(19) United States
(12) Patent Application Publication
(10) Pub. No.: US 2013/0031565 A1
(43) Pub. Date: Jan. 31, 2013

(54) MANAGING CONSISTENT INTERFACES FOR A PRODUCT DESIGN VERSION HIERARCHY BUSINESS OBJECT ACROSS HETEROGENEOUS SYSTEMS

(71) Applicants: Michael Wachter, Hockenheim (DE); Jens Griessmann, Walldorf (DE); Thomas Kretz, Muehlhausen (DE); Michael Belenki, Karlsruhe (DE); Karthikeyan A, Bangalore (IN); Jeyaraj A, Bangalore (IN); Ranjini R Varma, Bangalore (IN)

(72) Inventors: Michael Wachter, Hockenheim (DE); Jens Griessmann, Walldorf (DE); Thomas Kretz, Muehlhausen (DE); Michael Belenki, Karlsruhe (DE); Karthikeyan A, Bangalore (IN); Jeyaraj A, Bangalore (IN); Ranjini R Varma, Bangalore (IN)

(73) Assignee: SAP AG, Walldorf (DE)

(21) Appl. No.: 13/192,564

(22) Filed: Jul. 28, 2011

(51) Int. Cl. G06F 9/46

(52) U.S. Cl. 719/313

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a product design version hierarchy business object.

### CROSS-REFERENCE TO RELATED APPLICATIONS

Some details of the subject matter of this specification are described in previously-filed U.S. patent application Ser. No. 12/816,083, entitled “Managing Consistent Interfaces For Customer Project Invoicing Agreement, Engineering Change Case, Product Design, Product Design Version Hierarchy, and Project Expense View Business Objects Across Heterogeneous Systems”, filed on Jun. 15, 2010; which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a tangible computer readable medium includes program code for providing a message-based interface for exchanging information about product design version hierarchies with external engineering systems. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for responding to a query from an external engineering system about a product design version hierarchy that includes a first message package derived from the common business object model and hierarchically organized in memory as a product design version hierarchy by elements response message entity; a product design version hierarchy package comprising a product design version hierarchy entity, where the product design version hierarchy entity includes a universally unique identifier (UUID) and a log entity; and a log package comprising a log entity.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The message package further comprises a product design package. The product design version hierarchy entity further includes at least one of the following: a product design version UUID, a product design identifier (ID), a product design version ID, an engineering design business system ID, an engineering design internal ID, an engineering design version internal ID, and at least one component entity.

In another aspect, a distributed system operates in a landscape of computer systems providing message-based services defined in a service registry. The system comprises a graphical user interface comprising computer readable instructions, embedded on tangible media, for responding to a query from an external engineering system about a product design version hierarchy using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a product design version hierarchy by elements response message entity; a product design version hierarchy package comprising a product design version hierarchy entity, where the product design version hierarchy entity includes a universally unique identifier (UUID) and a log entity; and a log package comprising a log entity.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging information about product design version hierarchies with external engineering systems. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for sending a query from an external engineering system about a product design version hierarchy that includes a first message package derived from the common business object model and hierarchically organized in memory as a product design version hierarchy by elements query message entity, a message header package comprising a message header entity, and a product design version hierarchy selection by elements package comprising a product design version hierarchy selection by elements entity, where the product design version hierarchy selection by elements entity includes a requested detail level and at least one selection by product design version hierarchy elements entity.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The product design version hierarchy selection by elements entity further includes a language code. Each selection by product design version hierarchy elements entity includes at least one of the following: a product design version UUID, a product design ID, a product design version ID, an engineering design business system ID, an engineering design internal ID, an engineering design version internal ID, a quantity, an explosion date, a maximum hierarchy level ordinal number value, and a version determination code.

In another aspect, a distributed system operates in a landscape of computer systems providing message-based services defined in a service registry. The system comprises a graphical user interface comprising computer readable instructions, embedded on tangible media, for sending a query from an external engineering system about a product design version hierarchy using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a product design version hierarchy by elements query message entity, a message header package comprising a message header entity, and a product design version hierarchy selection by elements package comprising a product design version hierarchy selection by elements entity, where the product design version hierarchy selection by elements entity includes a requested detail level and at least one selection by product design version hierarchy elements entity.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example Product Design Version Hierarchy By Elements Query_sync Message Data Type.

FIGS. 33-1 through 33-5 collectively depict an example Product Design Version Hierarchy By Elements Query_sync Element Structure.

FIGS. 34-1 through 34-4 collectively depict an example Product Design Version Hierarchy By Elements Response_sync Message Data Type.

FIGS. 35-1 through 35-64 collectively depict an example Product Design Version Hierarchy By Elements Response_sync Element Structure.

FIG. 36 depicts an example Product Design Version Hierarchy Object Model.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature. The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component. The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances.

Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

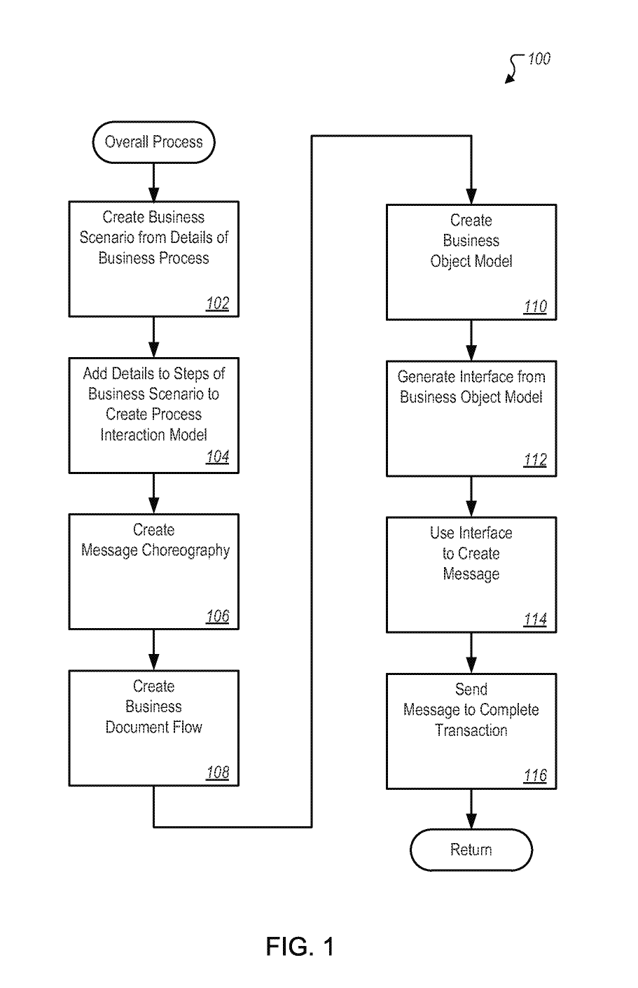

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

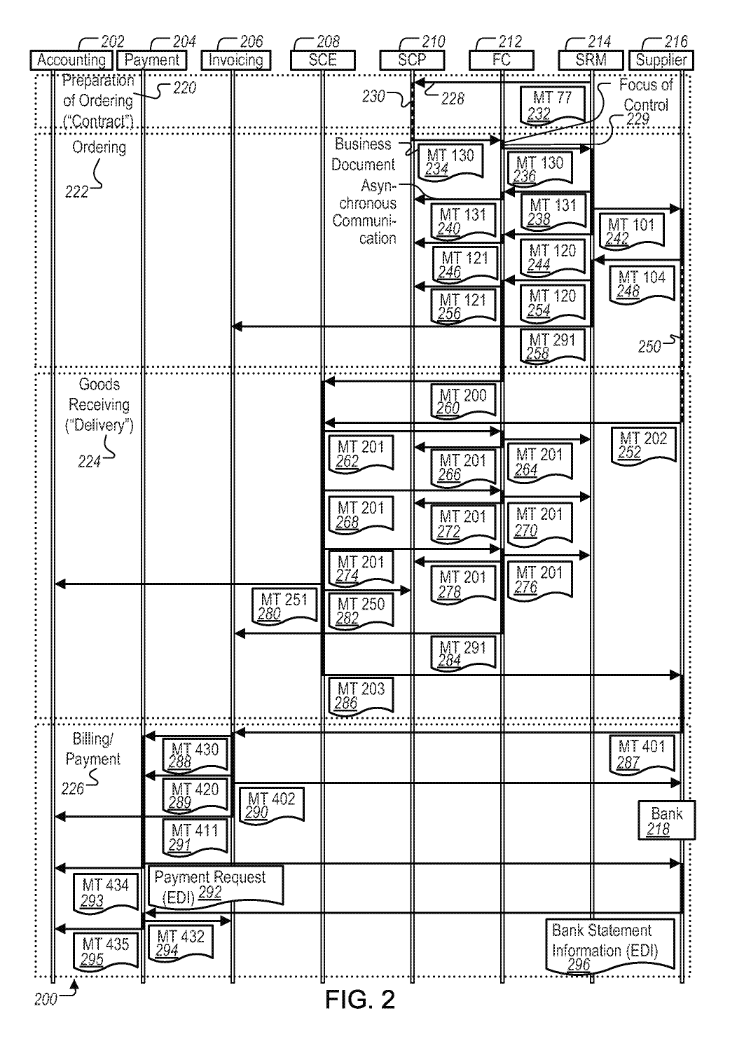

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

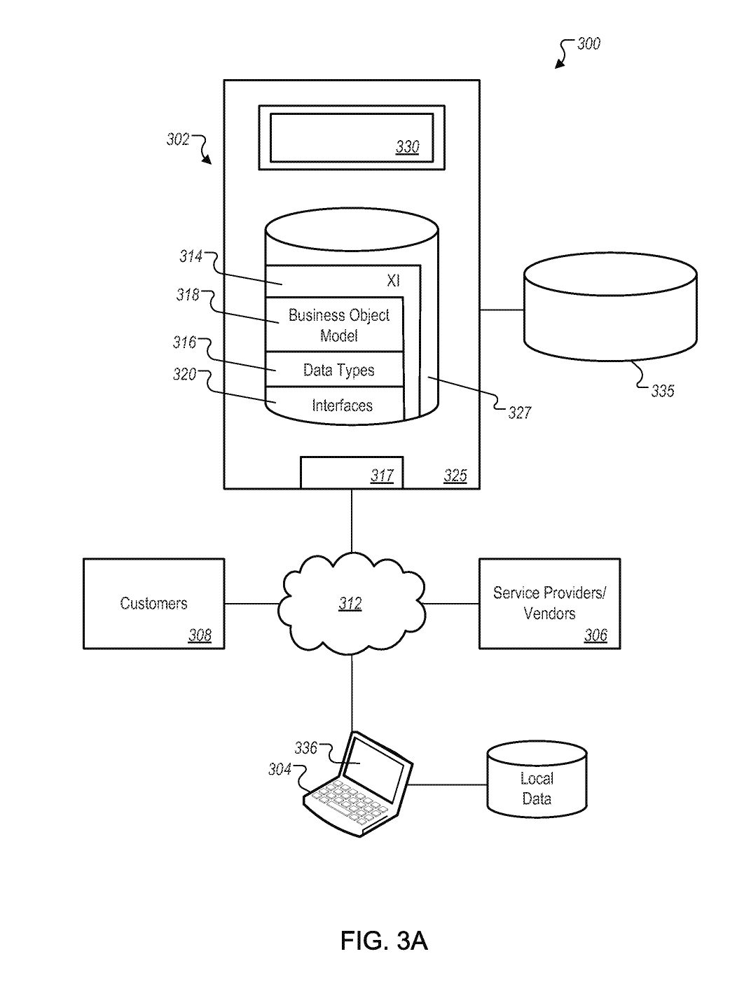

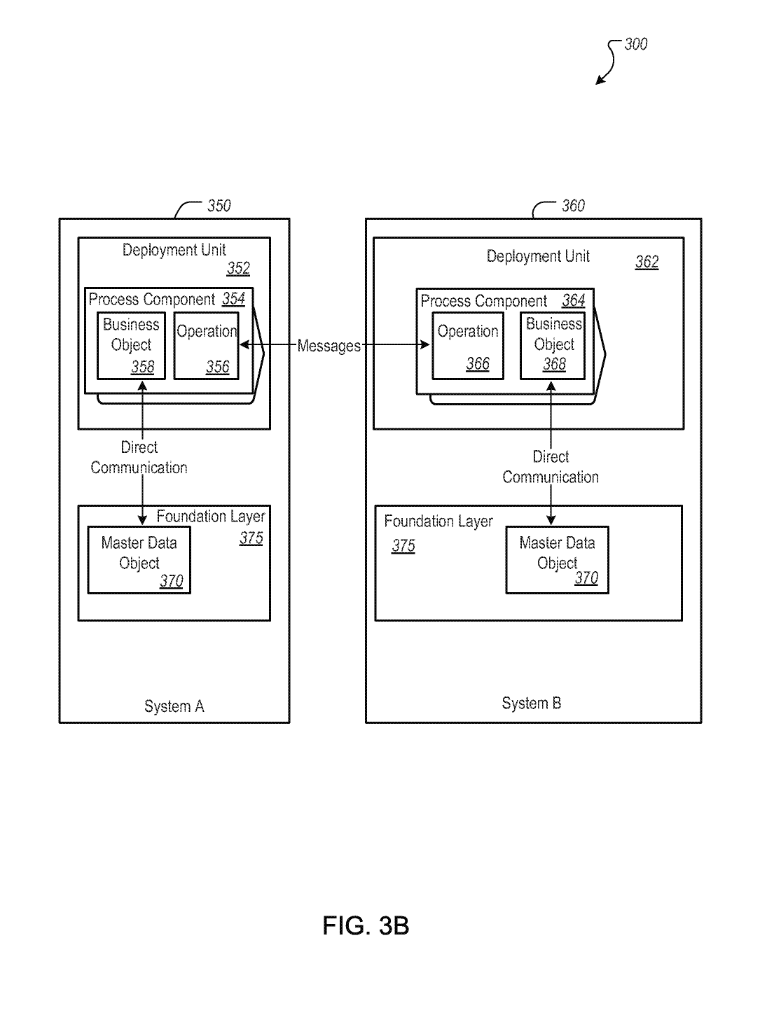

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

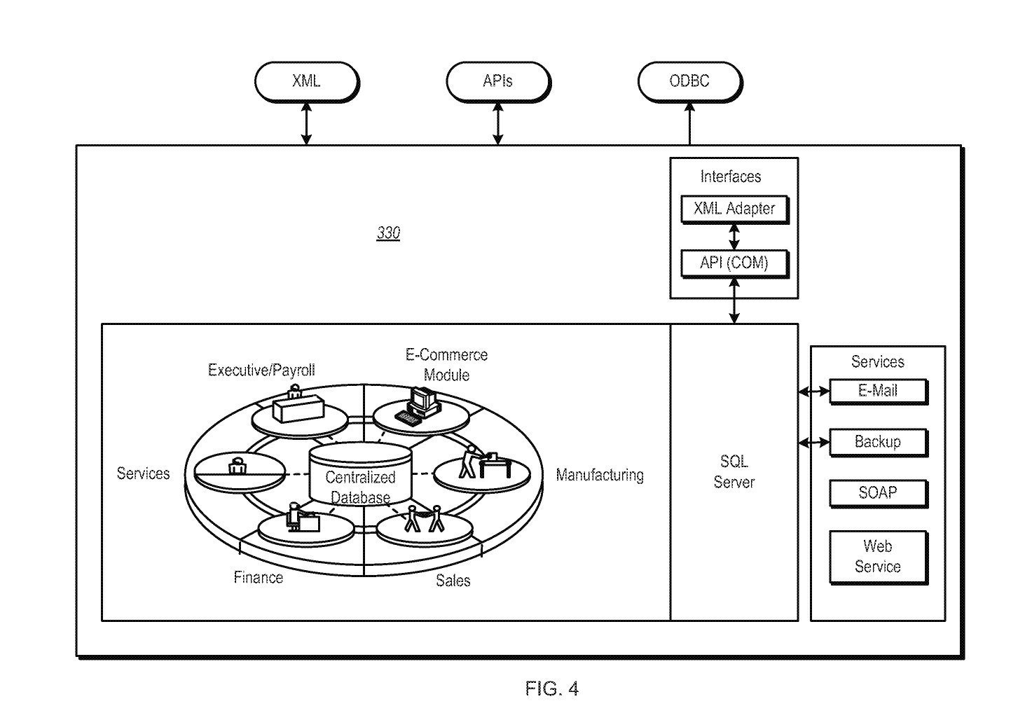

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

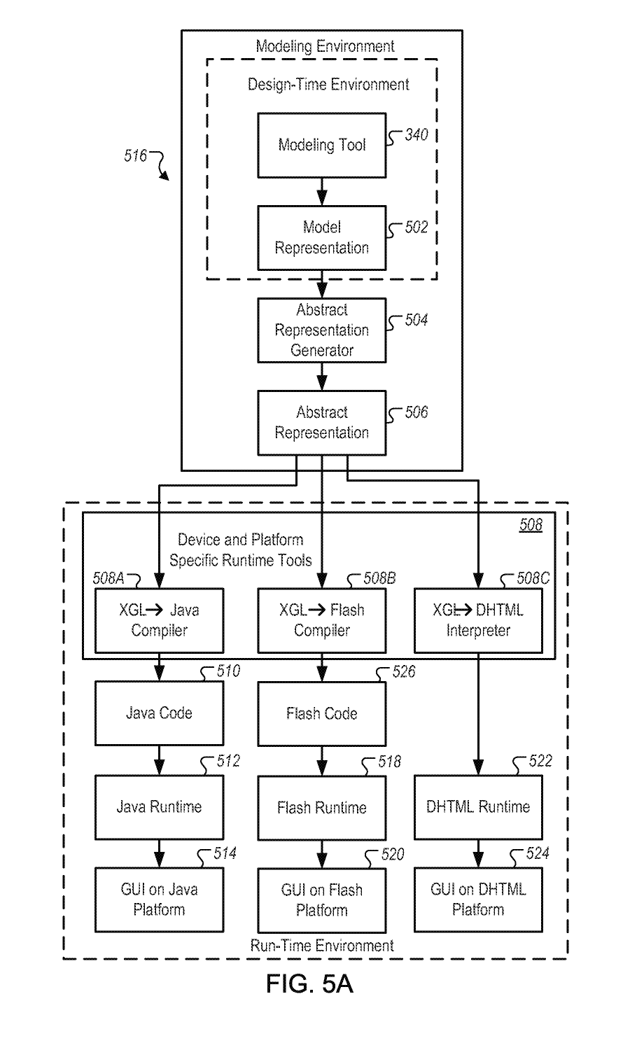

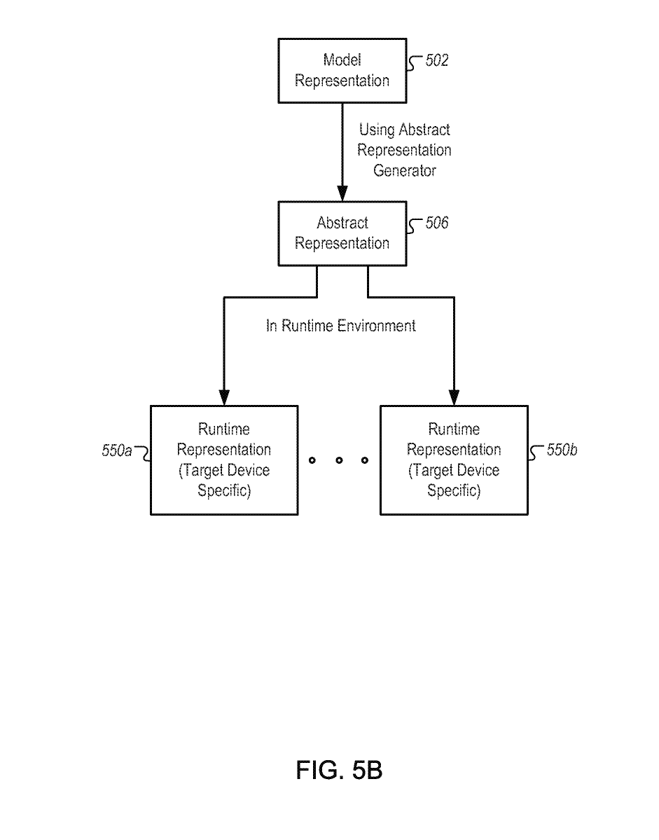

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such. One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

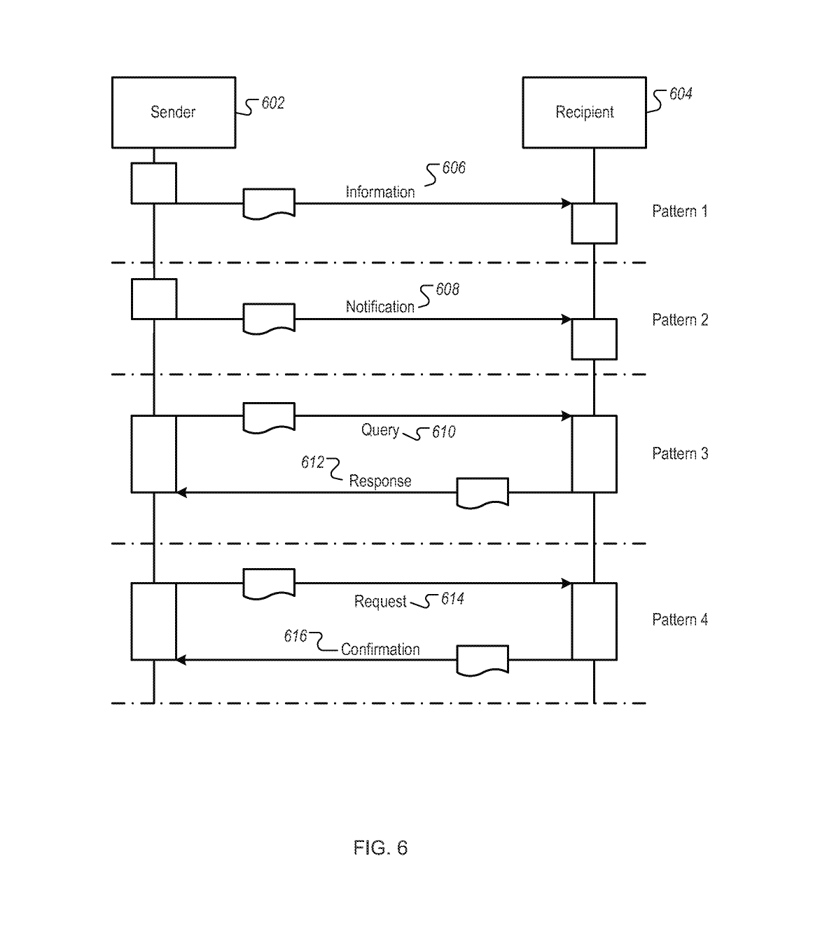

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

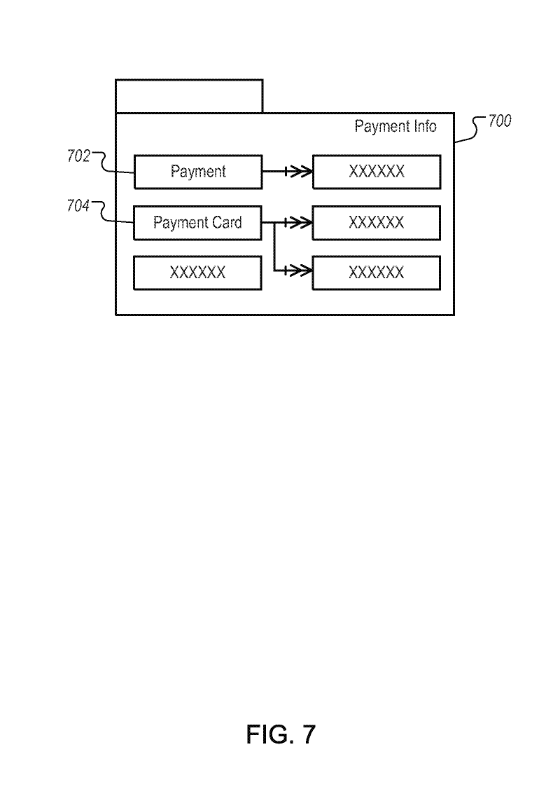

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

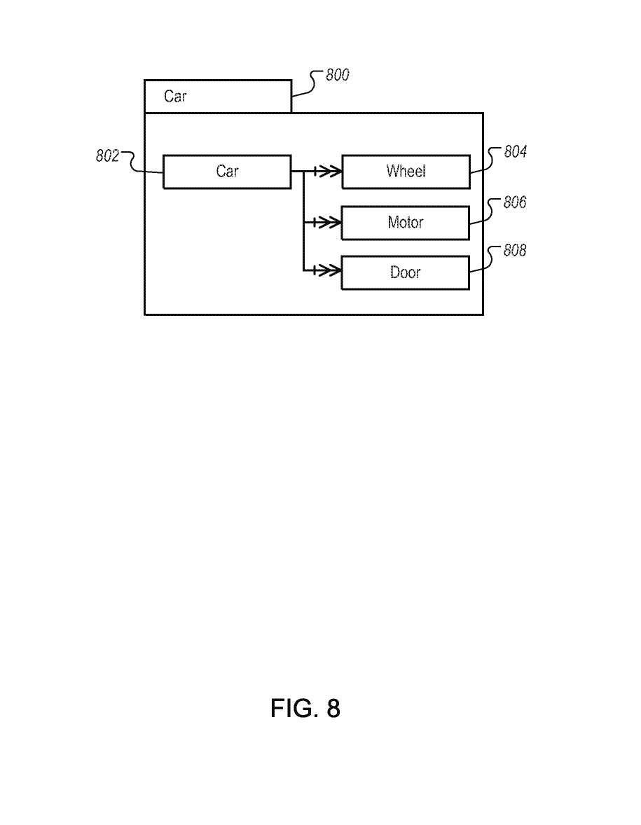

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

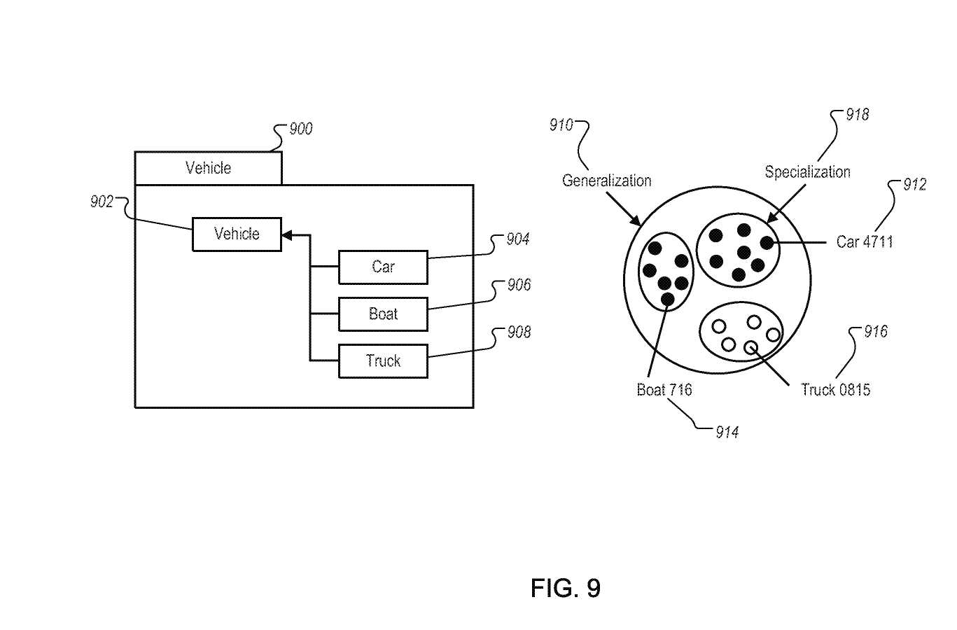

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

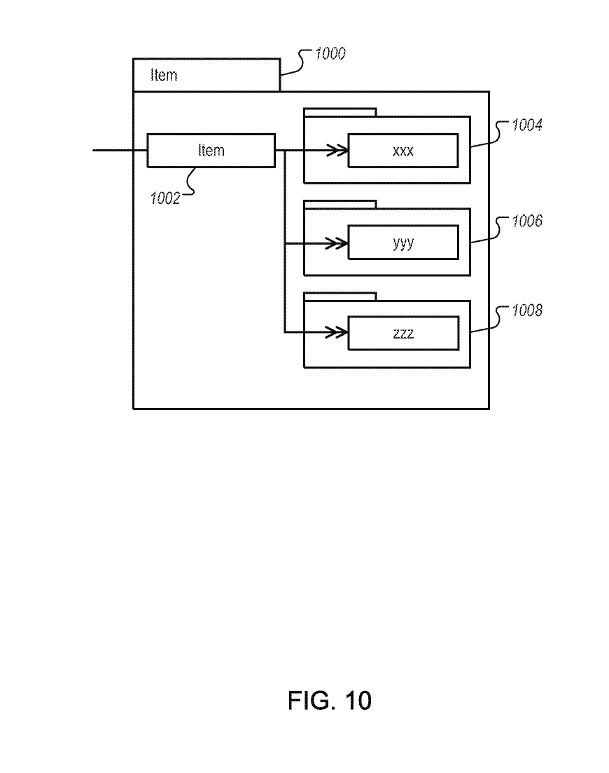

Packages also may be used to represent hierarchy levels. For example, as depicted in FIG. 10, the Item Package 1000 includes Item 1002 with subitem xxx 1004, subitem yyy 1006, and subitem zzz 1008.

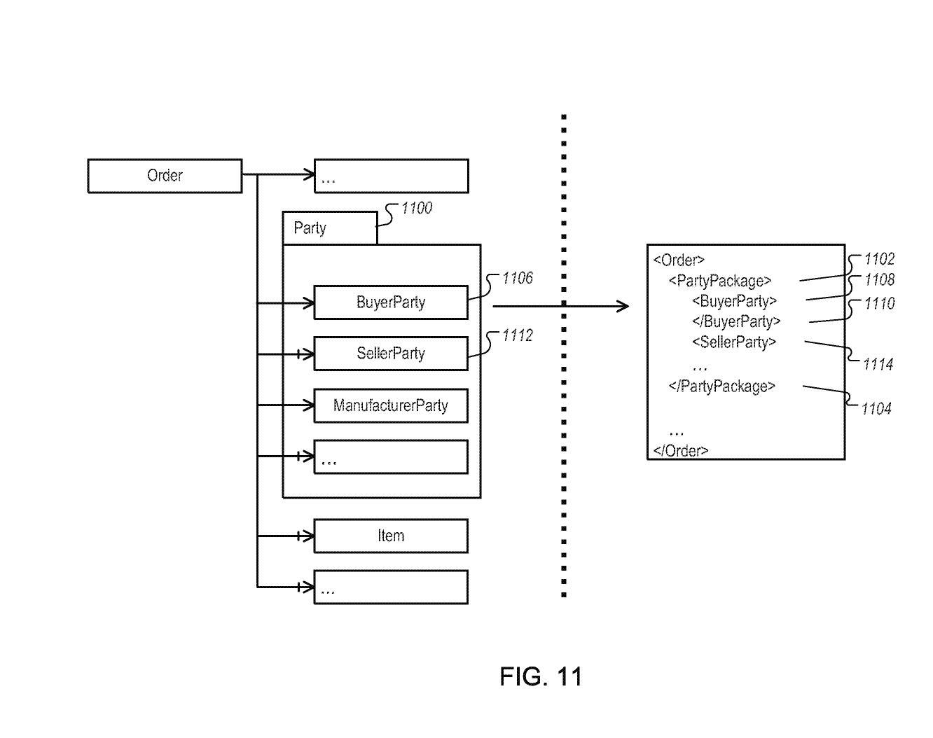

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

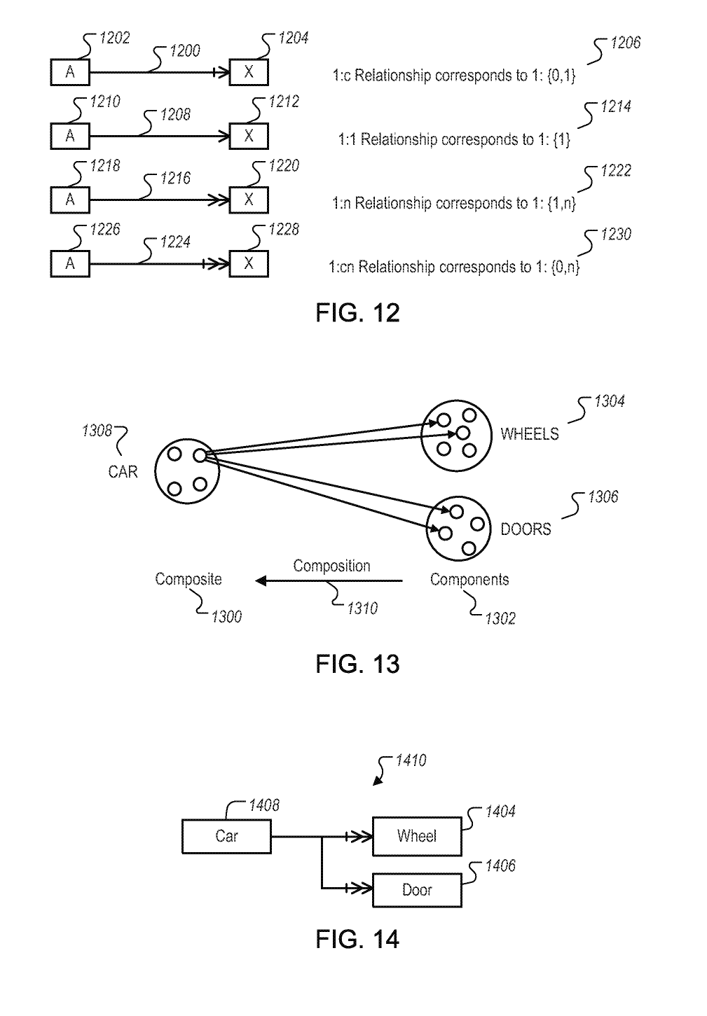

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

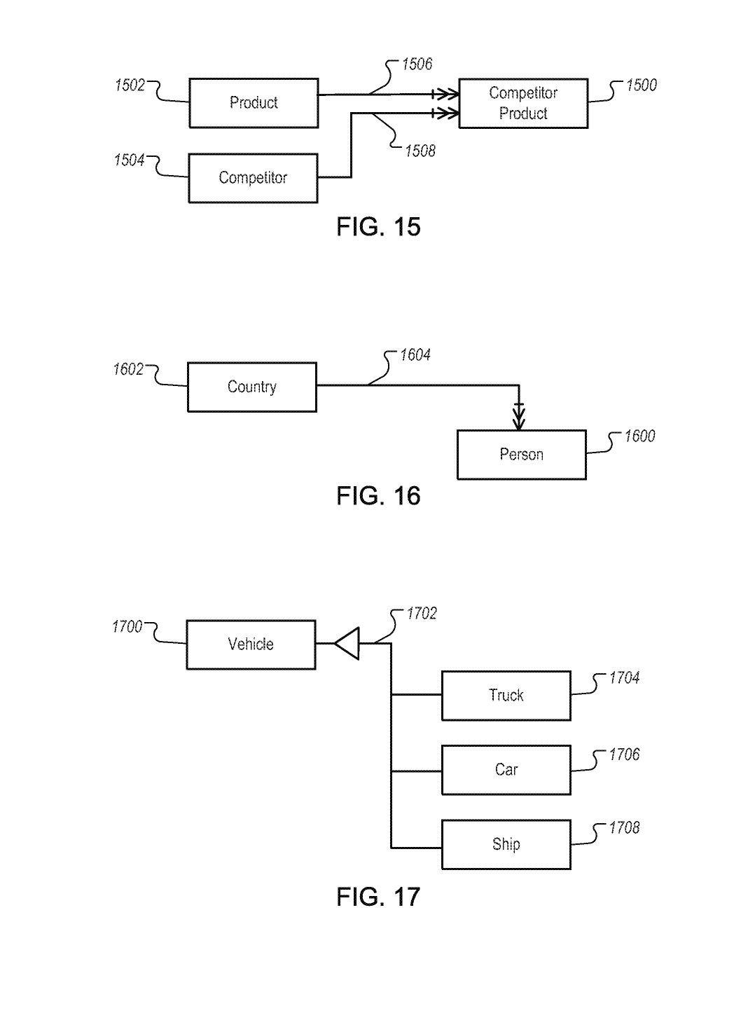

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

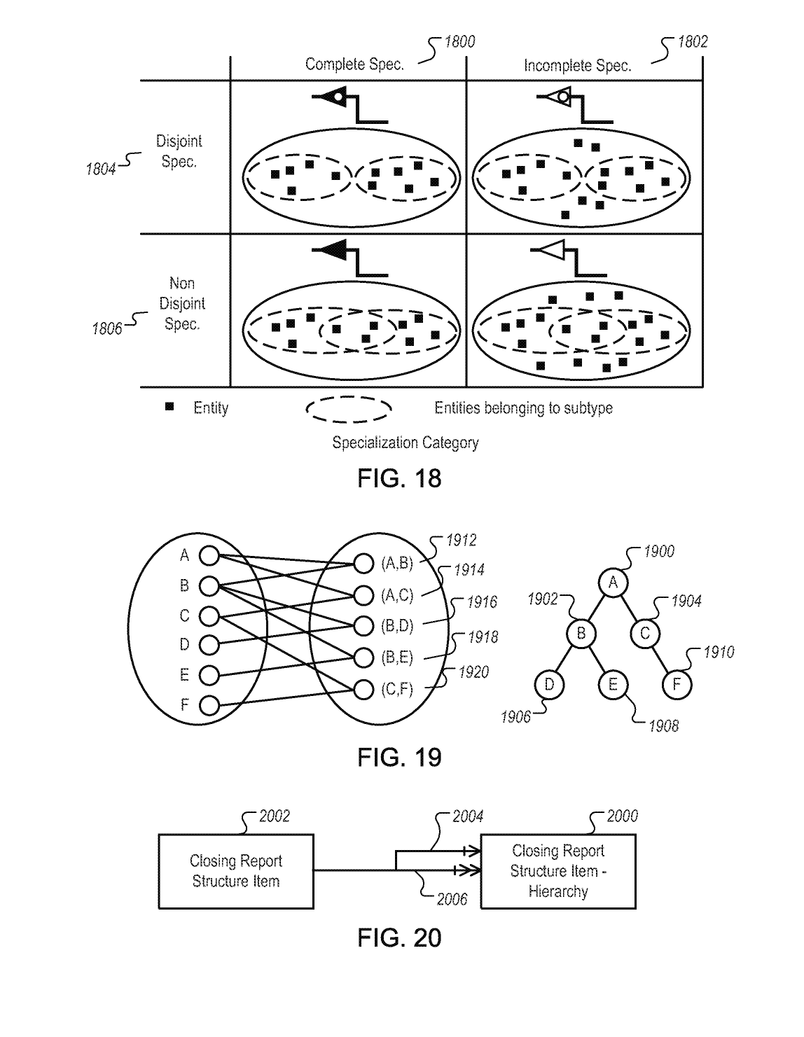

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

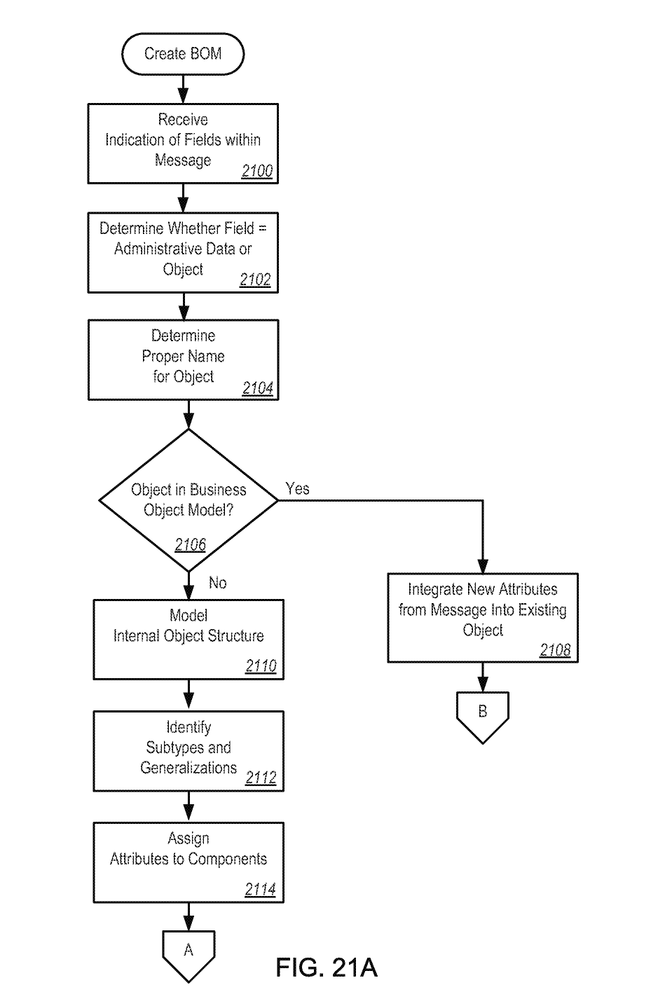

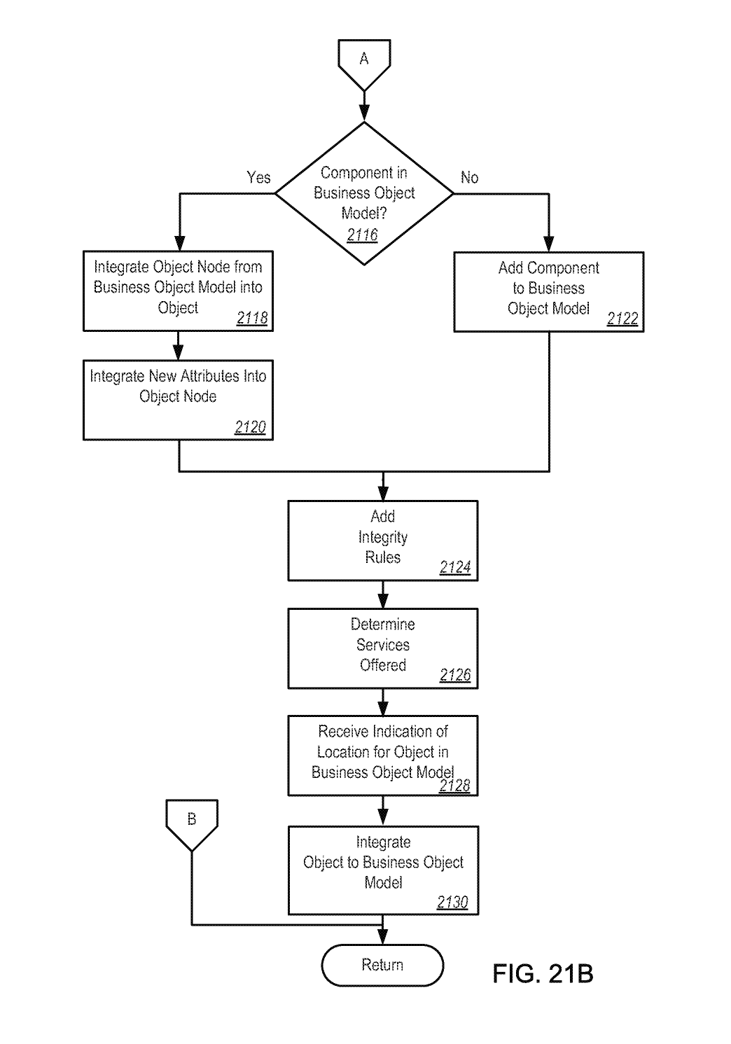

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Pur- | | |
| AdditionalID | chase | | |
| PostingDate | Order | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase Order | |
| ParentItemID | | Item | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

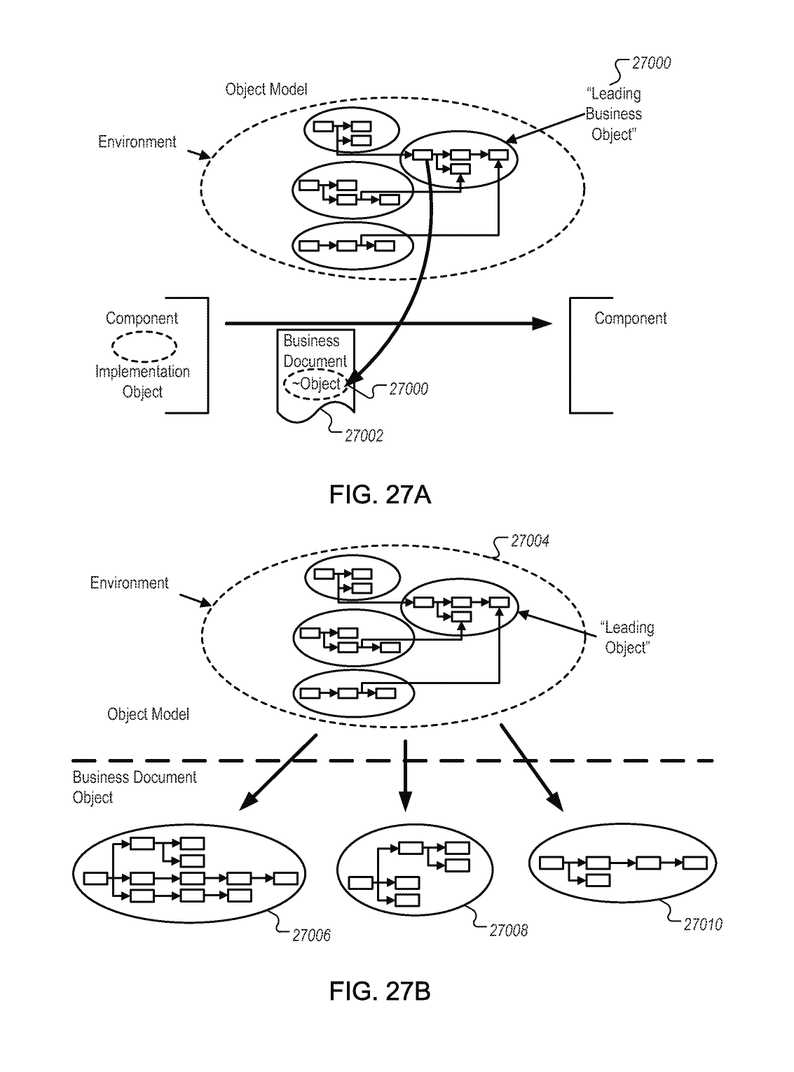

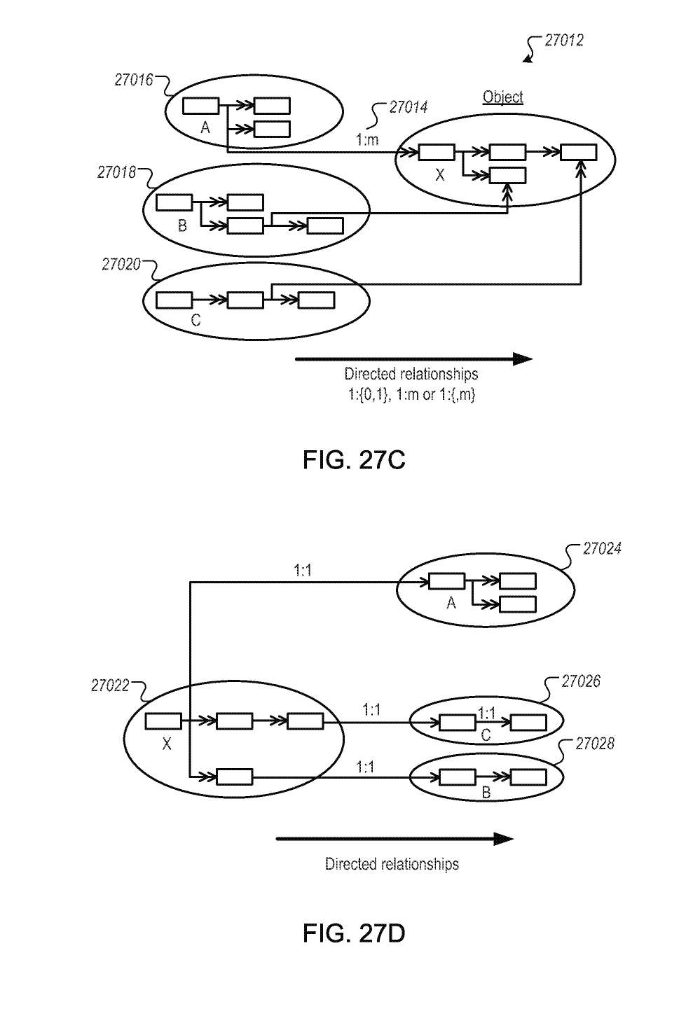

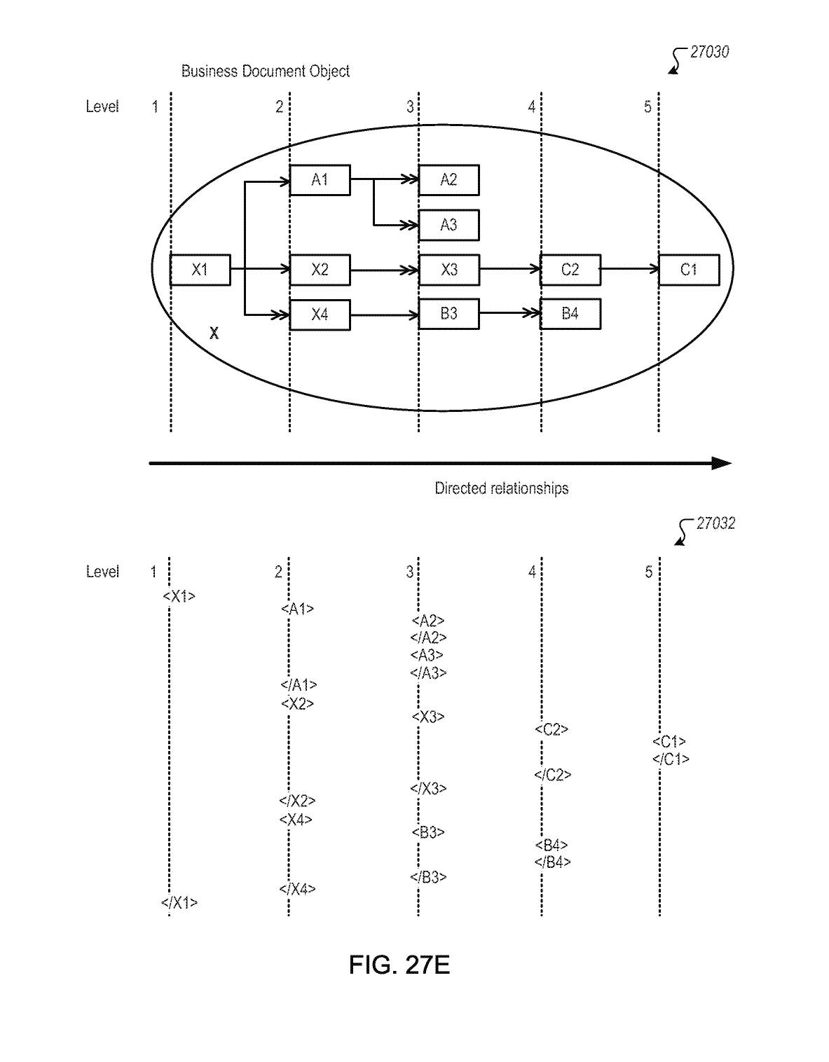

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderltemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

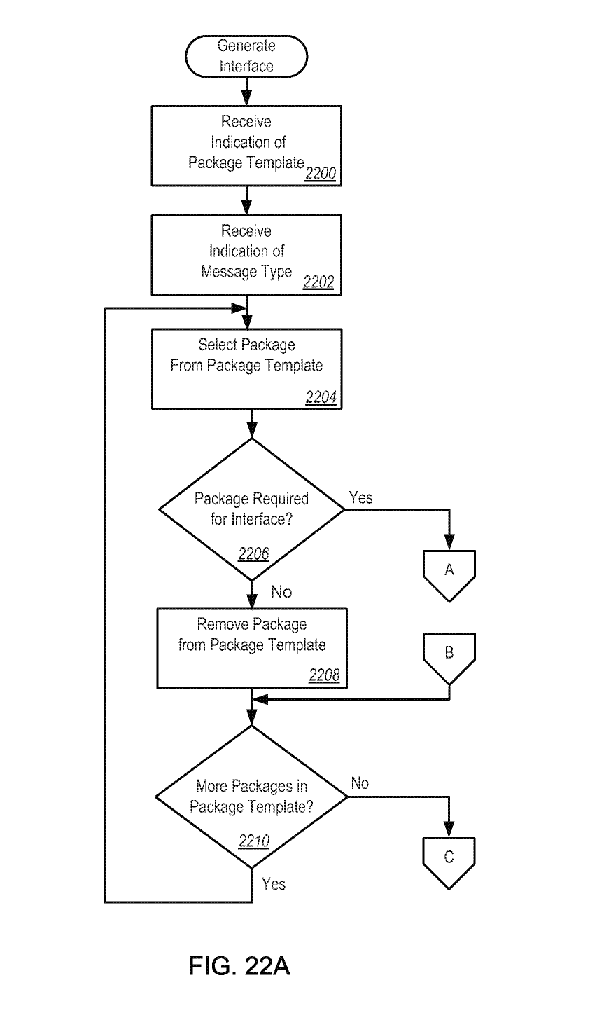

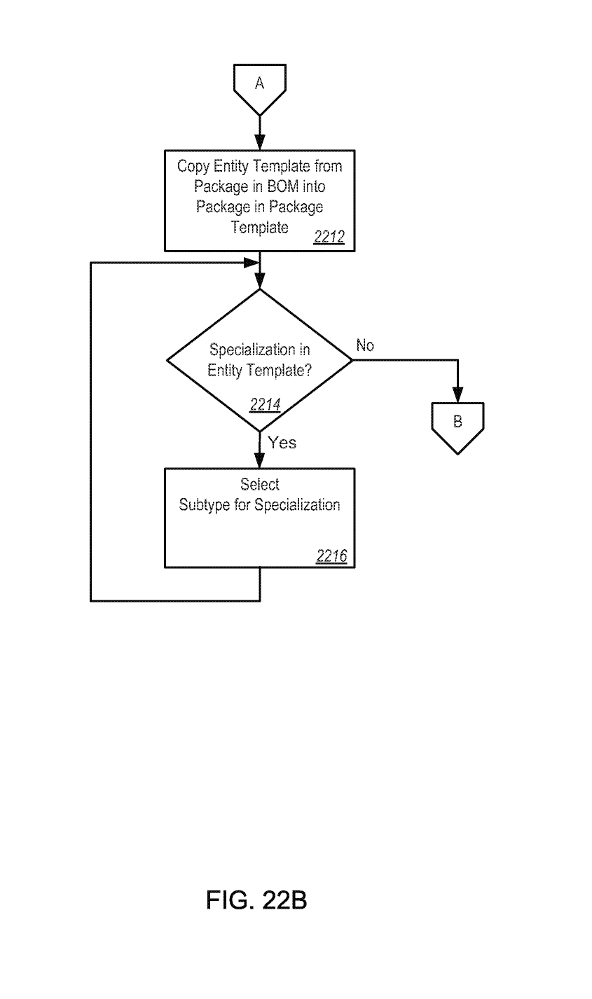

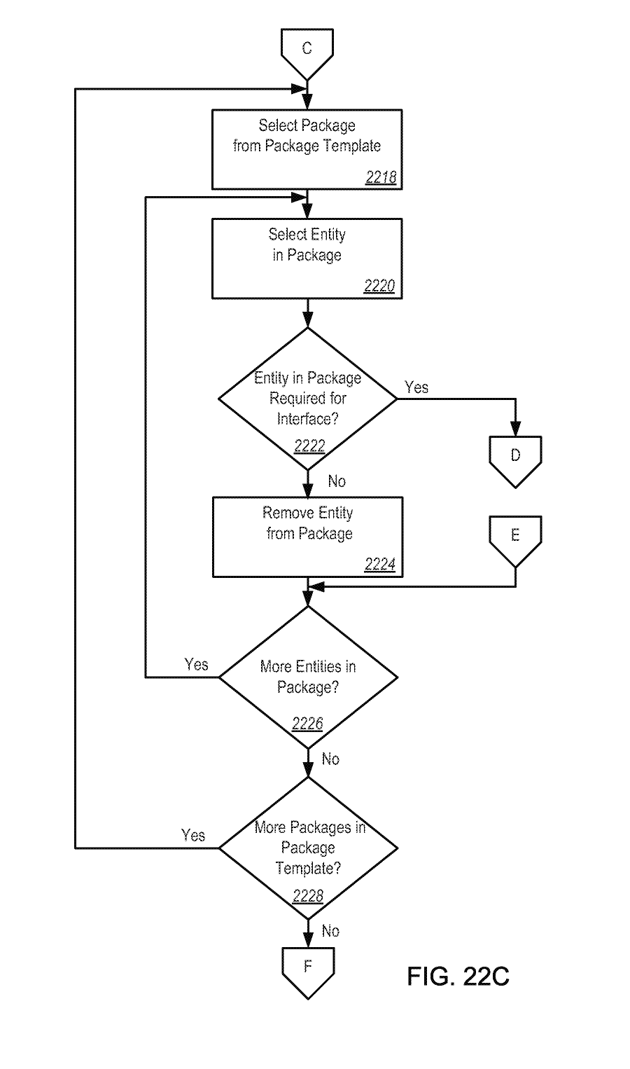

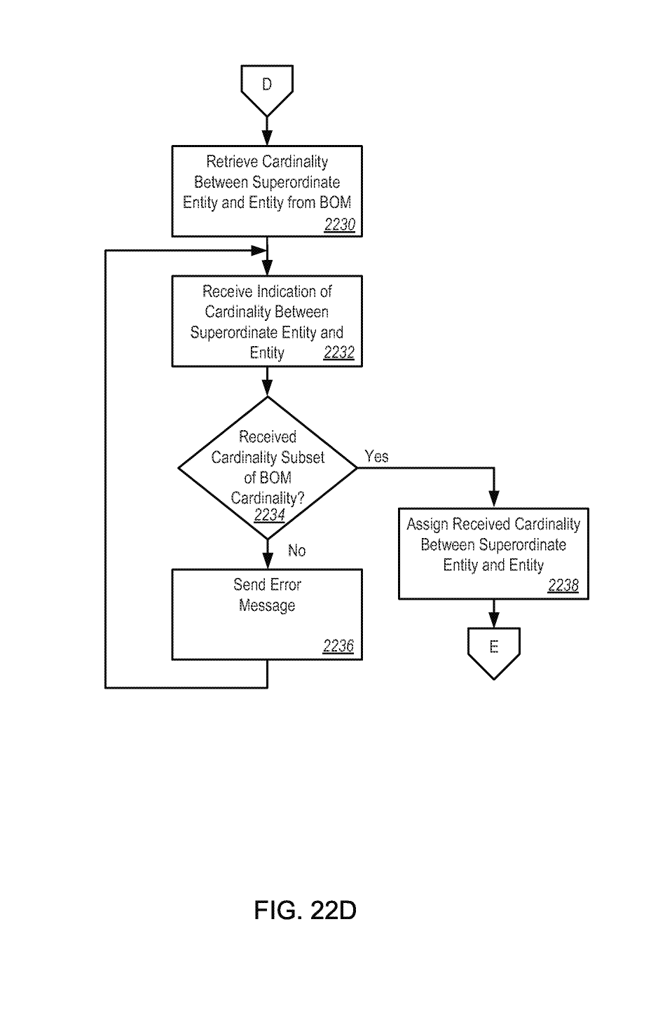

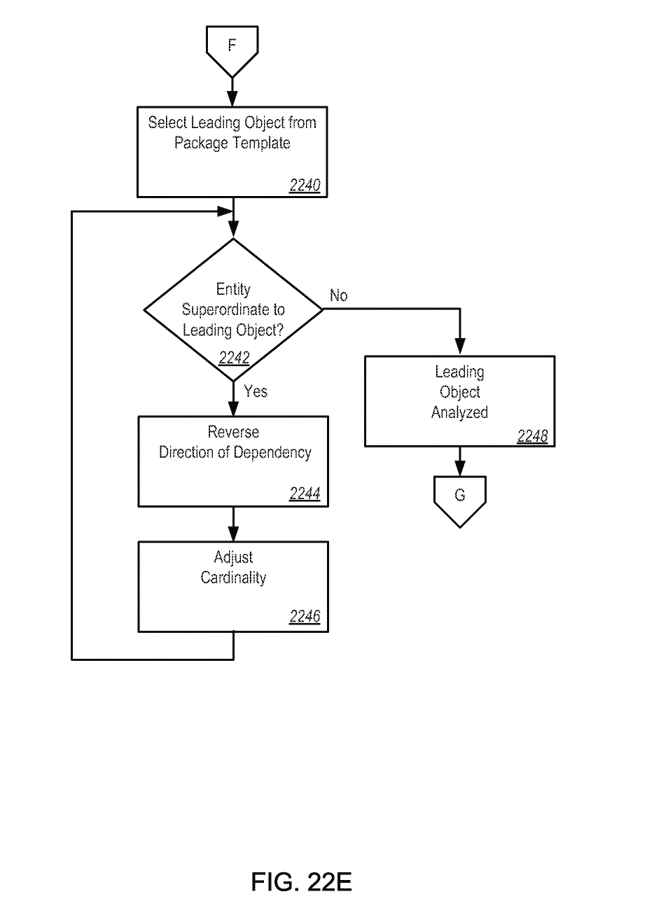

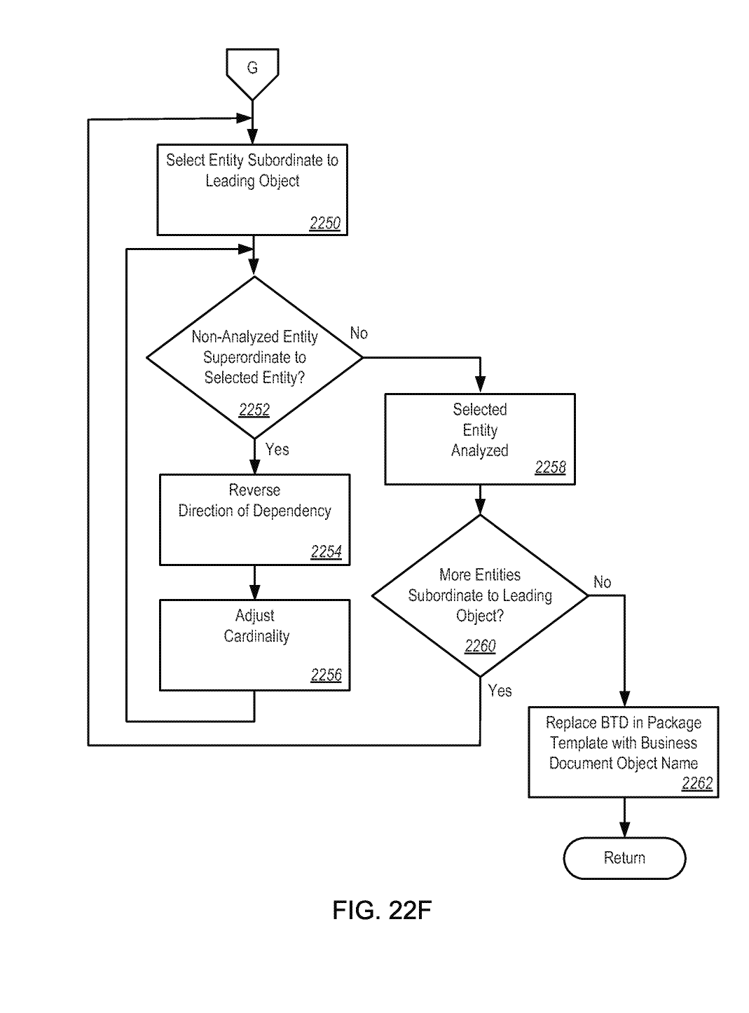

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

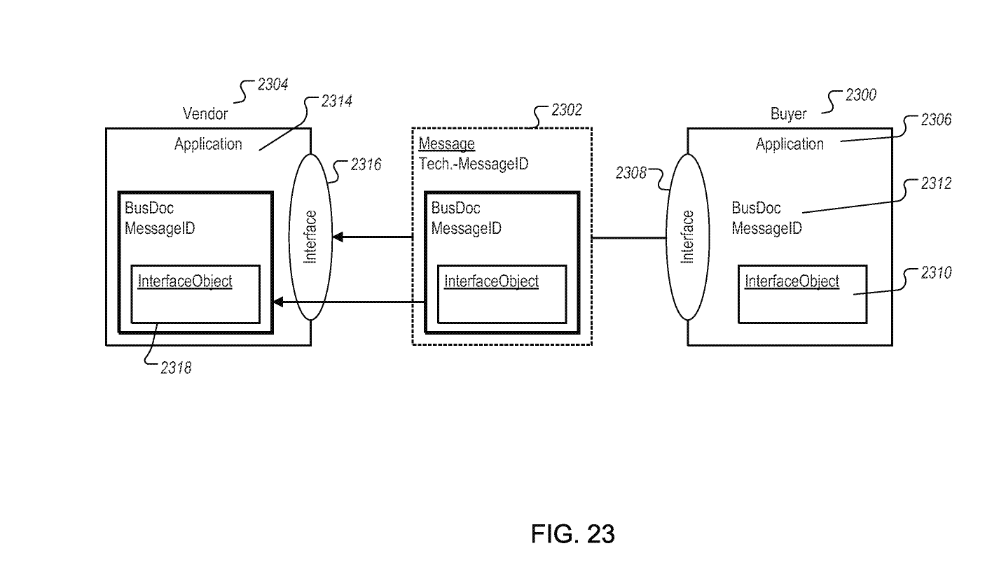

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

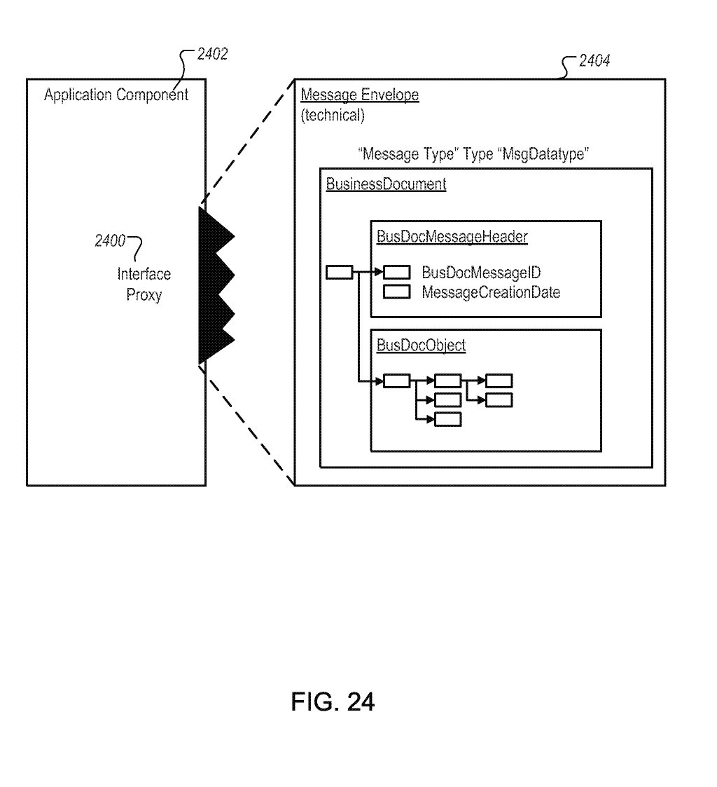

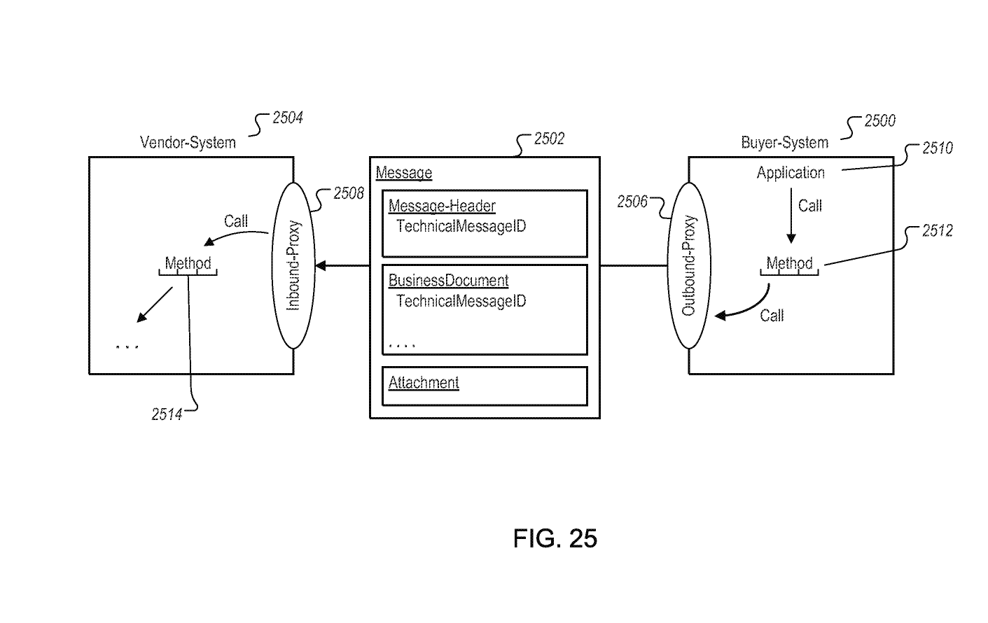

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

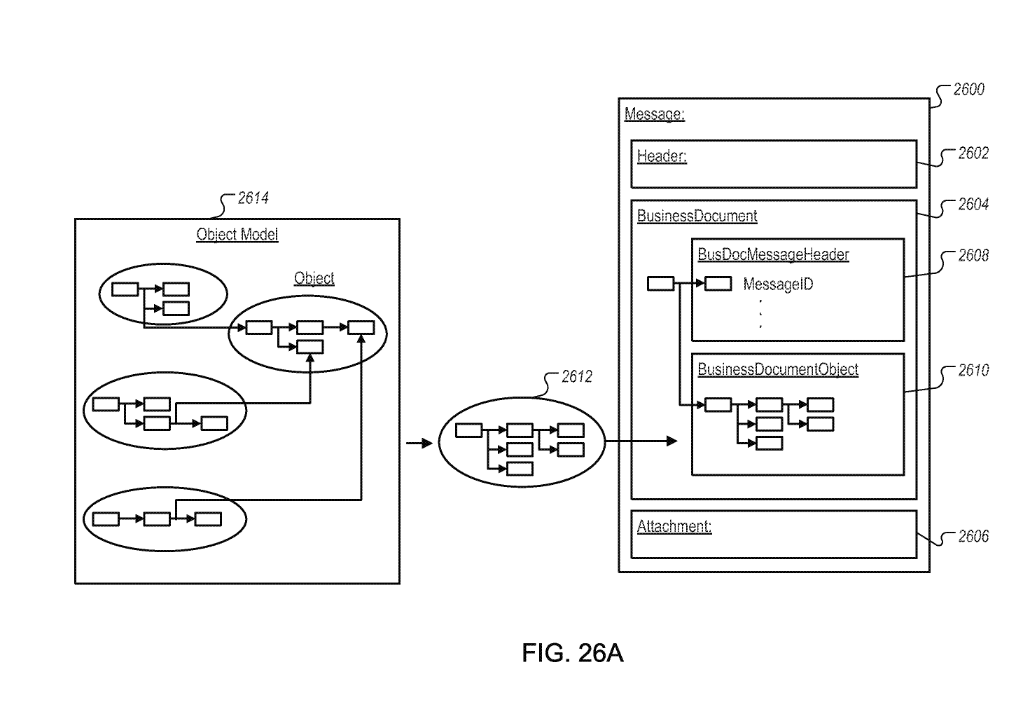

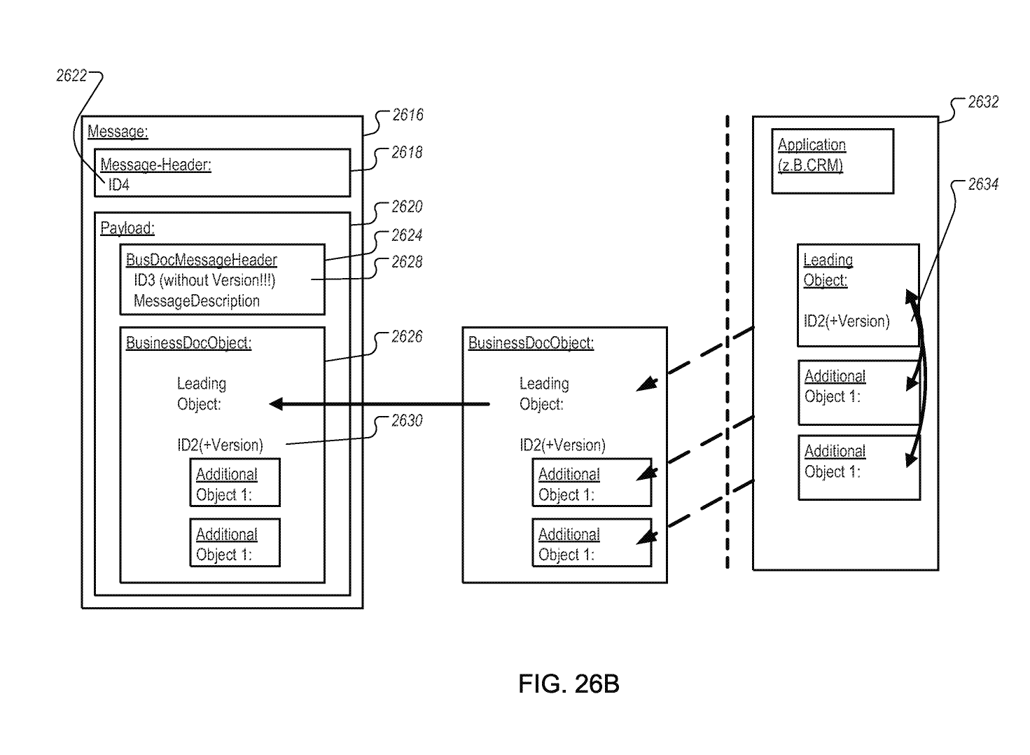

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of to different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

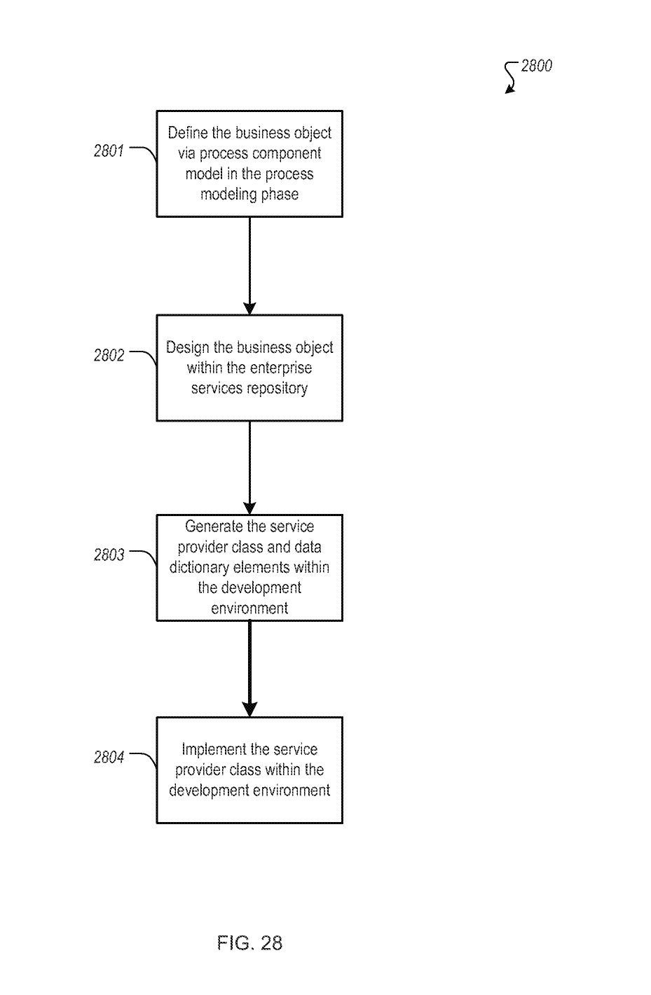

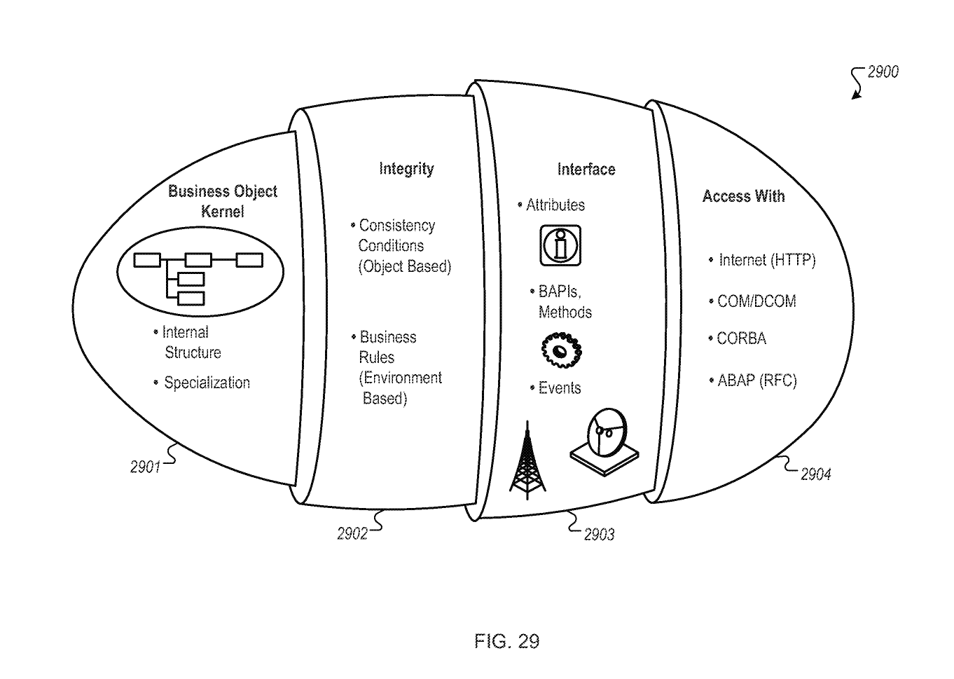

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

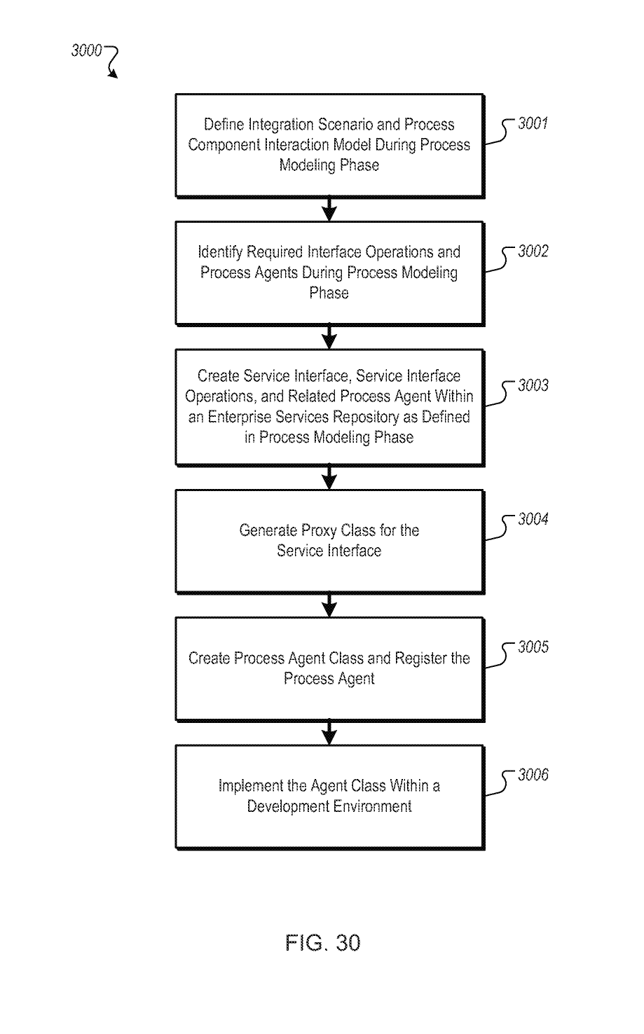

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

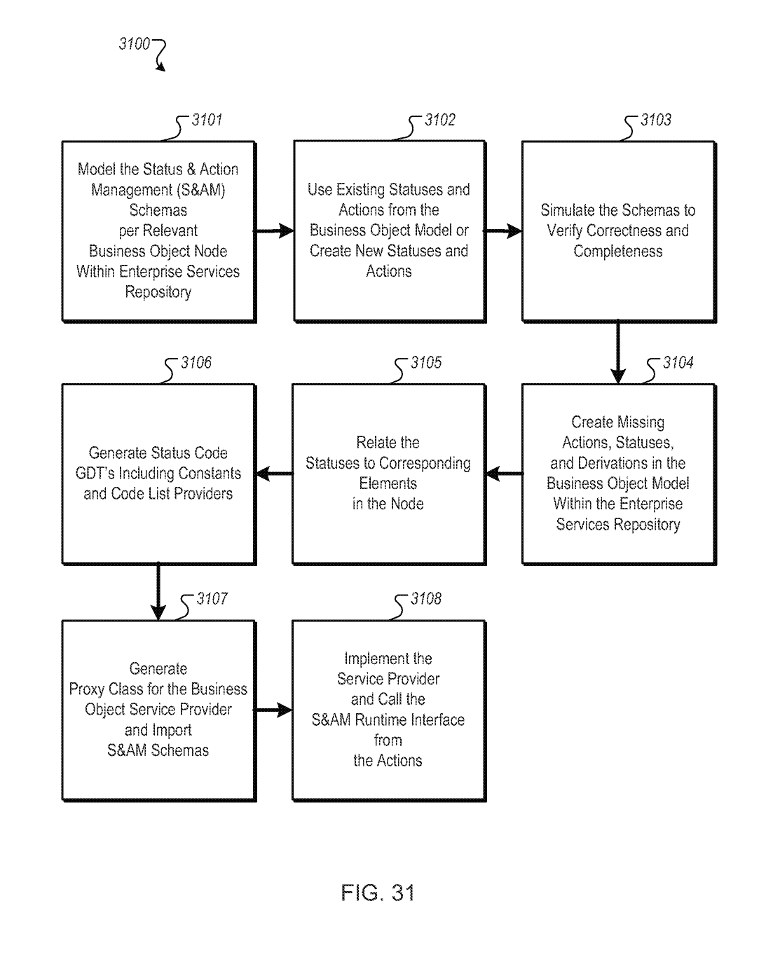

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

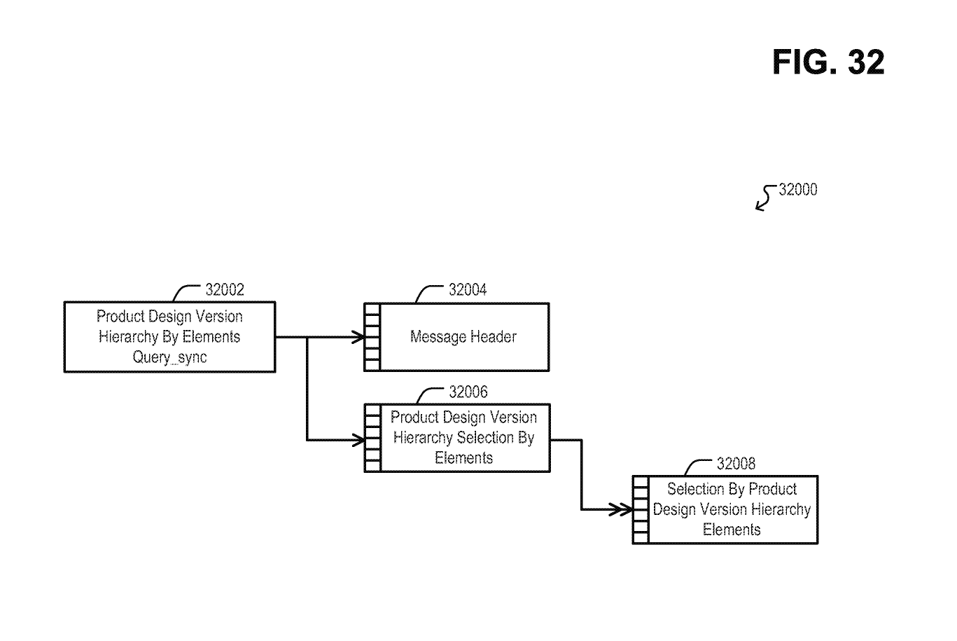

FIG. 32 illustrates one example logical configuration of a Product Design Version Hierarchy By Elements Query_sync message 32000. Specifically, this figure depicts the arrangement and hierarchy of various components such as one or more levels of packages, entities, and datatypes, shown here as 32002 through 32008. As described above, packages may be used to represent hierarchy levels. Entities are discrete business elements that are used during a business transaction. Data types are used to type object entities and interfaces with a structure. For example, the Product Design Version Hierarchy By Elements Query_sync message 32000 includes, among other things, a Product Design Version Hierarchy Selection By Elements entity 32006. Accordingly, heterogeneous applications may communicate using this consistent message configured as such.

The message type Product Design Version Hierarchy By Elements Query_sync is derived from the business object Product Design Version Hierarchy as a leading object together with its operation signature. The message type Product Design Version Hierarchy By Elements Query_sync is a query of an external engineering system about a product design version hierarchy. The structure of the message type Product Design Version Hierarchy By Elements Query_sync is determined by the message data type ProductDesignVersionHierarchyByElementsQueryMessage_sync. The message data type ProductDesignVersionHierarchyByElementsQueryMessage_sync may be used to request information about a product design version hierarchy from an external engineering system. The message data type ProductDesignVersionHierarchyByElementsQueryMessage_sync includes the MessageHeader package and the ProductDesignVersionHierarchySelectionByElements package. The package MessageHeader includes the sub-packages Party and Business Scope and the entity MessageHeader. MessageHeader is typed by BusinessDocumentMessageHeader.

The package ProductDesignVersionHierarchySelectionByElements includes the entity ProductDesignVersionHierarchySelectionByElements. ProductDesignVersionHierarchySelectionByElements includes the following non-node elements: RequestedDetailLevel, MaximumExplosionRequiredIndicator, RetrieveAttachmentDataIndicator, RetrieveTextCollectionIndicator, RetrieveProductAssignmentIndicator, RetrieveProductionBillOfMaterialVariantHandoverindicator, and LanguageCode. RequestedDetailLevel may have a multiplicity of 1 and may be based on datatype MIDT:ProductDesignVersionHierarchyByElementsQueryRequestedDetailLevel. MaximumExplosionRequiredIndicator may have a multiplicity of 0 . . . 1, may be used to indicate a maximum explosion of product design version hierarchy, and may be based on datatype CDT:Indicator. RetrieveAttachmentDataIndicator may have a multiplicity of 0 . . . 1, may be used to indicate whether attachment data should be in a response view, and may be based on datatype CDT:Indicator. RetrieveTextCollectionIndicator may have a multiplicity of 0.1, may be used to indicate whether Text collections should be in a response view, and may be based on datatype CDT:Indicator. RetrieveProductAssignmentIndicator may have a multiplicity of 0 . . . 1, may be used to indicate whether ProductAssignment node details in a Product Design business object should be in a response view, and may be based on datatype CDT:Indicator. RetrieveProductionBillOfMaterialVariantHandoverIndicator may have a multiplicity of 0 . . . 1, may be used to indicate whether ProductionBillOfMaterialVariantHandover node details in a Product Design business object should be in a response view, and may be based on datatype CDT:Indicator. LanguageCode may have a multiplicity of 0 . . . 1, may be used to retrieve a description, and may be based on datatype BGDT:LanguageCode.

ProductDesignVersionHierarchySelectionByElements includes the node element SelectionByProductDesignVersionHierarchyElements in a 1:N cardinality relationship. The package ProductDesignVersionHierarchySelectionByElements includes the entity SelectionByProductDesignVersionHierarchyElements. SelectionByProductDesignVersionHierarchyElements includes the following non-node elements: ProductDesignVersionUUID, ProductDesignID, ProductDesignVersionID, EngineeringDesignBusinessSystemID, EngineeringDesignInternalID, EngineeringDesignVersionInternalID, Quantity, ExplosionDate, MaximumHierarchyLevelOrdinalNumberValue, and VersionDeterminationCode. ProductDesignVersionUUID may have a multiplicity of 0 . . . 1 and may be based on datatype BGDT:UUID. ProductDesignID may have a multiplicity of 0 . . . 1 and may be based on datatype BGDT:ProductDesignID ProductDesignVersionID may have a multiplicity of 0 . . . 1 and may be based on datatype BGDT:VersionID. EngineeringDesignBusinessSystemID may have a multiplicity of 0 . . . 1 and may be based on datatype BGDT:BusinessSystemID EngineeringDesignInternalID may have a multiplicity of 0 . . . 1 and may be based on datatype BGDT:EngineeringDesignInternalID. EngineeringDesignVersionInternalID may have a multiplicity of 0 . . . 1 and may be based on datatype BGDT:EngineeringDesignVersionInternalID. Quantity may have a multiplicity of 0 . . . 1 and may be based on datatype CDT:NONNEGATIVE_Quantity. ExplosionDate may have a multiplicity of 0 . . . 1 and may be based on datatype CDT:Date. MaximumHierarchyLevelOrdinalNumberValue may have a multiplicity of 0 . . . 1 and may be based on datatype BGDT:OrdinalNumberValue. VersionDeterminationCode may have a multiplicity of 0 . . . 1 and may be based on datatype BGDT:ProductDesignVersionDeterminationMethodCode.

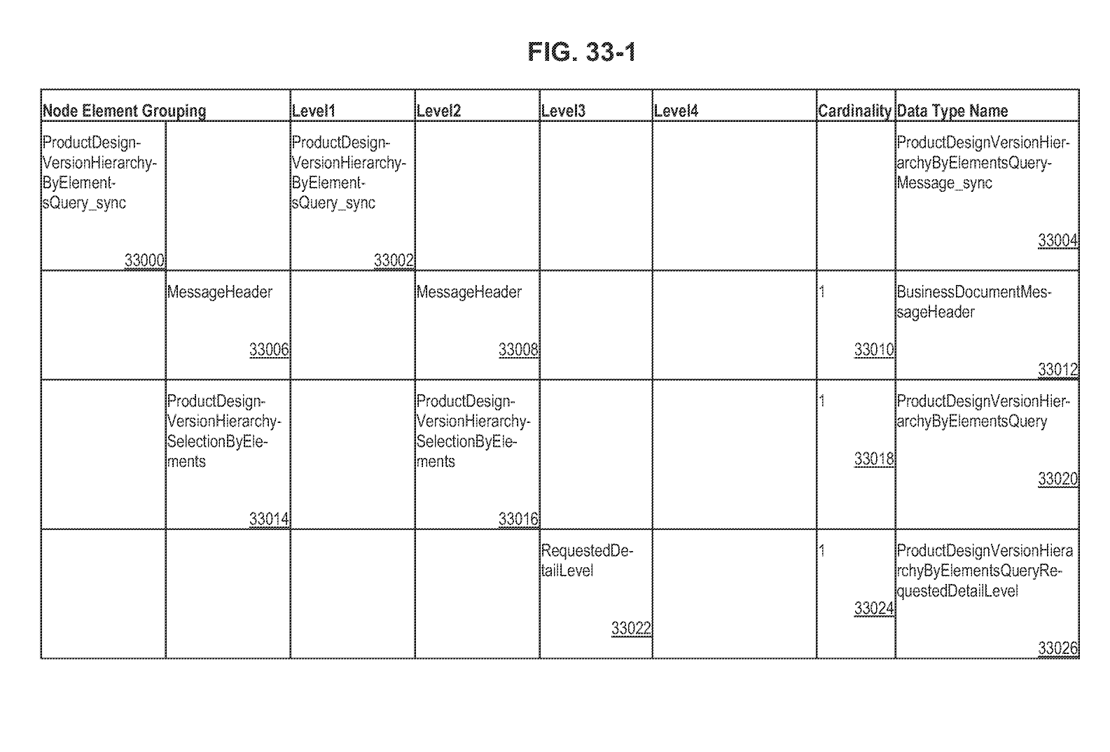

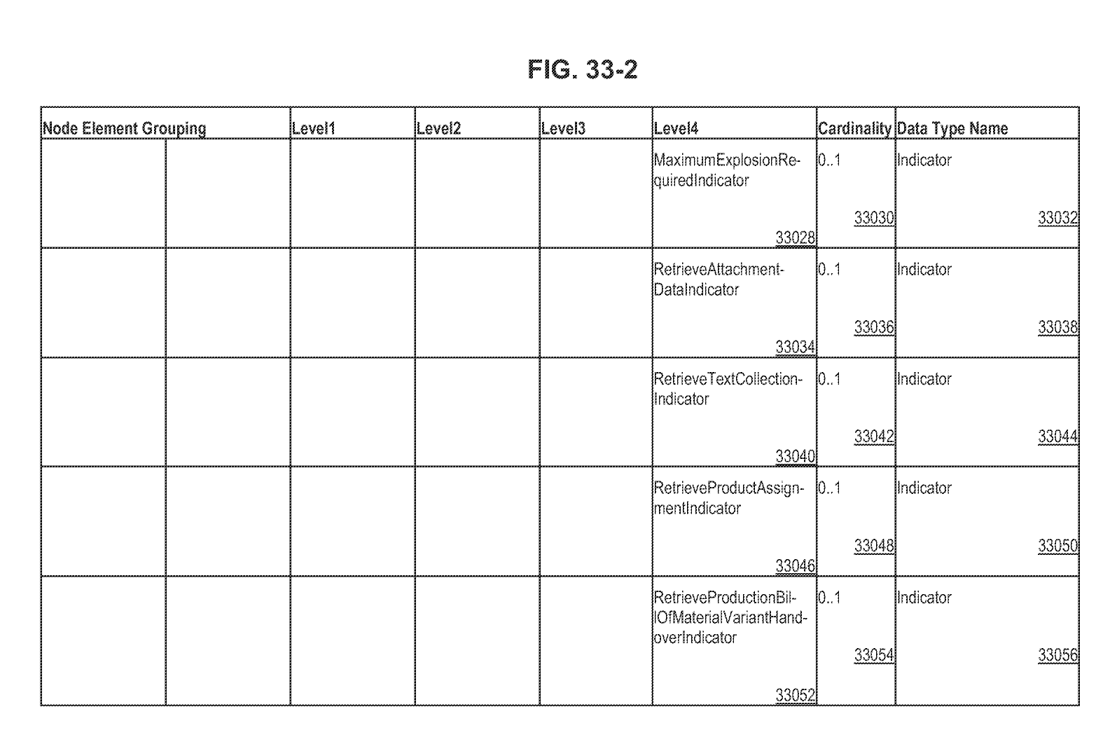

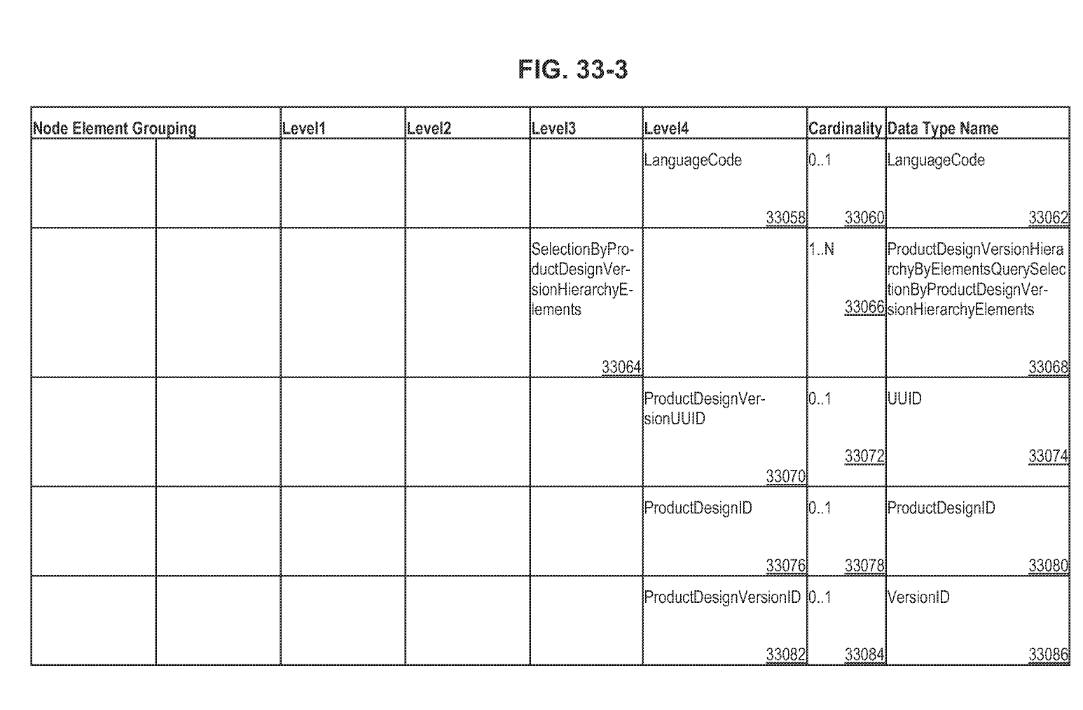

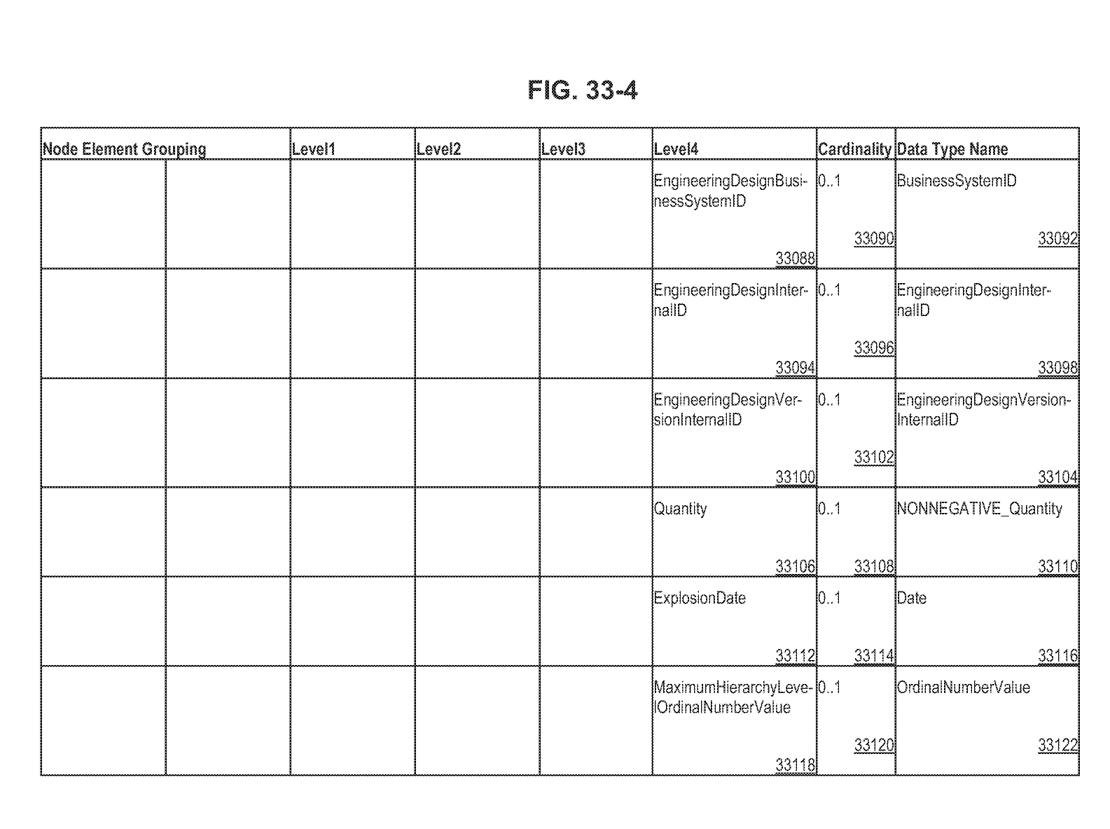

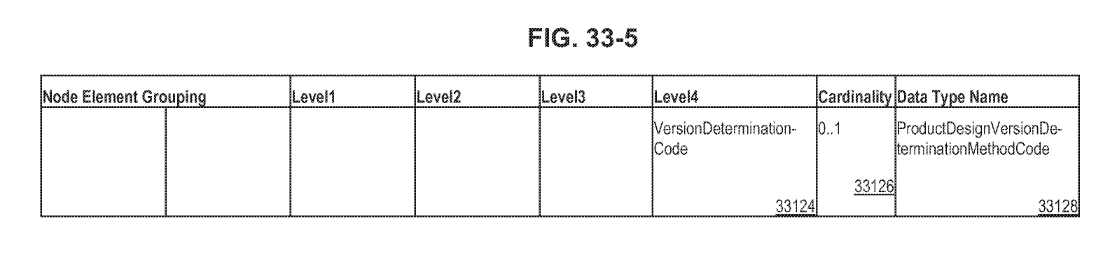

FIGS. 33-1 through 33-5 show an example configuration of an Element Structure that includes a ProductDesignVersionHierarchyByElementsQuery_sync 33000 node element grouping. Specifically, these figures depict the arrangement and hierarchy of various components such as one or more levels of node element groupings, entities, and datatypes, shown here as 33000 through 33128. As described above, node element groupings may be used to represent hierarchy levels. Entities are discrete business elements that are used during a business transaction. Data types are used to type object entities and interfaces with a structure. For example, the ProductDesignVersionHierarchyByElementsQuery_sync 33000 includes, among other things, a ProductDesignVersionHierarchyByElementsQuery_sync 33002. Accordingly, heterogeneous applications may communicate using this consistent message configured as such. The ProductDesignVersionHierarchyByElementsQuery_sync 33000 node element grouping is a ProductDesignVersionHierarchyByElementsQueryMessage_sync 33004 data type. The ProductDesignVersionHierarchyByElementsQuery_sync 33000 node element grouping includes a ProductDesignVersionHierarchyByElementsQuery_sync 33002 entity. The ProductDesignVersionHierarchyByElementsQuery_sync 33000 node element grouping includes various node element groupings, namely a MessageHeader 33006 and a ProductDesignVersionHierarchySelectionByElements 33014.

The MessageHeader 33006 node element grouping is a BusinessDocumentMessageHeader 33012 data type. The MessageHeader 33006 node element grouping includes a MessageHeader 33008 entity.

The MessageHeader 33008 entity has a cardinality of 1 33010 meaning that for each instance of the MessageHeader 33006 node element grouping there is one MessageHeader 33008 entity.

The ProductDesignVersionHierarchySelectionByElements 33014 node element grouping is a ProductDesignVersionHierarchyByElementsQuery 33020 data type. The ProductDesignVersionHierarchySelectionByElements 33014 node element grouping includes a ProductDesignVersionHierarchySelectionByElements 33016 entity. The ProductDesignVersionHierarchySelectionByElements 33016 entity has a cardinality of 1 33018 meaning that for each instance of the ProductDesignVersionHierarchySelectionByElements 33014 node element grouping there is one ProductDesignVersionHierarchySelectionByElements 33016 entity. The ProductDesignVersionHierarchySelectionByElements 33016 entity includes various subordinate entities, namely a RequestedDetailLevel 33022 and a SelectionByProductDesignVersionHierarchyElements 33064.

The RequestedDetailLevel 33022 entity has a cardinality of 1 33024 meaning that for each instance of the ProductDesignVersionHierarchySelectionByElements 33016 entity there is one RequestedDetailLevel 33022 entity. The RequestedDetailLevel 33022 entity includes various attributes, namely a MaximumExplosionRequiredIndicator 33028, a RetrieveAttachmentDataIndicator 33034, a RetrieveTextCollectionIndicator 33040, a RetrieveProductAssignmentIndicator 33046, a RetrieveProductionBillOfMaterialVariantHandoverindicator 33052 and a LanguageCode 33058.

The MaximumExplosionRequiredIndicator 33028 attribute is an Indicator 33032 data type. The MaximumExplosionRequiredIndicator 33028 attribute has a cardinality of 0 . . . 1 33030 meaning that for each instance of the RequestedDetailLevel 33022 entity there may be one MaximumExplosionRequiredIndicator 33028 attribute.

The RetrieveAttachmentDataIndicator 33034 attribute is an Indicator 33038 data type. The RetrieveAttachmentDataIndicator 33034 attribute has a cardinality of 0 . . . 1 33036 meaning that for each instance of the RequestedDetailLevel 33022 entity there may be one RetrieveAttachmentDataIndicator 33034 attribute.

The RetrieveTextCollectionIndicator 33040 attribute is an Indicator 33044 data type. The RetrieveTextCollectionIndicator 33040 attribute has a cardinality of 0 . . . 1 33042 meaning that for each instance of the RequestedDetailLevel 33022 entity there may be one RetrieveTextCollectionIndicator 33040 attribute.

The RetrieveProductAssignmentIndicator 33046 attribute is an Indicator 33050 data type. The RetrieveProductAssignmentIndicator 33046 attribute has a cardinality of 0 . . . 1 33048 meaning that for each instance of the RequestedDetailLevel 33022 entity there may be one RetrieveProductAssignmentIndicator 33046 attribute.

The RetrieveProductionBillOfMaterialVariantHandoverindicator 33052 attribute is an Indicator 33056 data type. The RetrieveProductionBillOfMaterialVariantHandoverindicator 33052 attribute has a cardinality of 0 . . . 1 33054 meaning that for each instance of the RequestedDetailLevel 33022 entity there may be one RetrieveProductionBillOfMaterialVariantHandoverindicator 33052 attribute.

The LanguageCode 33058 attribute is a LanguageCode 33062 data type. The LanguageCode 33058 attribute has a cardinality of 0 . . . 1 33060 meaning that for each instance of the RequestedDetailLevel 33022 entity there may be one LanguageCode 33058 attribute.

The SelectionByProductDesignVersionHierarchyElements 33064 entity has a cardinality of 1 . . . N 33066 meaning that for each instance of the ProductDesignVersionHierarchySelectionByElements 33016 entity there are one or more SelectionByProductDesignVersionHierarchyElements 33064 entities. The SelectionByProductDesignVersionHierarchyElements 33064 entity includes various attributes, namely a ProductDesignVersionUUID 33070, a ProductDesignID 33076, a ProductDesignVersionID 33082, an EngineeringDesignBusinessSystemID 33088, an EngineeringDesignInternalID 33094, an EngineeringDesignVersionInternalID 33100, a Quantity 33106, an ExplosionDate 33112, a MaximumHierarchyLevelOrdinalNumberValue 33118 and a VersionDeterminationCode 33124.

The ProductDesignVersionUUID 33070 attribute is an UUID 33074 data type. The ProductDesignVersionUUID 33070 attribute has a cardinality of 0 . . . 1 33072 meaning that for each instance of the SelectionByProductDesignVersionHierarchyElements 33064 entity there may be one ProductDesignVersionUUID 33070 attribute.

The ProductDesignID 33076 attribute is a ProductDesignID 33080 data type. The ProductDesignID 33076 attribute has a cardinality of 0 . . . 1 33078 meaning that for each instance of the SelectionByProductDesignVersionHierarchyElements 33064 entity there may be one ProductDesignID 33076 attribute.

The ProductDesignVersionID 33082 attribute is a VersionID 33086 data type. The ProductDesignVersionID 33082 attribute has a cardinality of 0 . . . 1 33084 meaning that for each instance of the SelectionByProductDesignVersionHierarchyElements 33064 entity there may be one ProductDesignVersionID 33082 attribute.

The EngineeringDesignBusinessSystemID 33088 attribute is a BusinessSystemID 33092 data type. The EngineeringDesignBusinessSystemID 33088 attribute has a cardinality of 0.1 33090 meaning that for each instance of the SelectionByProductDesignVersionHierarchyElements 33064 entity there may be one EngineeringDesignBusinessSystemID 33088 attribute.

The EngineeringDesignInternalID 33094 attribute is an EngineeringDesignInternalID 33098 data type. The EngineeringDesignInternalID 33094 attribute has a cardinality of 0 . . . 1 33096 meaning that for each instance of the SelectionByProductDesignVersionHierarchyElements 33064 entity there may be one EngineeringDesignInternalID 33094 attribute.

The EngineeringDesignVersionInternalID 33100 attribute is an EngineeringDesignVersionInternalID 33104 data type. The EngineeringDesignVersionInternalID 33100 attribute has a cardinality of 0 . . . 1 33102 meaning that for each instance of the SelectionByProductDesignVersionHierarchyElements 33064 entity there may be one EngineeringDesignVersionInternalID 33100 attribute.

The Quantity 33106 attribute is a NONNEGATIVE_Quantity 33110 data type. The Quantity 33106 attribute has a cardinality of 0 . . . 1 33108 meaning that for each instance of the SelectionByProductDesignVersionHierarchyElements 33064 entity there may be one Quantity 33106 attribute.

The ExplosionDate 33112 attribute is a Date 33116 data type. The ExplosionDate 33112 attribute has a cardinality of 0 . . . 1 33114 meaning that for each instance of the SelectionByProductDesignVersionHierarchyElements 33064 entity there may be one ExplosionDate 33112 attribute.

The MaximumHierarchyLevelOrdinalNumberValue 33118 attribute is an OrdinalNumberValue 33122 data type. The MaximumHierarchyLevelOrdinalNumberValue 33118 attribute has a cardinality of 0 . . . 1 33120 meaning that for each instance of the SelectionByProductDesignVersionHierarchyElements 33064 entity there may be one MaximumHierarchyLevelOrdinalNumberValue 33118 attribute.

The VersionDeterminationCode 33124 attribute is a ProductDesignVersionDeterminationMethodCode 33128 data type. The VersionDeterminationCode 33124 attribute has a cardinality of 0 . . . 1 33126 meaning that for each instance of the SelectionByProductDesignVersionHierarchyElements 33064 entity there may be one VersionDeterminationCode 33124 attribute.

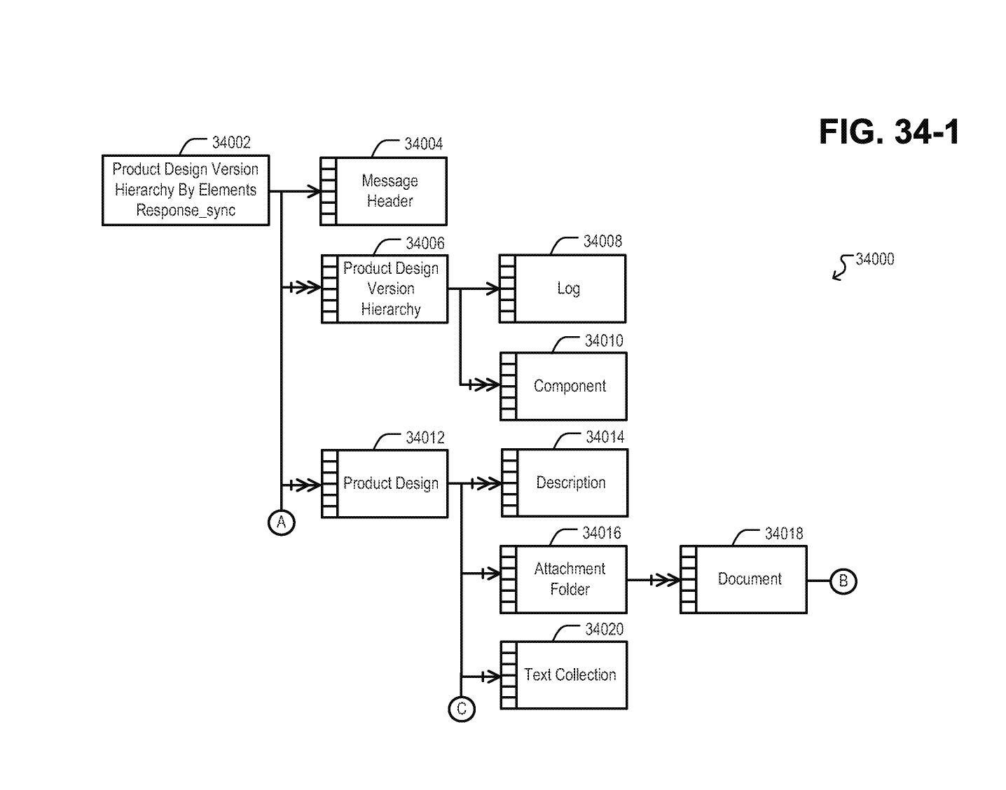

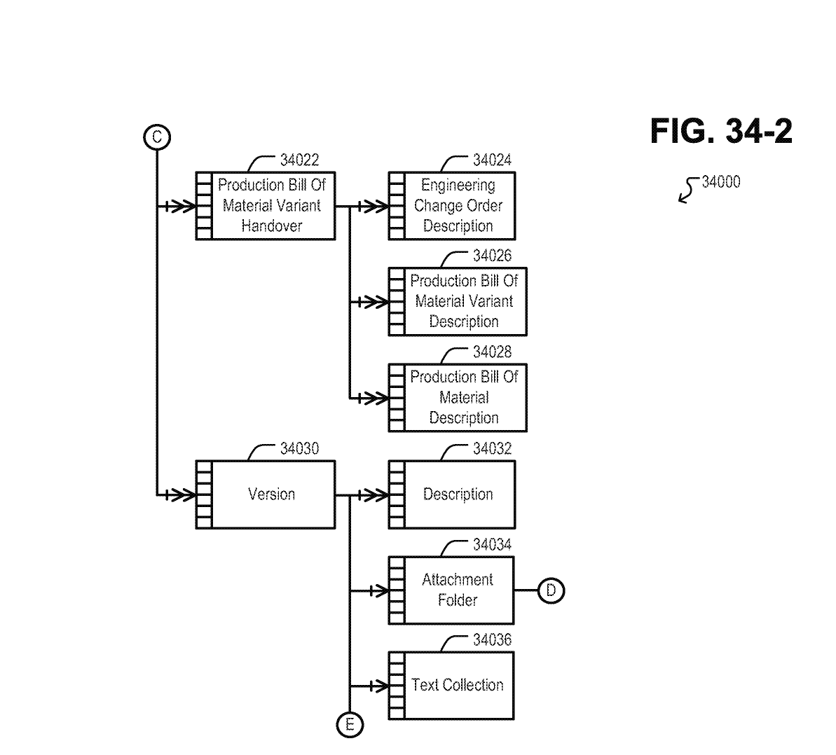

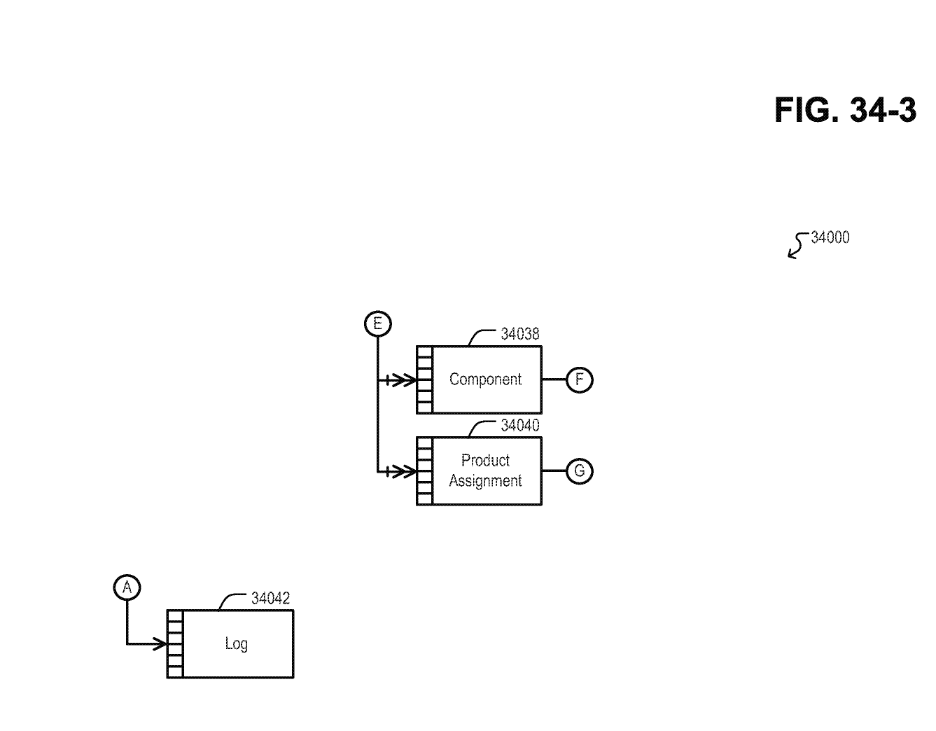

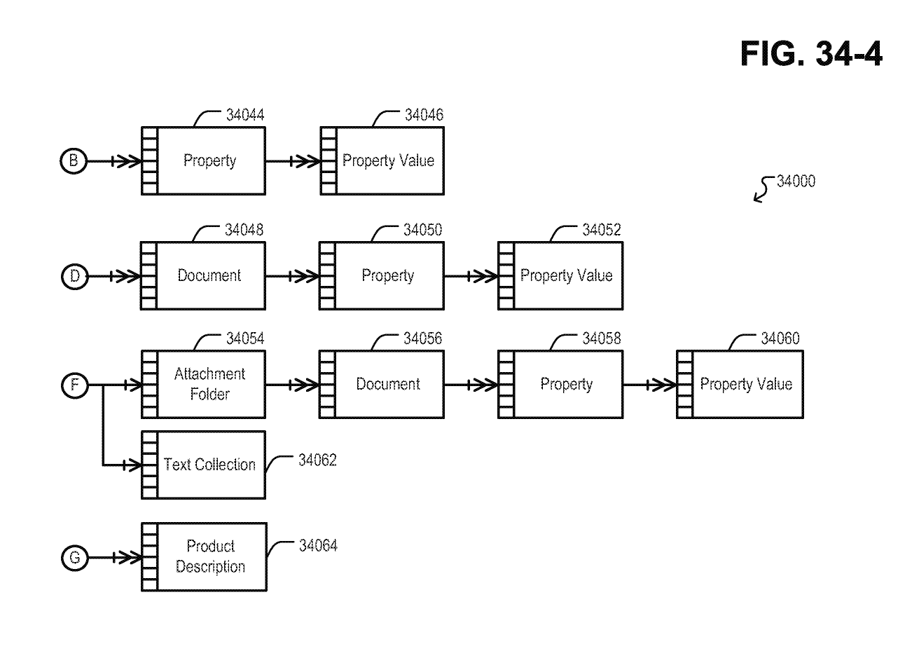

FIGS. 34-1 to 34-4 collectively illustrate one example logical configuration of a Product Design Version Hierarchy By Elements Response_sync message 34000. Specifically, these figures depict the arrangement and hierarchy of various components such as one or more levels of packages, entities, and datatypes, shown here as 34002 through 34064. As described above, packages may be used to represent hierarchy levels. Entities are discrete business elements that are used during a business transaction. Data types are used to type object entities and interfaces with a structure. For example, the Product Design Version Hierarchy By Elements Response_sync message 34000 includes, among other things, a Product Design Version Hierarchy entity 34006. Accordingly, heterogeneous applications may communicate using this consistent message configured as such.

The message type Product Design Version Hierarchy By Elements Response_sync is derived from the business object Product Design Version Hierarchy as a leading object together with its operation signature. The message data type Product Design Version Hierarchy By Elements Response_sync is a response to a query of an external engineering system about a product design version hierarchy. The structure of the message type Product Design Version Hierarchy By Elements Response_sync is determined by the message data type ProductDesignVersionHierarchyByElementsResponseMessage_sync. The message data type ProductDesignVersionHierarchyByElementsResponseMessage_sync may be used to provide information about a product design version hierarchy to an external engineering system. The message data type ProductDesignVersionHierarchyByElementsResponseMessage_sync includes the MessageHeader package, the ProductDesignVersionHierarchy package, the ProductDesign package, and the Log package.

The package MessageHeader includes the sub-packages Party and Business Scope and the entity MessageHeader. MessageHeader is typed by BusinessDocumentMessageHeader. The package ProductDesignVersionHierarchy includes the sub-package Component and the entity ProductDesignVersionHierarchy.

ProductDesignVersionHierarchy includes the following non-node elements: UUID, ProductDesignVersionUUID, ProductDesignID, ProductDesignVersionID, EngineeringDesignBusinessSystemID, EngineeringDesignInternalID, and EngineeringDesignVersionInternalID. UUID may have a multiplicity of 1 and may be based on datatype BGDT:UUID. ProductDesignVersionUUID may have a multiplicity of 0 . . . 1 and may be based on datatype BGDT:UUID. ProductDesignID may have a multiplicity of 0 . . . 1 and may be based on datatype BGDT:ProductDesignID. ProductDesignVersionID may have a multiplicity of 0 . . . 1 and may be based on datatype BGDT:VersionID. EngineeringDesignBusinessSystemID may have a multiplicity of 0 . . . 1 and may be based on datatype BGDT:BusinessSystemID EngineeringDesignInternalID may have a multiplicity of 0 . . . 1 and may be based on datatype BGDT:EngineeringDesignInternalID. EngineeringDesignVersionInternalID may have a multiplicity of 0 . . . 1 and may be based on datatype BGDT:EngineeringDesignVersionInternalID. ProductDesignVersionHierarchy includes the node element Log in a 1:1 cardinality relationship and the node element Component in a 1:CN cardinality relationship. Log is typed by datatype Log.

The package ProductDesignVersionHierarchyComponent includes the entity Component. Component includes the following non-node elements: UUID, ParentComponentUUID, ProductDesignUUID, ProductDesignVersionUUID, Quantity, and ProductDesignVersionComponentID. UUID may have a multiplicity of 0 . . . 1 and may be based on datatype BGDT:UUID. ParentComponentUUID may have a multiplicity of 0 . . . 1 and may be based on datatype BGDT:UUID. ProductDesignUUID may have a multiplicity of 0 . . . 1 and may be based on datatype BGDT:UUID. ProductDesignVersionUUID may have a multiplicity of 0 . . . 1 and may be based on datatype BGDT:UUID. Quantity may have a multiplicity of 0 . . . 1 and may be based on datatype CDT:NONNEGATIVE_Quantity. ProductDesignVersionComponentID may have a multiplicity of 0 . . . 1 and may be based on datatype BGDT:ProductDesignComponentID.

The package ProductDesign includes the sub-packages ProductionBillOfMaterialVariantHandover and Version and the entity ProductDesign. ProductDesign includes the following non-node elements: UUID, ID, CategoryCode, CategoryName, ResponsibleEmployeeUUID, ResponsibleEmployeeID, EngineeringDesignIdentification, EngineeringDesignBusinessSystemID, EngineeringDesignBusinessSystemName, EngineeringDesignID, EngineeringDesignInternalID, MostRecentlyCreatedVersionUUID, SystemAdministrativeData, CreationIdentity, PersonNameGivenName, PersonNameFamilyName, LastChangeIdentity, PersonNameGivenName, PersonNameFamilyName, ResponsibleEmployee, PersonNameGivenName, and PersonNameFamilyName. UUID may have a multiplicity of 0 . . . 1 and may be based on datatype BGDT:UUID. ID may have a multiplicity of 0 . . . 1 and may be based on datatype BGDT:ProductDesignID. CategoryCode may have a multiplicity of 0 . . . 1 and may be based on datatype BGDT:ProductDesignCategoryCode. CategoryName may have a multiplicity of 0 . . . 1 and may be based on datatype CDT:LANGUAGEINDEPENDENT_LONG_Name. ResponsibleEmployeeUUID may have a multiplicity of 0 . . . 1 and may be based on datatype BGDT:UUID. ResponsibleEmployeeID may have a multiplicity of 0 . . . 1 and may be based on datatype BGDT:EmployeeID. EngineeringDesignIdentification may have a multiplicity of 0 . . . 1 and may be based on datatype MIDT:ProductDesignVersionHierarchyByElementsResponseProductDesignEngineeringDesi gnIdentification. EngineeringDesignBusinessSystemID may have a multiplicity of 0 . . . 1 and may be based on datatype BGDT:BusinessSystemID EngineeringDesignBusinessSystemName may have a multiplicity of 0 . . . 1 and may be based on datatype CDT:LANGUAGEINDEPENDENT_LONG_Name. EngineeringDesignID may have a multiplicity of 0 . . . 1 and may be based on datatype BGDT:EngineeringDesignID. EngineeringDesignInternalID may have a multiplicity of 0 . . . 1 and may be based on datatype BGDT:EngineeringDesignInternalID. MostRecentlyCreatedVersionUUID may have a multiplicity of 0 . . . 1 and may be based on datatype BGDT:UUID. SystemAdministrativeData may have a multiplicity of 0 . . . 1 and may be based on datatype AGDT:SystemAdministrativeData. CreationIdentity may have a multiplicity of 1 and may be based on datatype MIDT:ProductDesignVersionHierarchyByElementsResponseProductDesignPersonName. PersonNameGivenName may have a multiplicity of 1 and may be based on datatype CDT:LANGUAGEINDEPENDENT_MEDIUM_Name. PersonNameFamilyName may have a multiplicity of 1 and may be based on datatype CDT:LANGUAGEINDEPENDENT_MEDIUM_Name. LastChangeIdentity may have a multiplicity of 1 and may be based on datatype MIDT:ProductDesignVersionHierarchyByElementsResponseProductDesignPersonName. PersonNameGivenName may have a multiplicity of 1 and may be based on datatype CDT:LANGUAGEINDEPENDENT_MEDIUM_Name. PersonNameFamilyName may have a multiplicity of 1 and may be based on datatype CDT:LANGUAGEINDEPENDENT_MEDIUM_Name. ResponsibleEmployee may have a multiplicity of 0 . . . 1 and may be based on datatype MIDT:ProductDesignVersionHierarchyByElementsResponseProductDesignPersonName. PersonNameGivenName may have a multiplicity of 1 and may be based on datatype CDT:LANGUAGEINDEPENDENT_MEDIUM_Name. PersonNameFamilyName may have a multiplicity of 1 and may be based on datatype CDT:LANGUAGEINDEPENDENT_MEDIUM_Name.

ProductDesign includes the following node elements: Description, in a 1:CN cardinality relationship; AttachmentFolder, in a 1:C cardinality relationship; TextCollection, in a 1:C cardinality relationship; ProductionBillOfMaterialVariantHandover, in a 1:CN cardinality relationship; and Version, in a 1:CN cardinality relationship. The package ProductDesign includes the entities Description, AttachmentFolder, and TextCollection.

Description includes the following non-node elements: Description, which may have a multiplicity of 0 . . . 1 and may be based on datatype BGDT:MEDIUM_Description. AttachmentFolder includes the following non-node elements: UUID, which may have a multiplicity of 0 . . . 1 and may be based on datatype BGDT:UUID. Attachment includes the node element Document in a 1:CN cardinality relationship.

Document includes the following non-node elements: UUID, VersionID, SystemAdministrativeData, LinkInternalIndicator, CheckedOutIndicator, VisibleIndicator, VersioningEnabledIndicator, CategoryCode, CategoryName, TypeCode, TypeName, MIMECode, MIMEName, PathName, Name, AlternativeName, InternalLinkUUID, Description, ExternalLinkWebURI, FileContentURI, and FilesizeMeasure. UUID may have a multiplicity of 0 . . . 1 and may be based on datatype BGDT:UUID. VersionID may have a multiplicity of 0 . . . 1 and may be based on datatype BGDT:VersionID. SystemAdministrativeData may have a multiplicity of 0 . . . 1 and may be based on datatype AGDT:SystemAdministrativeData. LinkInternalIndicator may have a multiplicity of 0 . . . 1 and may be based on datatype CDT:Indicator. CheckedOutIndicator may have a multiplicity of 0 . . . 1 and may be based on datatype CDT:Indicator. VisibleIndicator may have a multiplicity of 0.1 and may be based on datatype CDT:Indicator. VersioningEnabledIndicator may have a multiplicity of 0 . . . 1 and may be based on datatype CDT:Indicator. CategoryCode may have a multiplicity of 0 . . . 1 and may be based on datatype BGDT:DocumentCategoryCode. CategoryName may have a multiplicity of 0 . . . 1 and may be based on datatype CDT:LANGUAGEINDEPENDENT_LONG_Name. TypeCode may have a multiplicity of 0 . . . 1 and may be based on datatype BGDT:DocumentTypeCode. TypeName may have a multiplicity of 0 . . . 1 and may be based on datatype CDT:LANGUAGEINDEPENDENT_LONG_Name. MIMECode may have a multiplicity of 0 . . . 1 and may be based on datatype BGDT:MIMECode. MIMEName may have a multiplicity of 0.1 and may be based on datatype CDT:LANGUAGEINDEPENDENT_LONG_Name. PathName may have a multiplicity of 0 . . . 1 and may be based on datatype CDT:LANGUAGEINDEPENDENT_Name. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. FileContentURI may have a multiplicity of 0 . . . 1 and may be based on datatype BGDT:URI. FilesizeMeasure may have a multiplicity of 0 . . . 1 and may be based on datatype CDT:Measure.

Document includes the node element Property in a 1:CN cardinality relationship. Property includes the following non-node elements: TechnicalID, Name, DataTypeFormatCode, DataTypeFormatName, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0.1 and may be based on datatype BGDT:PropertyDataTypeFormatCode. DataTypeFormatName may have a multiplicity of 0 . . . 1 and may be based on datatype CDT:LANGUAGEINDEPENDENT_LONG_Name. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description.

Property includes the node element PropertyValue in a 1:CN cardinality relationship. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

TextCollection includes the following non-node elements: UUID, Text, TechnicalID, TypeCode, TypeName, LanguageCode, LanguageName, SystemAdministrativeData, CreationDateTime, TextContent, TechnicalID, and Text. UUID may have a multiplicity of 0 . . . 1 and may be based on datatype BGDT:UUID. Text may have a multiplicity of 0 . . . * and may be based on datatype MIDT:AccessTextCollectionText. TechnicalID may have a multiplicity of 0 . . . 1 and may be based on datatype BGDT:ObjectNodeTechnicalID. TypeCode may have a multiplicity of 0 . . . 1 and may be based on datatype BGDT:TextCollectionTextTypeCode. TypeName may have a multiplicity of 0 . . . 1 and may be based on datatype CDT:LANGUAGEINDEPENDENT_LONG_Name. LanguageCode may have a multiplicity of 0 . . . 1 and may be based on datatype BGDT:LanguageCode. LanguageName may have a multiplicity of 0 . . . 1 and may be based on datatype CDT:LANGUAGEINDEPENDENT_LONG_Name. SystemAdministrativeData may have a multiplicity of 0 . . . 1 and may be based on datatype AGDT:SystemAdministrativeData. CreationDateTime may have a multiplicity of 0 . . . 1 and may be based on datatype CDT:GLOBAL_DateTime. TextContent may have a multiplicity of 0 . . . 1 and may be based on datatype MIDT:AccessTextCollectionTextTextContent. TechnicalID may have a multiplicity of 0.1 and may be based on datatype BGDT:ObjectNodeTechnicalID. Text may have a multiplicity of 0 . . . 1 and may be based on datatype CDT:Text.

The package ProductDesignProductionBillOfMaterialVariantHandover includes the entity ProductionBillOfMaterialVariantHandover. ProductionBillOfMaterialVariantHandover includes the following non-node elements: UUID, ProductDesignVersionUUID, ProductDesignVersionID, EngineeringChangeOrderUUID, EngineeringChangeOrderID, ProductionBillOfMaterialVariantUUID, ProductionBillOfMaterialVariantKey, BillOfMaterialVariantID, BillOfMaterialID, SystemAdministrativeData, CreationIdentity, PersonNameGivenName, PersonNameFamilyName, LastChangeIdentity, PersonNameGivenName, and PersonNameFamilyName. UUID may have a multiplicity of 0 . . . 1 and may be based on datatype BGDT:UUID. ProductDesignVersionUUID may have a multiplicity of 0 . . . 1 and may be based on datatype BGDT:UUID. ProductDesignVersionID may have a multiplicity of 0 . . . 1 and may be based on datatype BGDT:VersionID. EngineeringChangeOrderUUID may have a multiplicity of 0 . . . 1 and may be based on datatype BGDT:UUID. EngineeringChangeOrderID may have a multiplicity of 0 . . . 1 and may be based on datatype BGDT:EngineeringChangeOrderID. ProductionBillOfMaterialVariantUUID may have a multiplicity of 0 . . . 1 and may be based on datatype BGDT:UUID. ProductionBillOfMaterialVariantKey may have a multiplicity of 0 . . . 1 and may be based on datatype MIDT:ProductDesignVersionHierarchyByIDResponseProductionBillOfMaterialVariantHand overProductionBillOfMaterialVariantKey. BillOfMaterialVariantID may have a multiplicity of 0.1 and may be based on datatype BGDT:BillOfMaterialVariantID. BillOfMaterialID may have a multiplicity of 0 . . . 1 and may be based on datatype BGDT:BillOfMaterialID. SystemAdministrativeData may have a multiplicity of 0 . . . 1 and may be based on datatype AGDT:SystemAdministrativeData. CreationIdentity may have a multiplicity of 1 and may be based on datatype MIDT:ProductDesignVersionHierarchyByElementsResponseProductDesignPersonName. PersonNameGivenName may have a multiplicity of 1 and may be based on datatype CDT:LANGUAGEINDEPENDENT_MEDIUM_Name. PersonNameFamilyName may have a multiplicity of 1 and may be based on datatype CDT:LANGUAGEINDEPENDENT_MEDIUM_Name. LastChangeIdentity may have a multiplicity of 1 and may be based on datatype MIDT:ProductDesignVersionHierarchyByElementsResponseProductDesignPersonName. PersonNameGivenName may have a multiplicity of 1 and may be based on datatype CDT:LANGUAGEINDEPENDENT_MEDIUM_Name. PersonNameFamilyName may have a multiplicity of 1 and may be based on datatype CDT:LANGUAGEINDEPENDENT_MEDIUM_Name.

ProductionBillOfMaterialVariantHandover includes the node elements EngineeringChangeOrderDescription in a 1:CN cardinality relationship; ProductionBillOfMaterialVariantDescription in a 1:CN cardinality relationship; and ProductionBillOfMateriaIDescription in a 1:CN cardinality relationship. The package ProductDesignProductionBillOfMaterialVariantHandover includes the entities EngineeringChangeOrderDescription, ProductionBillOfMaterialVariantDescription, and ProductionBillOfMateriaIDescription.

EngineeringChangeOrderDescription includes the following non-node elements: Description, which may have a multiplicity of 0 . . . 1 and which may be based on datatype BGDT:SHORT_Description. ProductionBillOfMaterialVariantDescription includes the following non-node elements: Description, which may have a multiplicity of 0 . . . 1 and may be based on datatype BGDT:MEDIUM_Description. ProductionBillOfMateriaIDescription includes the following non-node elements: Description, which may have a multiplicity of 0 . . . 1 and may be based on datatype BGDT:MEDIUM_Description.

The package ProductDesignVersion includes the sub-packages Component and ProductAssignment and the entity Version. Version includes the following non-node elements: UUID, ID, Name, EngineeringDesignVersionIdentification, ManuallyCreatedIndicator, AssemblyIndicator, PredecessorVersionUUID, PredecessorVersionEngineeringDesignVersionIdentification, BaseQuantity, BaseQuantityTypeCode, BaseQuantityTypeName, ProposedProcurementMethodCode, ProposedProcurementMethodName, ValidityStartDate, ActivationDate, ActivationTime, EngineeringDesignVersionStatusName, EngineeringDesignVersionReleaseDate, EngineeringDesignVersionResponsibleEngineerPersonGivenName, EngineeringDesignVersionResponsibleEngineerPersonFamilyName, EngineeringDesignVersionReplicationCancelledIndicator, EngineeringDesignVersionPrimaryViewableCreationDateTime, EngineeringDesignChangeOrderID, ApplicationLogUUID, EngineeringDesignVersionCreationDateTime, EngineeringDesignVersionLastChangeDateTime, SystemAdministrativeData, Status, CreationIdentity, and LastChangeIdentity. EngineeringDesignVersionIdentification may include EngineeringDesignVersionID and EngineeringDesignVersionInternalID. PredecessorVersionEngineeringDesignVersionIdentification may include EngineeringDesignBusinessSystemID, EngineeringDesignBusinessSystemName, EngineeringDesignID, EngineeringDesignInternalID, EngineeringDesignVersionID, and EngineeringDesignVersionInternalID. Status may include LifeCycleStatusCode, LifeCycleStatusName, ObsolescenceStatusCode, ObsolescenceStatusName, BlockingStatusCode, BlockingStatusName, ReviewProcessingStatusCode, ReviewProcessingStatusName, ActivationStatusCode, ActivationStatusName, EngineeringDesignVersionReleaseStatusCode, EngineeringDesignVersionReleaseStatusName, ConsistencyStatusCode, and ConsistencyStatusName. CreationIdentity and LastChangeIdentity may each include PersonNameGivenName and PersonNameFamilyName. UUID may have a multiplicity of 0 . . . 1 and may be based on datatype BGDT:UUID. ID may have a multiplicity of 0 . . . 1 and may be based on datatype BGDT:VersionID. Name may have a multiplicity of 0 . . . 1 and may be based on datatype CDT:LANGUAGEINDEPENDENT_MEDIUM_Name. EngineeringDesignVersionIdentification may have a multiplicity of 0 . . . 1 and may be based on datatype MIDT:ProductDesignVersionHierarchyByElementsResponseVersionEngineeringDesignVersionIdentification. EngineeringDesignVersionID may have a multiplicity of 0 . . . 1 and may be based on datatype BGDT:EngineeringDesignVersionID. EngineeringDesignVersionInternalID may have a multiplicity of 0 . . . 1 and may be based on datatype BGDT:EngineeringDesignVersionInternalID. ManuallyCreatedIndicator may have a multiplicity of 0 . . . 1 and may be based on datatype CDT:Indicator. AssemblyIndicator may have a multiplicity of 0 . . . 1 and may be based on datatype CDT:Indicator. PredecessorVersionUUID may have a multiplicity of 0 . . . 1 and may be based on datatype BGDT:UUID. PredecessorVersionEngineeringDesignVersionIdentification may have a multiplicity of 0 . . . 1 and may be based on datatype MIDT:ProductDesignVersionHierarchyByElementsResponseVersionPredecessorVersionEngineeringDesignVersionIdentification. EngineeringDesignBusinessSystemID may have a multiplicity of 0 . . . 1 and may be based on datatype BGDT:BusinessSystemID EngineeringDesignBusinessSystemName may have a multiplicity of 0 . . . 1 and may be based on datatype CDT:LANGUAGEINDEPENDENT_LONG_Name. EngineeringDesignID may have a multiplicity of 0 . . . 1 and may be based on datatype BGDT:EngineeringDesignID. EngineeringDesignInternalID may have a multiplicity of 0 . . . 1 and may be based on datatype BGDT:EngineeringDesignInternalID. EngineeringDesignVersionID may have a multiplicity of 0.1 and may be based on datatype BGDT:EngineeringDesignVersionID. EngineeringDesignVersionInternalID may have a multiplicity of 0 . . . 1 and may be based on datatype BGDT:EngineeringDesignVersionInternalID. BaseQuantity may have a multiplicity of 0.1 and may be based on datatype CDT:POSITIVE_Quantity. BaseQuantityTypeCode may have a multiplicity of 0 . . . 1 and may be based on datatype BGDT:QuantityTypeCode. BaseQuantityTypeName may have a multiplicity of 0 . . . 1 and may be based on datatype CDT:LANGUAGEINDEPENDENT_LONG_Name. ProposedProcurementMethodCode may have a multiplicity of 0 . . . 1 and may be based on datatype BGDT:ProcurementMethodCode. ProposedProcurementMethodName may have a multiplicity of 0 . . . 1 and may be based on datatype CDT:LANGUAGEINDEPENDENT_LONG_Name. ValidityStartDate may have a multiplicity of 0 . . . 1 and may be based on datatype CDT:Date. ActivationDate may have a multiplicity of 0 . . . 1 and may be based on datatype CDT:Date. ActivationTime may have a multiplicity of 0 . . . 1 and may be based on datatype CDT:Time. EngineeringDesignVersionStatusName may have a multiplicity of 0 . . . 1 and may be based on datatype CDT:LANGUAGEINDEPENDENT_MEDIUM_Name. EngineeringDesignVersionReleaseDate may have a multiplicity of 0 . . . 1 and may be based on datatype CDT:Date. EngineeringDesignVersionResponsibleEngineerPersonGivenName may have a multiplicity of 0 . . . 1 and may be based on datatype CDT:LANGUAGEINDEPENDENT_MEDIUM_Name. EngineeringDesignVersionResponsibleEngineerPersonFamilyName may have a multiplicity of 0.1 and may be based on datatype CDT:LANGUAGEINDEPENDENT_MEDIUM_Name. EngineeringDesignVersionReplicationCancelledIndicator may have a multiplicity of 0 . . . 1 and may be based on datatype CDT:Indicator. EngineeringDesignVersionPrimaryViewableCreationDateTime may have a multiplicity of 0 . . . 1 and may be based on datatype CDT:GLOBAL_DateTime. EngineeringDesignChangeOrderID may have a multiplicity of 0 . . . 1 and may be based on datatype BGDT:EngineeringDesignChangeOrderID. ApplicationLogUUID may have a multiplicity of 0 . . . 1 and may be based on datatype BGDT:UUID. EngineeringDesignVersionCreationDateTime may have a multiplicity of 0 . . . 1 and may be based on datatype CDT:GLOBAL_DateTime. EngineeringDesignVersionLastChangeDateTime may have a multiplicity of 0 . . . 1 and may be based on datatype CDT:GLOBAL_DateTime. SystemAdministrativeData may have a multiplicity of 0 . . . 1 and may be based on datatype AGDT:SystemAdministrativeData. Status may have a multiplicity of 0 . . . 1 and may be based on datatype MIDT:ProductDesignVersionHierarchyByElementsResponseVersionStatus. LifeCycleStatusCode may have a multiplicity of 0 . . . 1 and may be based on datatype BGDT:ProductDesignVersionLifeCycleStatusCode. LifeCycleStatusName may have a multiplicity of 0 . . . 1 and may be based on datatype CDT:LANGUAGEINDEPENDENT_LONG_Name. ObsolescenceStatusCode may have a multiplicity of 0 . . . 1 and may be based on datatype BGDT:ObsolescenceStatusCode. ObsolescenceStatusName may have a multiplicity of 0 . . . 1 and may be based on datatype CDT:LANGUAGEINDEPENDENT_LONG_Name. BlockingStatusCode may have a multiplicity of 0 . . . 1 and may be based on datatype BGDT:NOTBLOCKEDBLOCKED_BlockingStatusCode. BlockingStatusName may have a multiplicity of 0 . . . 1 and may be based on datatype CDT:LANGUAGEINDEPENDENT_LONG_Name. ReviewProcessingStatusCode may have a multiplicity of 0 . . . 1 and may be based on datatype BGDT:ProcessingStatusCode. ReviewProcessingStatusName may have a multiplicity of 0 . . . 1 and may be based on datatype CDT:LANGUAGEINDEPENDENT_LONG_Name. ActivationStatusCode may have a multiplicity of 0 . . . 1 and may be based on datatype BGDT:INACTIVEACTIVE_ActivationStatusCode. ActivationStatusName may have a multiplicity of 0 . . . 1 and may be based on datatype CDT:LANGUAGEINDEPENDENT_LONG_Name. EngineeringDesignVersionReleaseStatusCode may have a multiplicity of 0 . . . 1 and may be based on datatype BGDT:EngineeringDesignVersionReleaseStatusCode. EngineeringDesignVersionReleaseStatusName may have a multiplicity of 0 . . . 1 and may be based on datatype CDT:LANGUAGEINDEPENDENT_LONG_Name. ConsistencyStatusCode may have a multiplicity of 0 . . . 1 and may be based on datatype BGDT:ConsistencyStatusCode. ConsistencyStatusName may have a multiplicity of 0 . . . 1 and may be based on datatype CDT:LANGUAGEINDEPENDENT_LONG_Name. CreationIdentity may have a multiplicity of 0 . . . 1 and may be based on datatype MIDT:ProductDesignVersionHierarchyByElementsResponseProductDesignPersonName. PersonNameGivenName may have a multiplicity of 1 and may be based on datatype CDT:LANGUAGEINDEPENDENT_MEDIUM_Name. PersonNameFamilyName may have a multiplicity of 1 and may be based on datatype CDT:LANGUAGEINDEPENDENT_MEDIUM_Name. LastChangeIdentity may have a multiplicity of 0 . . . 1 and may be based on datatype MIDT:ProductDesignVersionHierarchyByElementsResponseProductDesignPersonName.

Version includes the following node elements: Description, in a 1:CN cardinality relationship; AttachmentFolder, in a 1:C cardinality relationship; TextCollection, in a 1:C cardinality relationship; Component, in a 1:CN cardinality relationship; and ProductAssignment, in a 1:CN cardinality relationship. Description includes the Description non-node element, which may have a multiplicity of 0 . . . 1 and may be based on datatype BGDT:MEDIUM_Description.

AttachmentFolder includes the UUID non-node element, which may have a multiplicity of 0 . . . 1 and may be based on datatype BGDT:UUID. AttachmentFolder includes the node element Document in a 1:CN cardinality relationship. The package ProductDesignVersion includes the entity Document. Document includes the following non-node elements: UUID, VersionID, SystemAdministrativeData, LinkInternalIndicator, CheckedOutIndicator, VisibleIndicator, VersioningEnabledIndicator, CategoryCode, CategoryName, TypeCode, TypeName, MIMECode, MIMEName, PathName, Name, AlternativeName, InternalLinkUUID, Description, ExternalLinkWebURI, FileContentURI, and FilesizeMeasure. UUID may have a multiplicity of 0 . . . 1 and may be based on datatype BGDT:UUID. VersionID may have a multiplicity of 0 . . . 1 and may be based on datatype BGDT:VersionID. SystemAdministrativeData may have a multiplicity of 0 . . . 1 and may be based on datatype AGDT: SystemAdministrativeData. LinkInternalIndicator may have a multiplicity of 0 . . . 1 and may be based on datatype CDT:Indicator. CheckedOutIndicator may have a multiplicity of 0 . . . 1 and may be based on datatype CDT:Indicator. VisibleIndicator may have a multiplicity of 0 . . . 1 and may be based on datatype CDT:Indicator. VersioningEnabledIndicator may have a multiplicity of 0 . . . 1 and may be based on datatype CDT:Indicator. CategoryCode may have a multiplicity of 0 . . . 1 and may be based on datatype BGDT:DocumentCategoryCode. CategoryName may have a multiplicity of 0 . . . 1 and may be based on datatype CDT:LANGUAGEINDEPENDENT_LONG_Name. TypeCode may have a multiplicity of 0 . . . 1 and may be based on datatype BGDT:DocumentTypeCode. TypeName may have a multiplicity of 0 . . . 1 and may be based on datatype CDT:LANGUAGEINDEPENDENT_LONG_Name. MIMECode may have a multiplicity of 0 . . . 1 and may be based on datatype BGDT:MIMECode. MIMEName may have a multiplicity of 0 . . . 1 and may be based on datatype CDT:LANGUAGEINDEPENDENT_LONG_Name. PathName may have a multiplicity of 0 . . . 1 and may be based on datatype CDT:LANGUAGEINDEPENDENT_Name. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. FileContentURI may have a multiplicity of 0 . . . 1 and may be based on datatype BGDT:URI. FilesizeMeasure may have a multiplicity of 0 . . . 1 and may be based on datatype CDT:Measure.

Document includes the node element Property in a 1:CN cardinality relationship. Property includes the following non-node elements: TechnicalID, Name, DataTypeFormatCode, DataTypeFormatName, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0.1 and may be based on datatype BGDT:PropertyDataTypeFormatCode. DataTypeFormatName may have a multiplicity of 0 . . . 1 and may be based on datatype CDT:LANGUAGEINDEPENDENT_LONG_Name. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description.

Property includes the node element PropertyValue in a 1:CN cardinality relationship. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

TextCollection includes the following non-node elements: UUID and Text. Text may include TechnicalID, TypeCode, TypeName, LanguageCode, LanguageName, SystemAdministrativeData, CreationDateTime, and TextContent. TextContent may include TechnicalID, and Text. UUID may have a multiplicity of 0 . . . 1 and may be based on datatype BGDT:UUID. Text may have a multiplicity of 0 . . . * and may be based on datatype MIDT:AccessTextCollectionText. TechnicalID may have a multiplicity of 0 . . . 1 and may be based on datatype BGDT:ObjectNodeTechnicalID. TypeCode may have a multiplicity of 0 . . . 1 and may be based on datatype BGDT:TextCollectionTextTypeCode. TypeName may have a multiplicity of 0 . . . 1 and may be based on datatype CDT:LANGUAGEINDEPENDENT_LONG_Name. LanguageCode may have a multiplicity of 0.1 and may be based on datatype BGDT:LanguageCode. LanguageName may have a multiplicity of 0 . . . 1 and may be based on datatype CDT:LANGUAGEINDEPENDENT_LONG_Name. SystemAdministrativeData may have a multiplicity of 0 . . . 1 and may be based on datatype AGDT: SystemAdministrativeData. CreationDateTime may have a multiplicity of 0 . . . 1 and may be based on datatype CDT:GLOBAL_DateTime. TextContent may have a multiplicity of 0 . . . 1 and may be based on datatype MIDT:AccessTextCollectionTextTextContent. TechnicalID may have a multiplicity of 0.1 and may be based on datatype BGDT:ObjectNodeTechnicalID. Text may have a multiplicity of 0 . . . 1 and may be based on datatype CDT:Text.

The package ProductDesignVersionComponent includes the entity Component. Component includes the following non-node elements: UUID, ProductDesignComponentID, BaseQuantity, BaseQuantityTypeCode, BaseQuantityTypeName, ProductDesignUUID, ProductDesignID, ProductDesignEngineeringDesignIdentification, ProductDesignVersionUUID, ProductDesignVersionID, and ProductDesignVersionEngineeringDesignVersionIdentification. ProductDesignEngineeringDesignIdentification may include EngineeringDesignBusinessSystemID, EngineeringDesignBusinessSystemName, EngineeringDesignID, and EngineeringDesignInternalID. ProductDesignVersionEngineeringDesignVersionIdentification may include EngineeringDesignVersionID and EngineeringDesignVersionInternalID. UUID may have a multiplicity of 1 and may be based on datatype BGDT:UUID. ProductDesignComponentID may have a multiplicity of 1 and may be based on datatype BGDT:ProductDesignComponentID. BaseQuantity may have a multiplicity of 1 and may be based on datatype CDT:POSITIVE_Quantity. BaseQuantityTypeCode may have a multiplicity of 1 and may be based on datatype BGDT:QuantityTypeCode. BaseQuantityTypeName may have a multiplicity of 1 and may be based on datatype CDT:LANGUAGEINDEPENDENT_LONG_Name. ProductDesignUUID may have a multiplicity of 1 and may be based on datatype BGDT:UUID. ProductDesignID may have a multiplicity of 1 and may be based on datatype BGDT:ProductDesignID ProductDesignEngineeringDesignIdentification may have a multiplicity of 1 and may be based on datatype MIDT:ProductDesignVersionHierarchyByElementsResponseProductDesignEngineeringDesi gnIdentification. EngineeringDesignBusinessSystemID may have a multiplicity of 0 . . . 1 and may be based on datatype BGDT:BusinessSystemID EngineeringDesignBusinessSystemName may have a multiplicity of 0 . . . 1 and may be based on datatype CDT:LANGUAGEINDEPENDENT_LONG_Name. EngineeringDesignID may have a multiplicity of 0 . . . 1 and may be based on datatype BGDT:EngineeringDesignID. EngineeringDesignInternalID may have a multiplicity of 0 . . . 1 and may be based on datatype BGDT:EngineeringDesignInternalID. ProductDesignVersionUUID may have a multiplicity of 1 and may be based on datatype BGDT:UUID. ProductDesignVersionID may have a multiplicity of 1 and may be based on datatype BGDT:VersionID. ProductDesignVersionEngineeringDesignVersionIdentification may have a multiplicity of 1 and may be based on datatype MIDT:ProductDesignVersionHierarchyByElementsResponseVersionEngineeringDesignVersionIdentification. EngineeringDesignVersionID may have a multiplicity of 0 . . . 1 and may be based on datatype BGDT:EngineeringDesignVersionID. EngineeringDesignVersionInternalID may have a multiplicity of 0 . . . 1 and may be based on datatype BGDT:EngineeringDesignVersionInternalID.

Component includes the node element AttachmentFolder in a 1:C cardinality relationship and the node element TextCollection in a 1:C cardinality relationship. The package ProductDesignVersionComponent includes the entities AttachmentFolder and TextCollection. AttachmentFolder includes the UUID non-node element, which may have a multiplicity of 0 . . . 1 and may be based on datatype BGDT:UUID. AttachmentFolder includes the node element Document in a 1:CN cardinality relationship.

Document includes the following non-node elements: UUID, VersionID, SystemAdministrativeData, LinkInternalIndicator, CheckedOutIndicator, VisibleIndicator, VersioningEnabledIndicator, CategoryCode, CategoryName, TypeCode, TypeName, MIMECode, MIMEName, PathName, Name, AlternativeName, InternalLinkUUID, Description, ExternalLinkWebURI, FileContentURI, and FilesizeMeasure. UUID may have a multiplicity of 0 . . . 1 and may be based on datatype BGDT:UUID. VersionID may have a multiplicity of 0 . . . 1 and may be based on datatype BGDT:VersionID. SystemAdministrativeData may have a multiplicity of 0 . . . 1 and may be based on datatype AGDT:SystemAdministrativeData. LinkInternalIndicator may have a multiplicity of 0 . . . 1 and may be based on datatype CDT:Indicator. CheckedOutIndicator may have a multiplicity of 0 . . . 1 and may be based on datatype CDT:Indicator. VisibleIndicator may have a multiplicity of 0 . . . 1 and may be based on datatype CDT:Indicator. VersioningEnabledIndicator may have a multiplicity of 0 . . . 1 and may be based on datatype CDT:Indicator. CategoryCode may have a multiplicity of 0 . . . 1 and may be based on datatype BGDT:DocumentCategoryCode. CategoryName may have a multiplicity of 0 . . . 1 and may be based on datatype CDT:LANGUAGEINDEPENDENT_LONG_Name. TypeCode may have a multiplicity of 0 . . . 1 and may be based on datatype BGDT:DocumentTypeCode. TypeName may have a multiplicity of 0 . . . 1 and may be based on datatype CDT:LANGUAGEINDEPENDENT_LONG_Name. MIMECode may have a multiplicity of 0 . . . 1 and may be based on datatype BGDT:MIMECode. MIMEName may have a multiplicity of 0.1 and may be based on datatype CDT:LANGUAGEINDEPENDENT_LONG_Name. PathName may have a multiplicity of 0 . . . 1 and may be based on datatype CDT:LANGUAGEINDEPENDENT_Name. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. FileContentURI may have a multiplicity of 0 . . . 1 and may be based on datatype BGDT:URI. FilesizeMeasure may have a multiplicity of 0 . . . 1 and may be based on datatype CDT:Measure.

Document includes the node element Property in a 1:CN cardinality relationship. Property includes the following non-node elements: TechnicalID, Name, DataTypeFormatCode, DataTypeFormatName, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0.1 and may be based on datatype BGDT:PropertyDataTypeFormatCode. DataTypeFormatName may have a multiplicity of 0 . . . 1 and may be based on datatype CDT:LANGUAGEINDEPENDENT_LONG_Name. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description.

Property includes the node element PropertyValue in a 1:CN cardinality relationship. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

TextCollection includes the following non-node elements: UUID and Text. Text includes TechnicalID, TypeCode, TypeName, LanguageCode, LanguageName, SystemAdministrativeData, CreationDateTime, and TextContent. TextContent includes TechnicalID and Text. UUID may have a multiplicity of 0 . . . 1 and may be based on datatype BGDT:UUID. Text may have a multiplicity of 0 . . . * and may be based on datatype MIDT:AccessTextCollectionText. TechnicalID may have a multiplicity of 0 . . . 1 and may be based on datatype BGDT:ObjectNodeTechnicalID. TypeCode may have a multiplicity of 0 . . . 1 and may be based on datatype BGDT:TextCollectionTextTypeCode. TypeName may have a multiplicity of 0 . . . 1 and may be based on datatype CDT:LANGUAGEINDEPENDENT_LONG_Name. LanguageCode may have a multiplicity of 0 . . . 1 and may be based on datatype BGDT:LanguageCode. LanguageName may have a multiplicity of 0 . . . 1 and may be based on datatype CDT:LANGUAGEINDEPENDENT_LONG_Name. SystemAdministrativeData may have a multiplicity of 0 . . . 1 and may be based on datatype AGDT: SystemAdministrativeData. CreationDateTime may have a multiplicity of 0 . . . 1 and may be based on datatype CDT:GLOBAL_DateTime. TextContent may have a multiplicity of 0 . . . 1 and may be based on datatype MIDT:AccessTextCollectionTextTextContent. TechnicalID may have a multiplicity of 0.1 and may be based on datatype BGDT:ObjectNodeTechnicalID. Text may have a multiplicity of 0 . . . 1 and may be based on datatype CDT:Text.

The package ProductDesignVersionProductAssignment includes the entity ProductAssignment. ProductAssignment includes the following non-node elements: UUID, ProductUUID, ProductKey, ProductTypeCode, ProductTypeName, ProductidentifierTypeCode, ProductidentifierTypeName, ProductID, and DefaultIndicator. UUID may have a multiplicity of 0 . . . 1 and may be based on datatype BGDT:UUID. ProductUUID may have a multiplicity of 0 . . . 1 and may be based on datatype BGDT:UUID. ProductKey may have a multiplicity of 0 . . . 1 and may be based on datatype MIDT:ProductDesignVersionHierarchyByElementsResponseProductAssignmentProductKey. ProductTypeCode may have a multiplicity of 0 . . . 1 and may be based on datatype BGDT:ProductTypeCode. ProductTypeName may have a multiplicity of 0 . . . 1 and may be based on datatype CDT:LANGUAGEINDEPENDENT_LONG_Name. ProductidentifierTypeCode may have a multiplicity of 0 . . . 1 and may be based on datatype BGDT:ProductidentifierTypeCode. ProductidentifierTypeName may have a multiplicity of 0 . . . 1 and may be based on datatype CDT:LANGUAGEINDEPENDENT_LONG_Name. ProductID may have a multiplicity of 0 . . . 1 and may be based on datatype BGDT:ProductID. DefaultIndicator may have a multiplicity of 0 . . . 1 and may be based on datatype CDT:Indicator.

ProductAssignment includes the node element ProductDescription in a 1:CN cardinality relationship. The package ProductDesignVersionProductAssignment includes the entity ProductDescription. ProductDescription includes the Description non-node element, which may have a multiplicity of 0 . . . 1 and may be based on datatype BGDT:SHORT_Description. The package Log includes the entity Log. Log is typed by datatype Log.

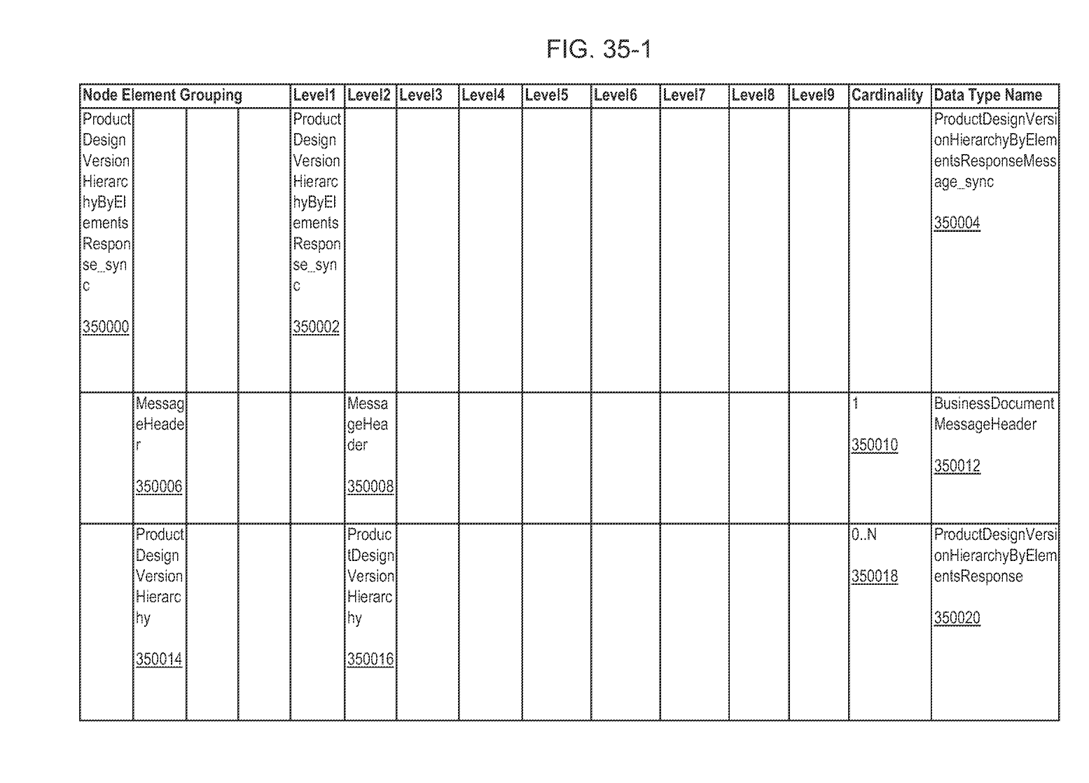

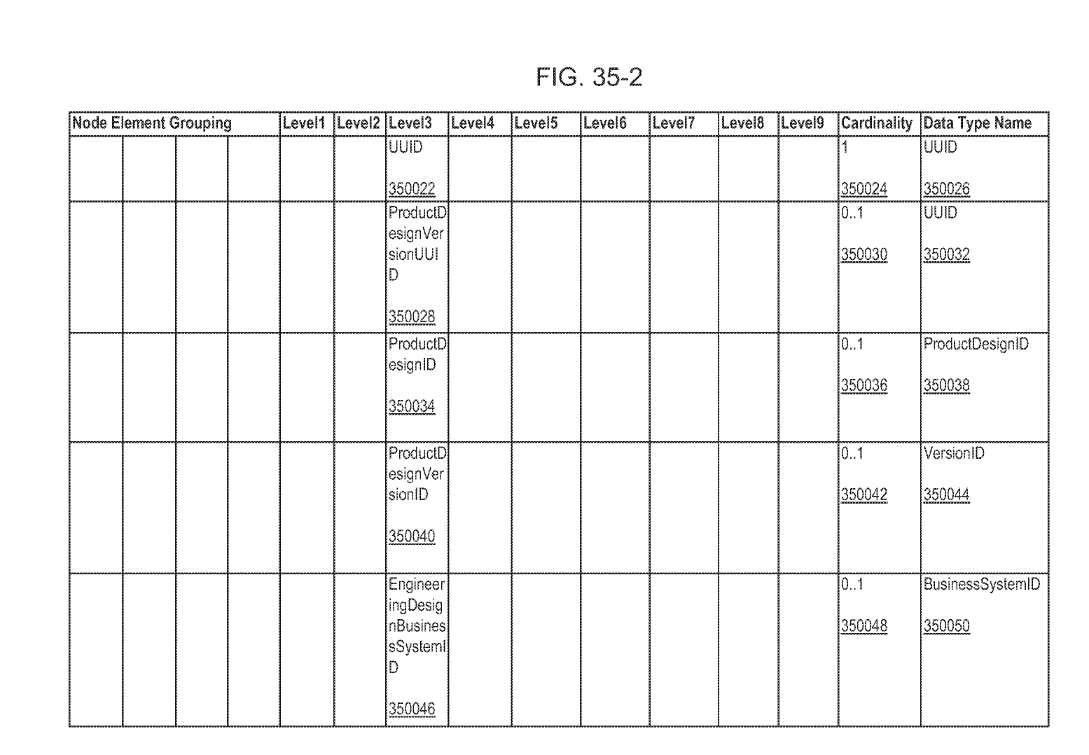

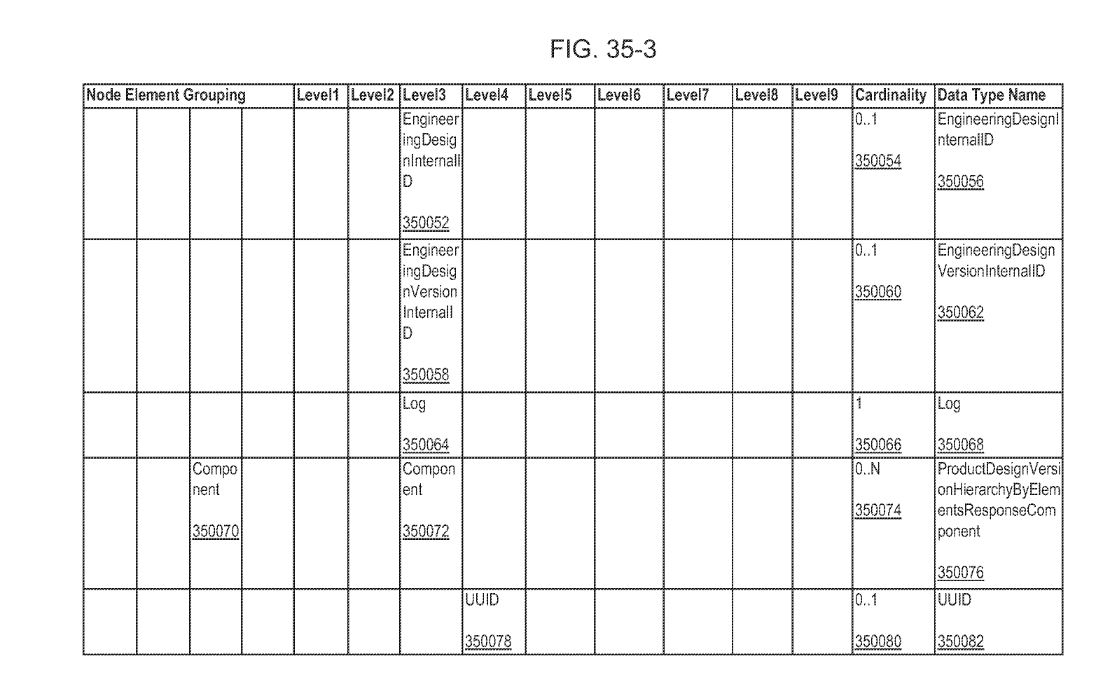

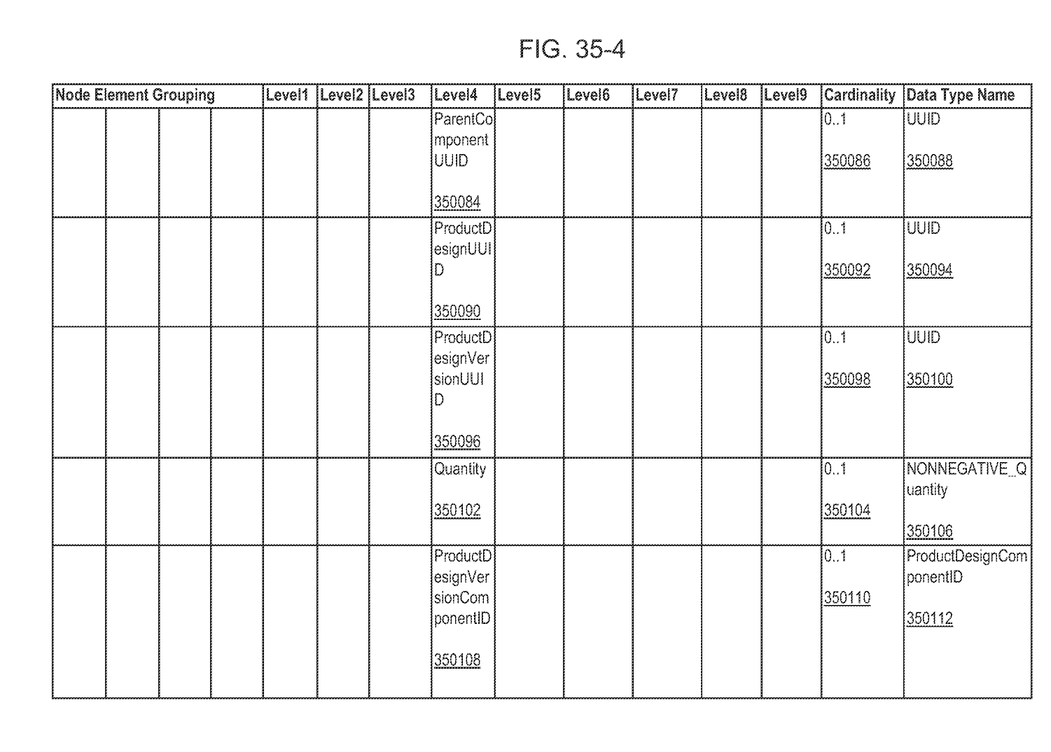

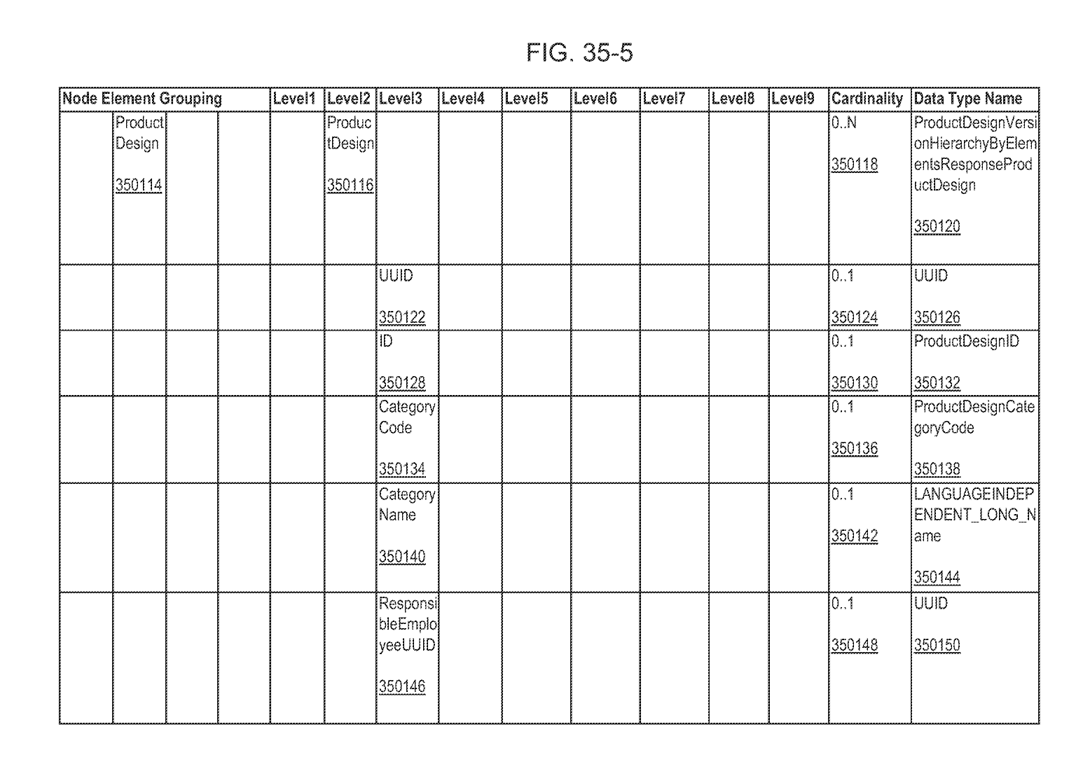

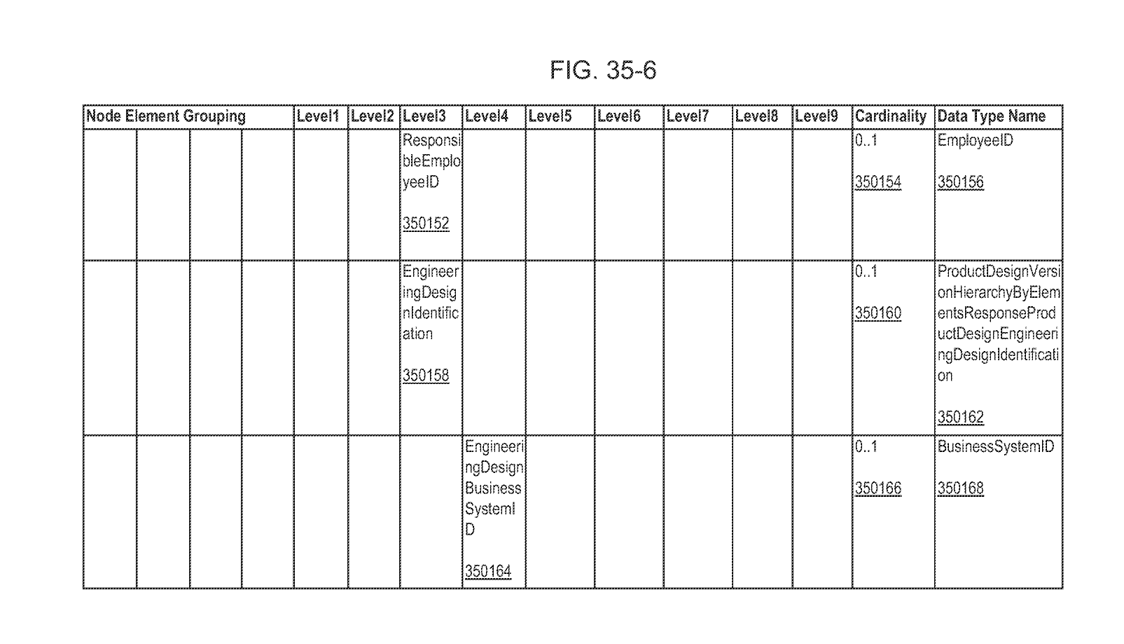

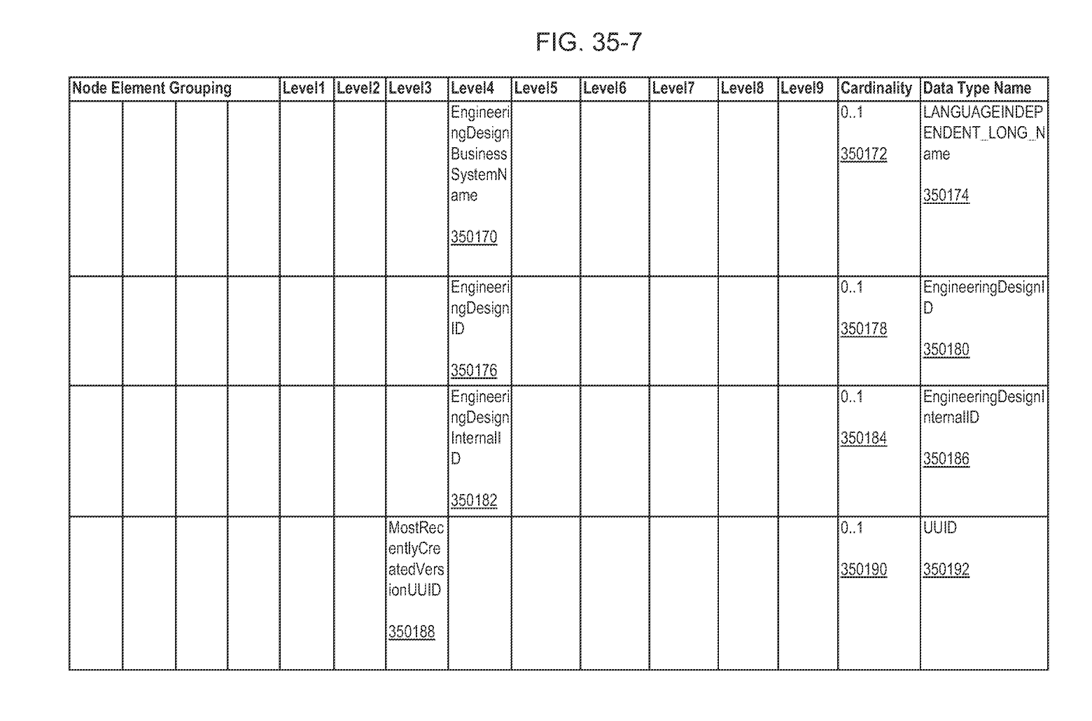

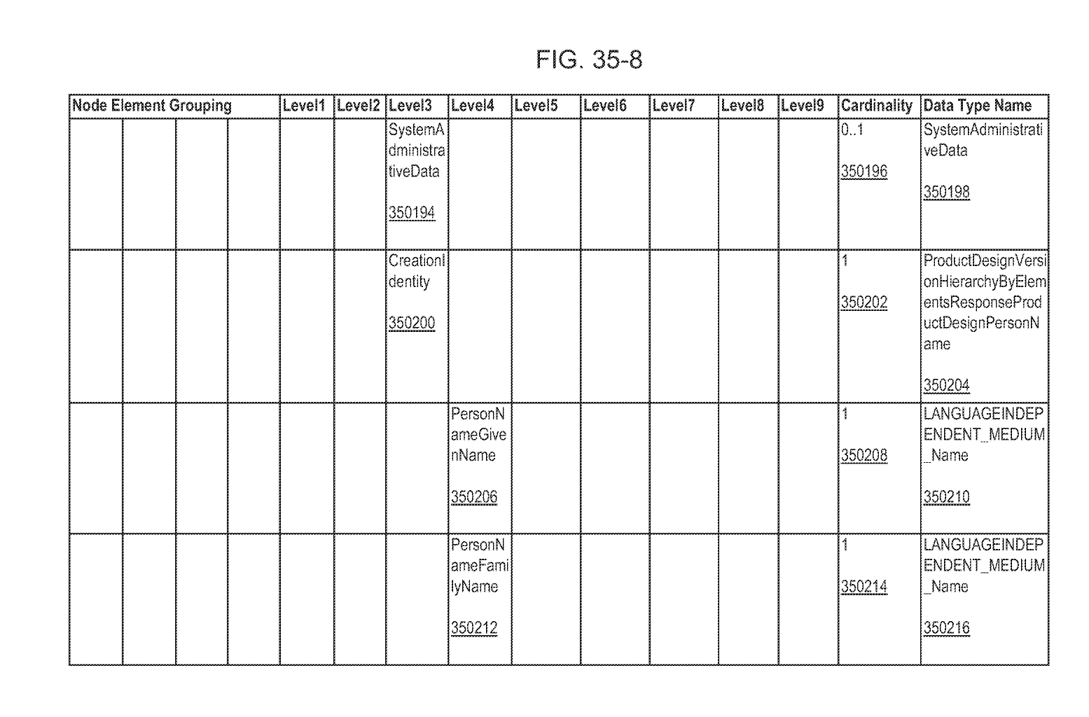

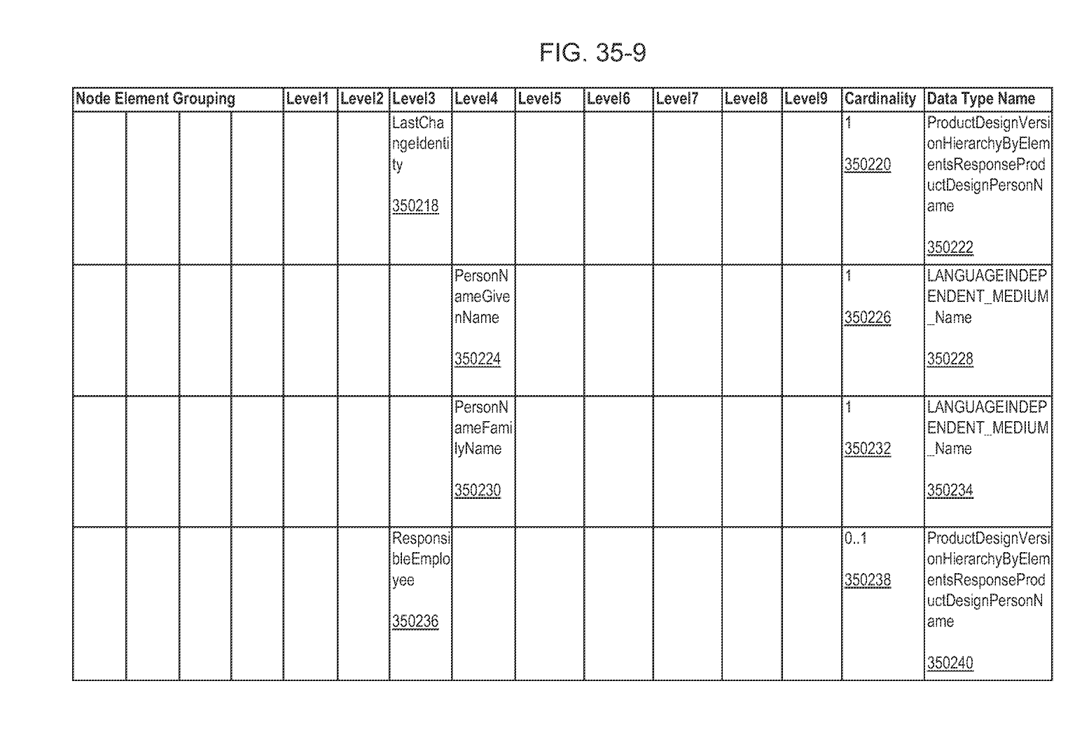

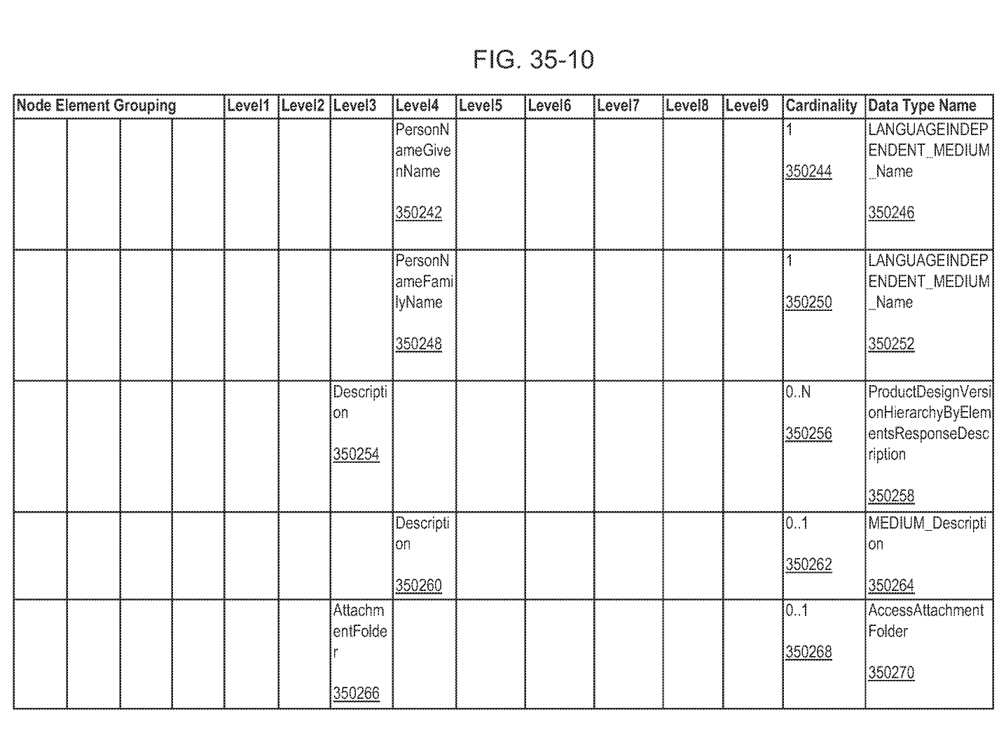

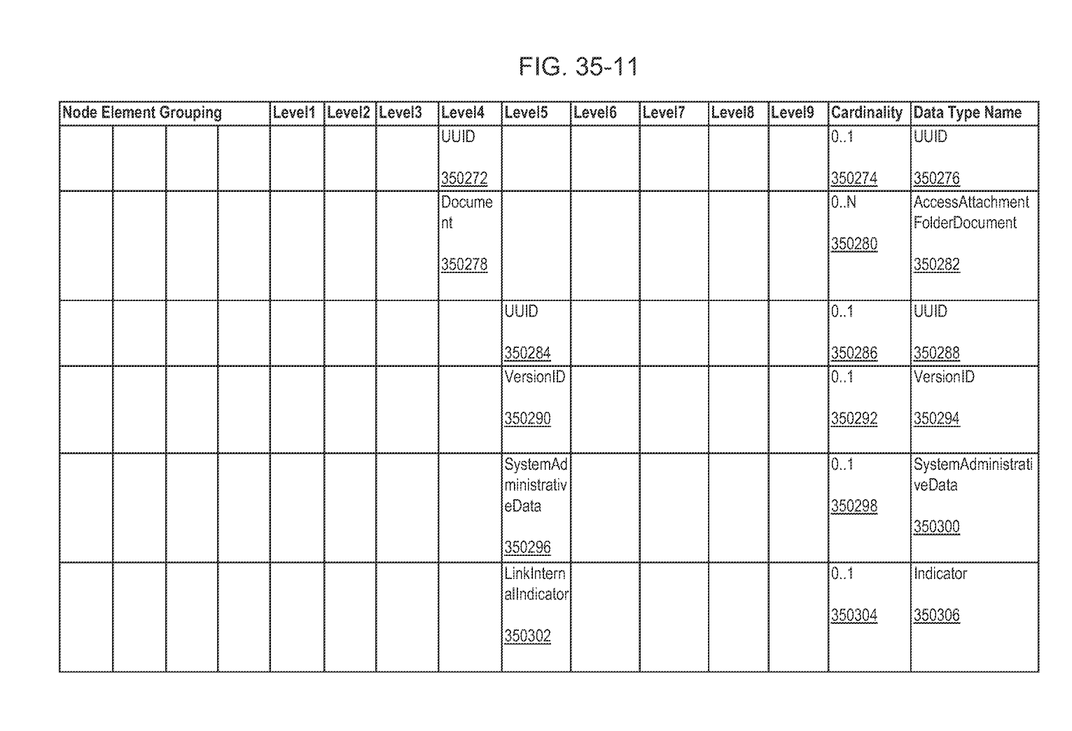

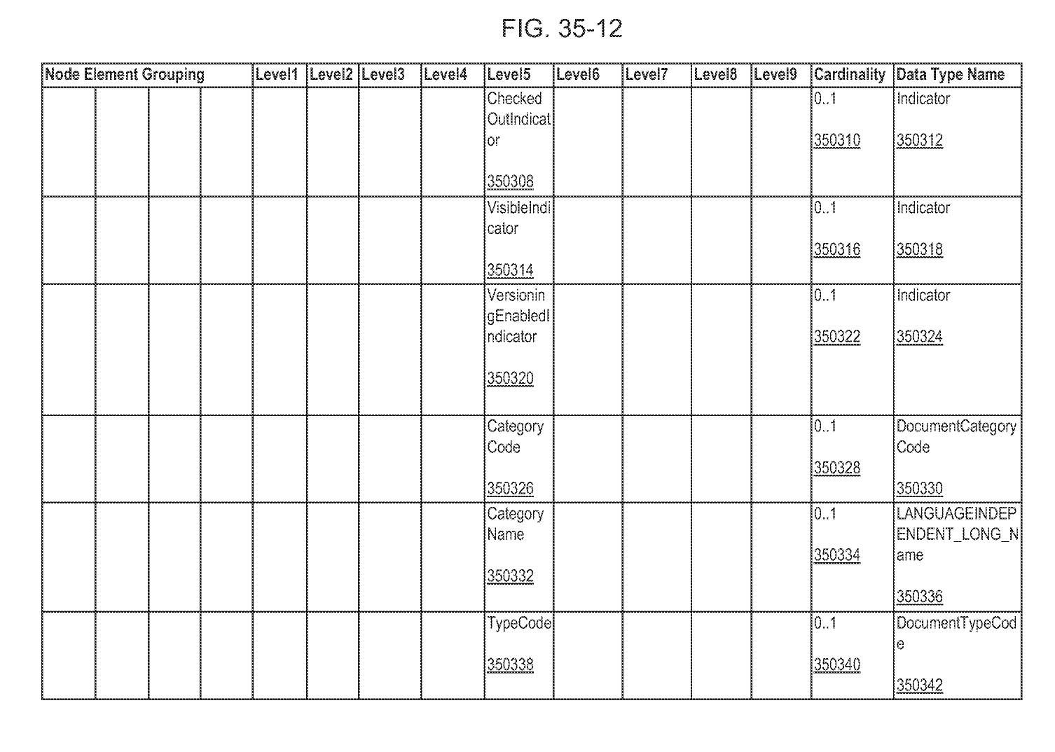

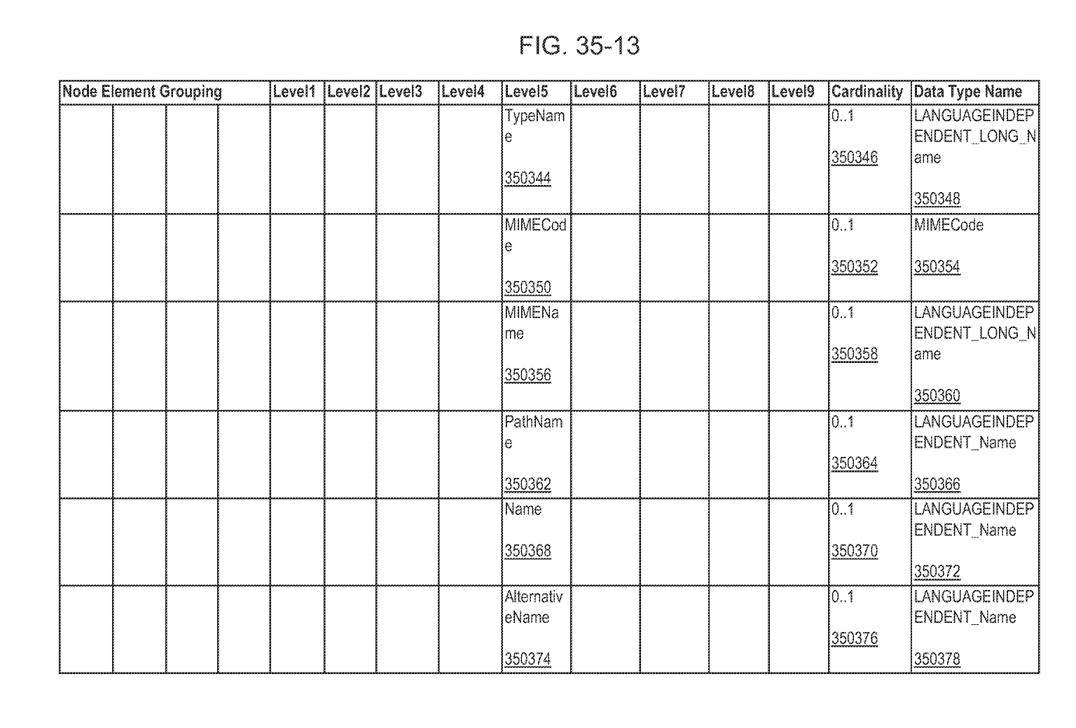

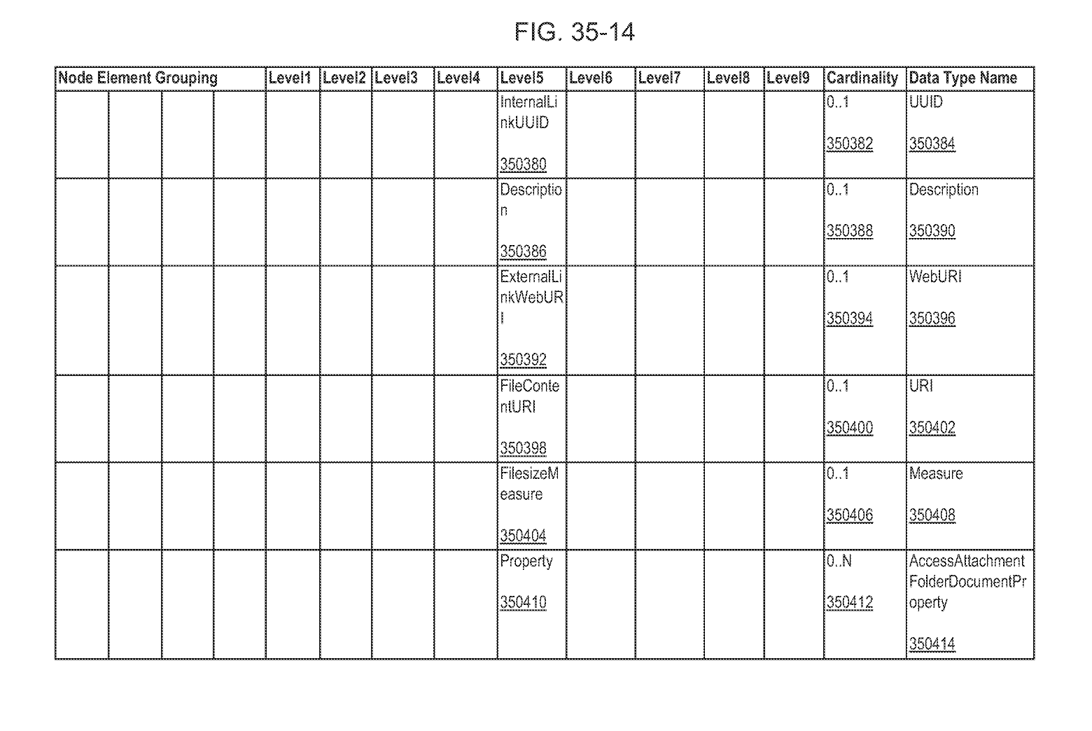

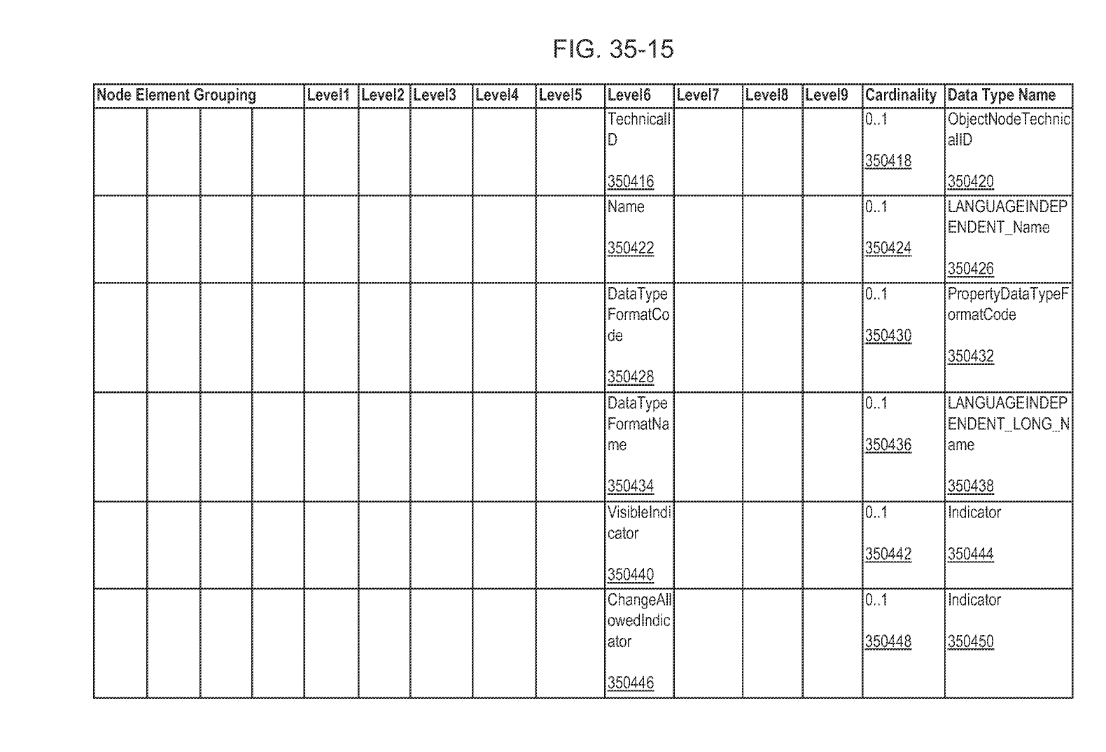

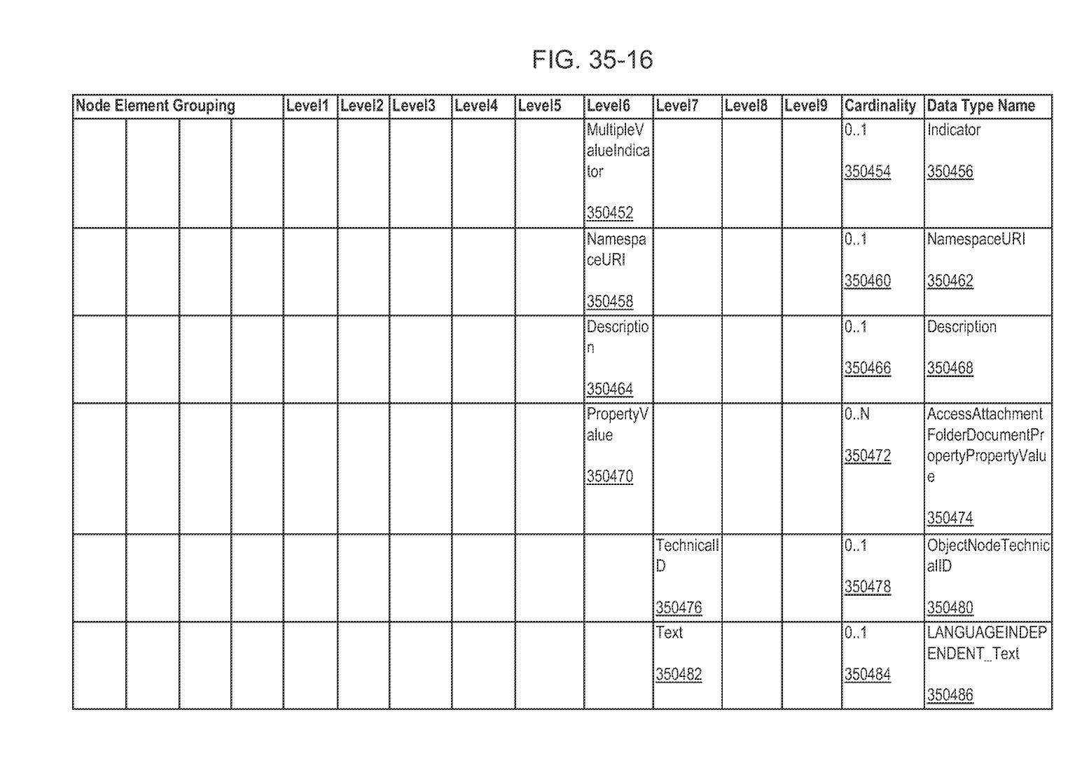

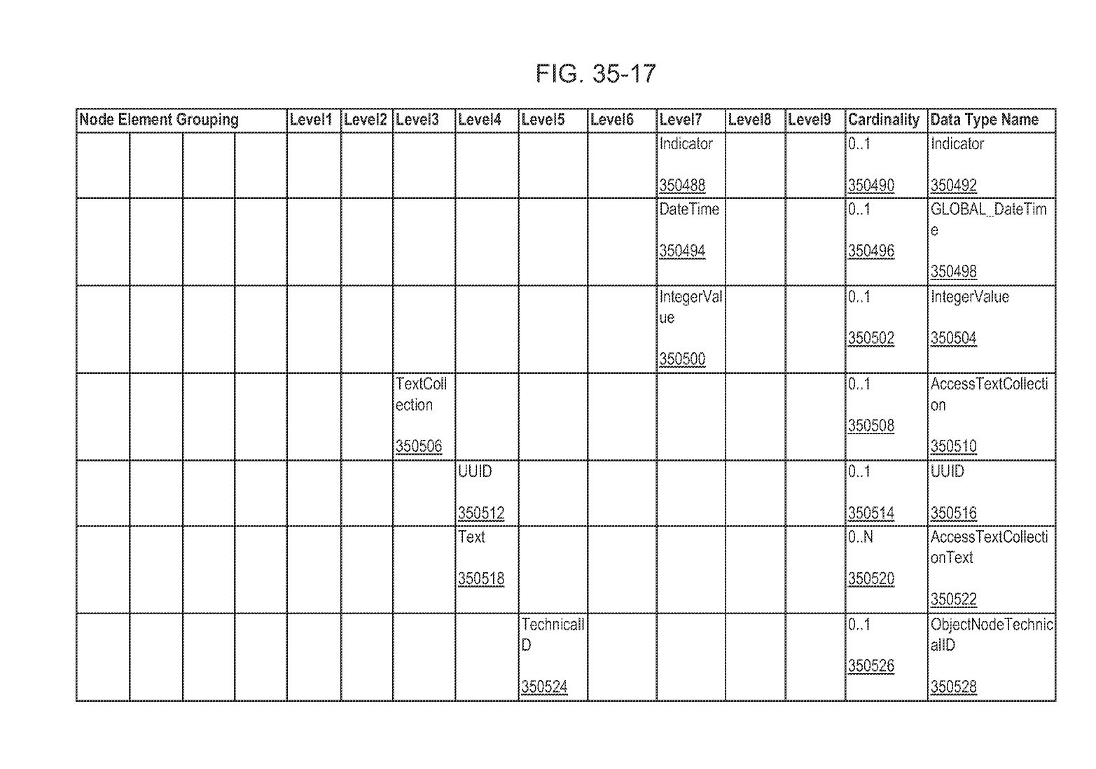

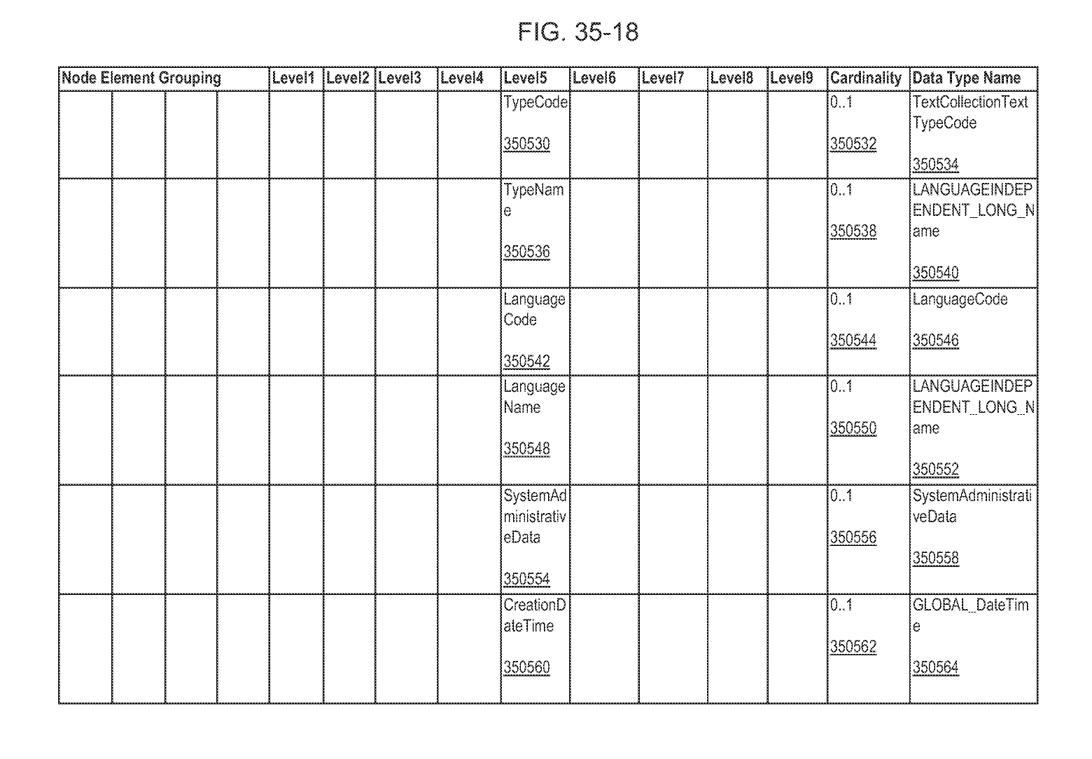

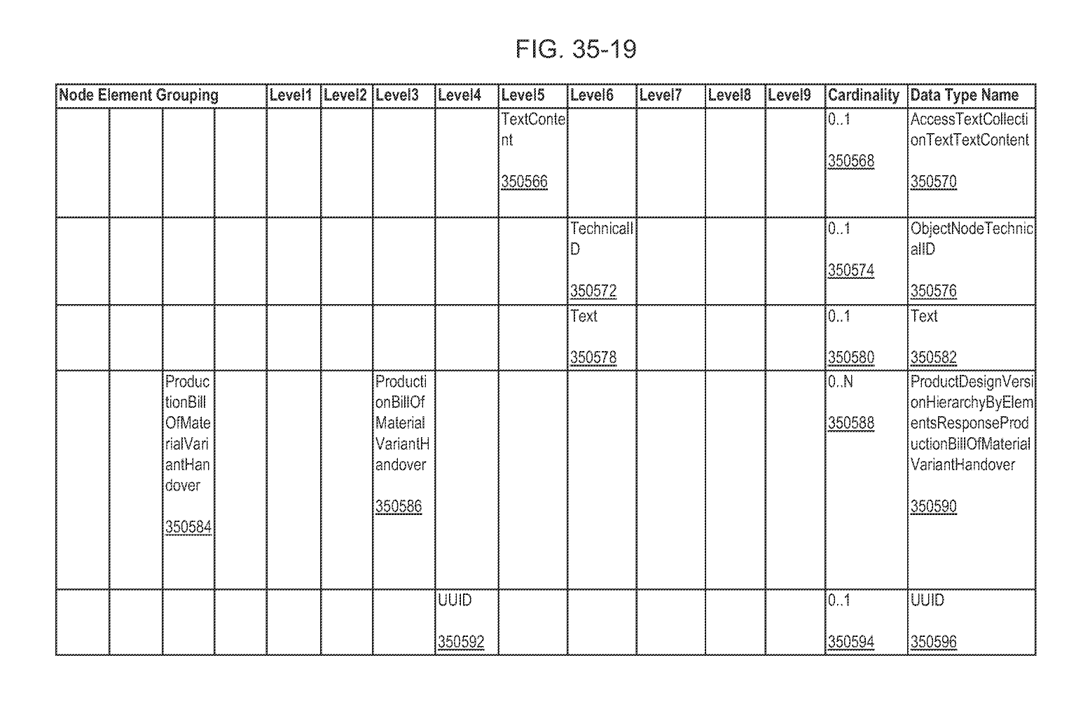

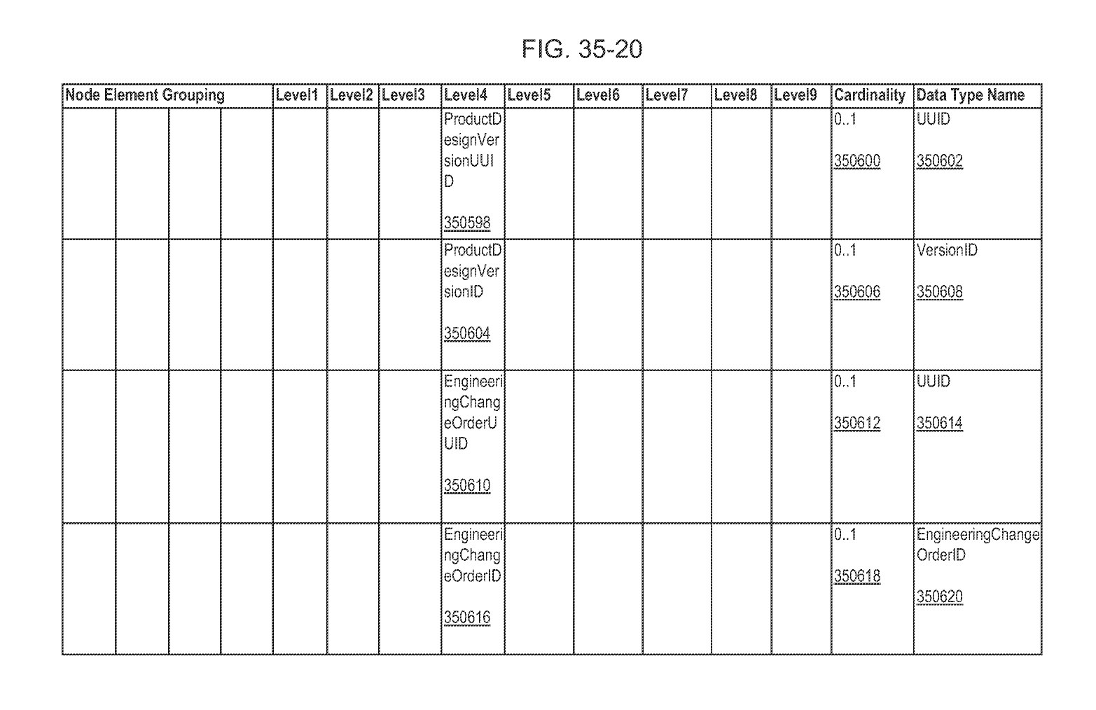

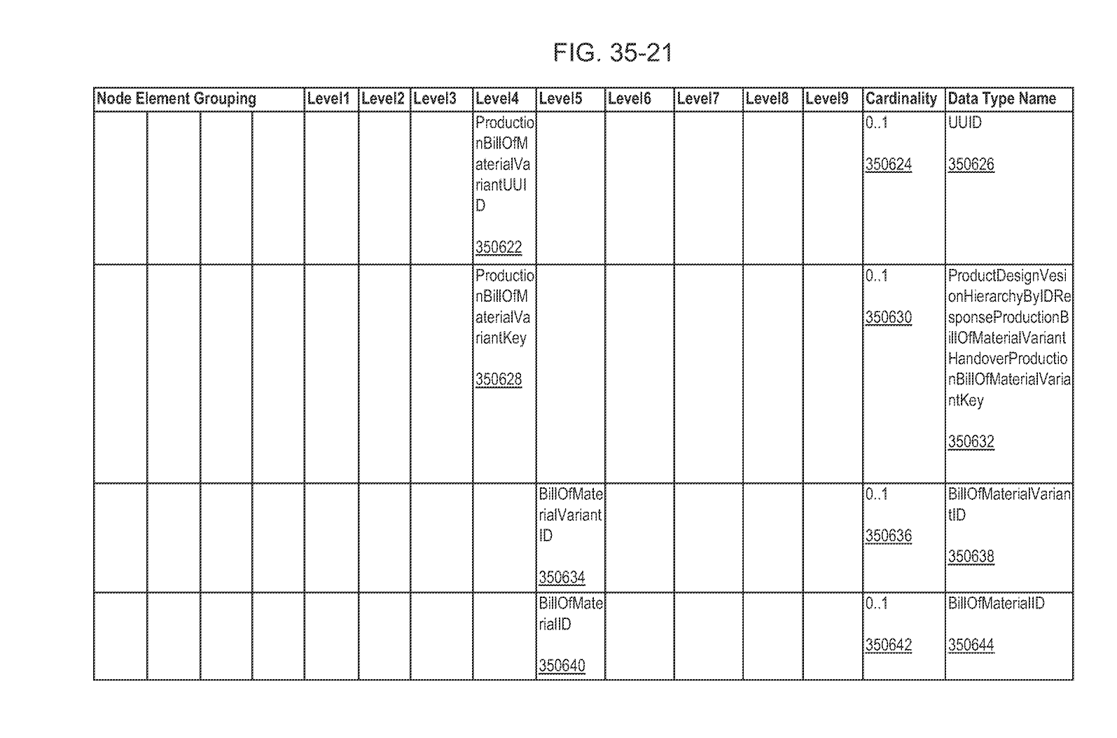

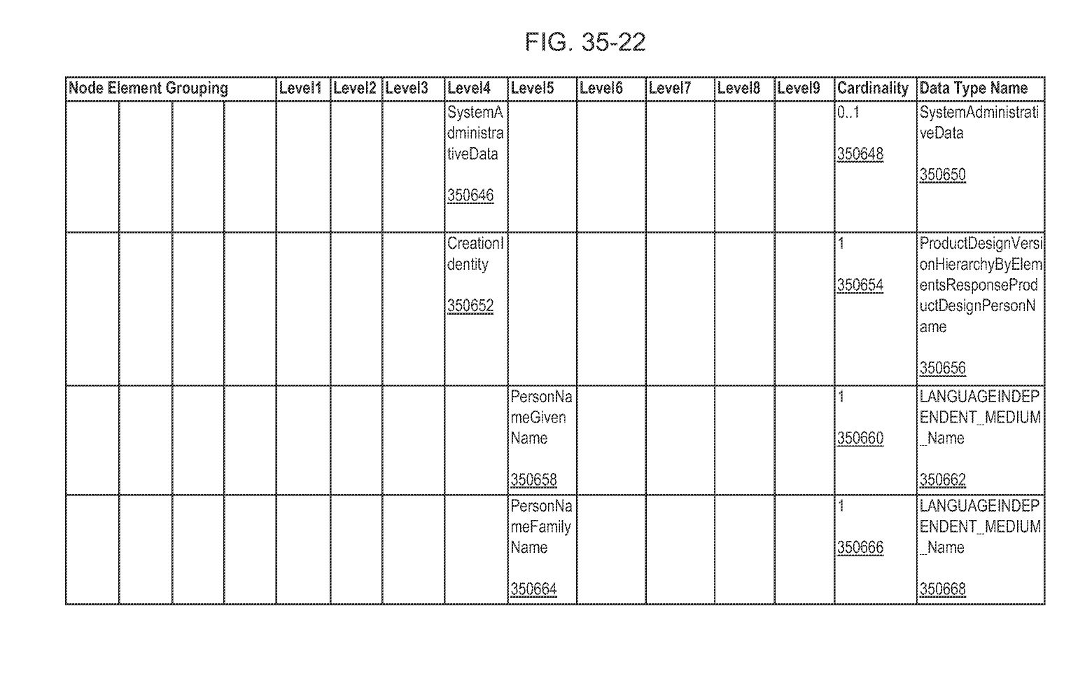

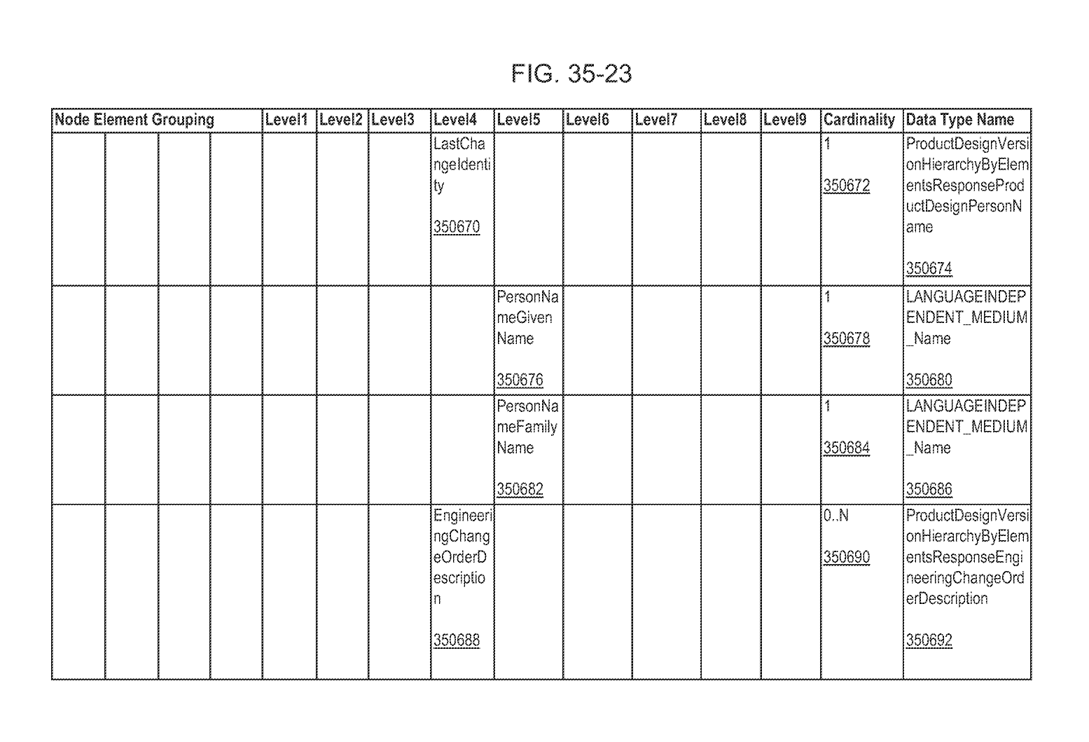

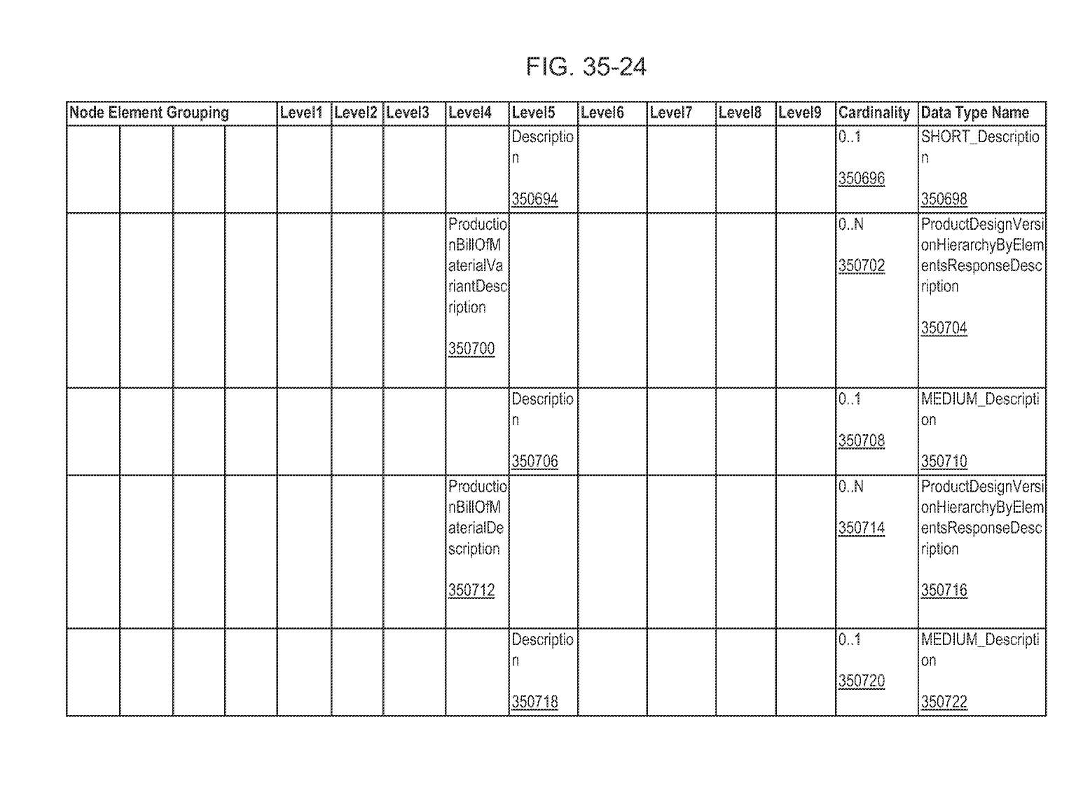

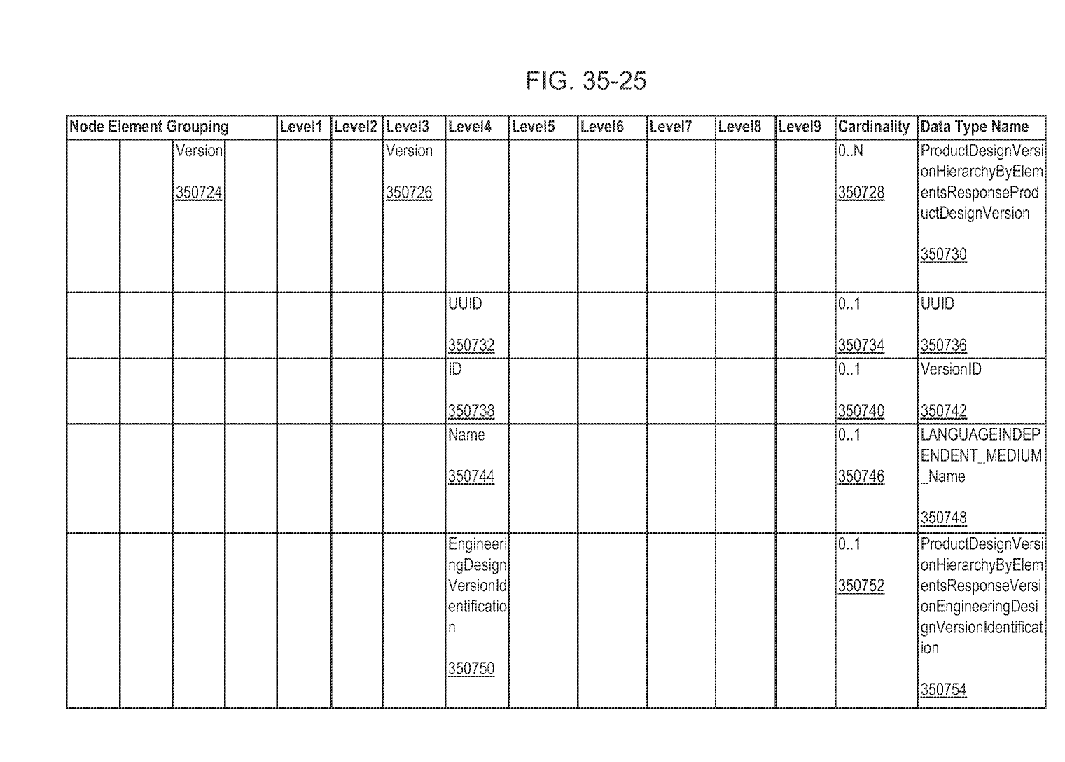

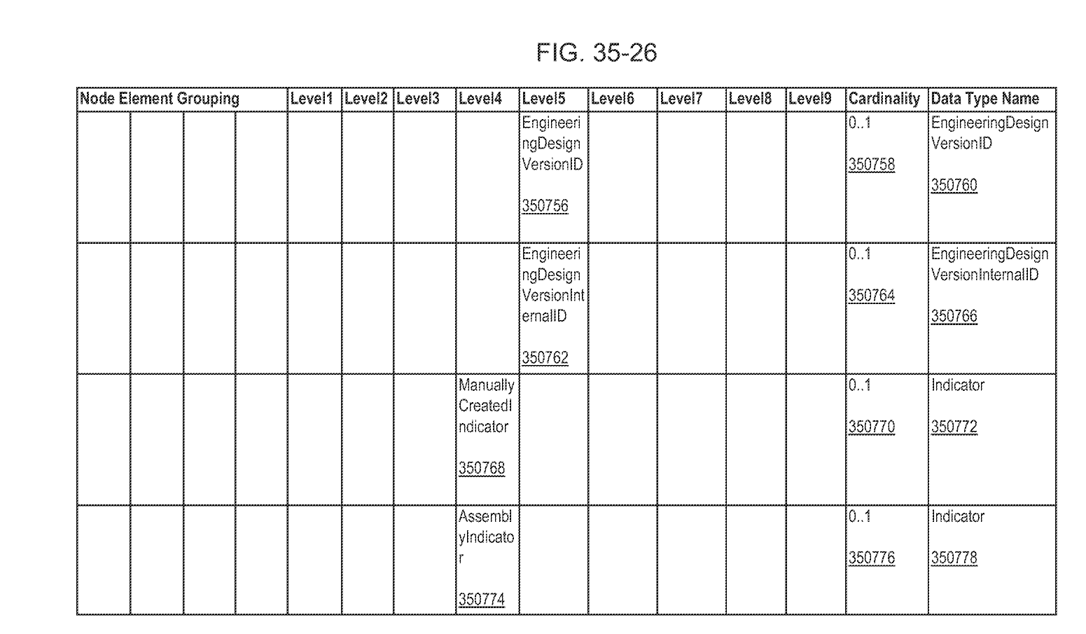

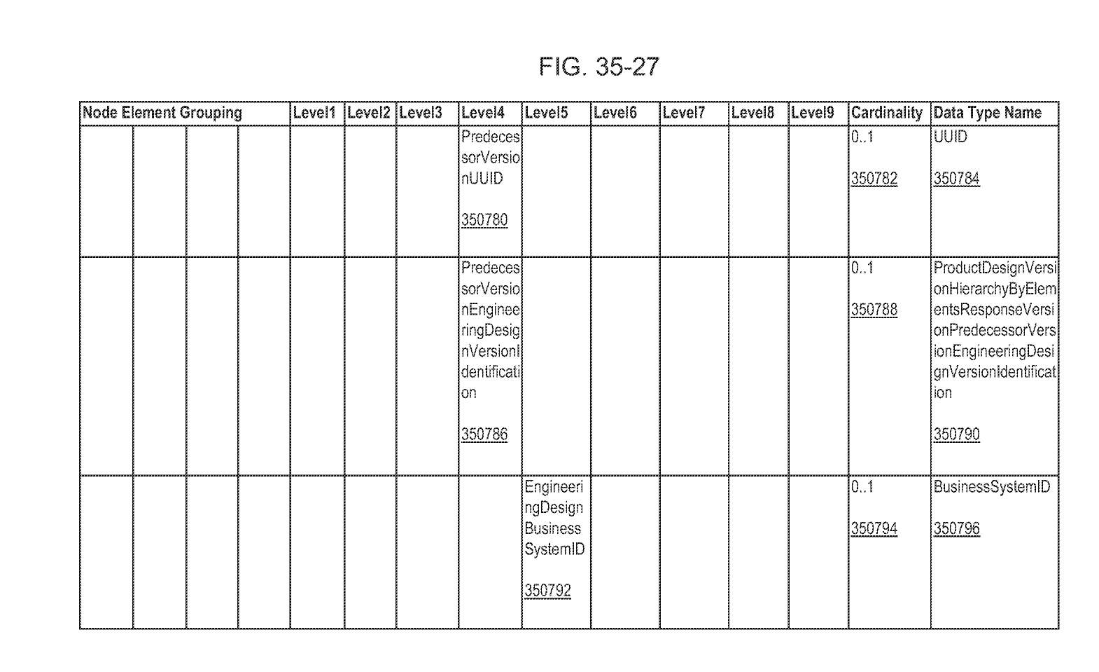

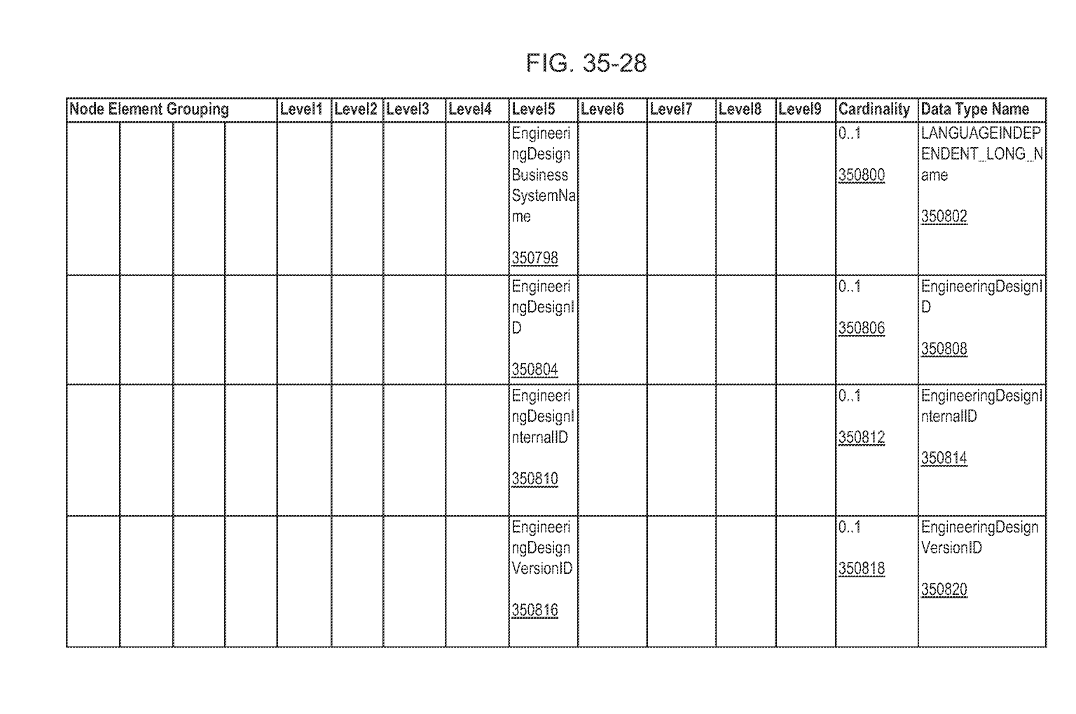

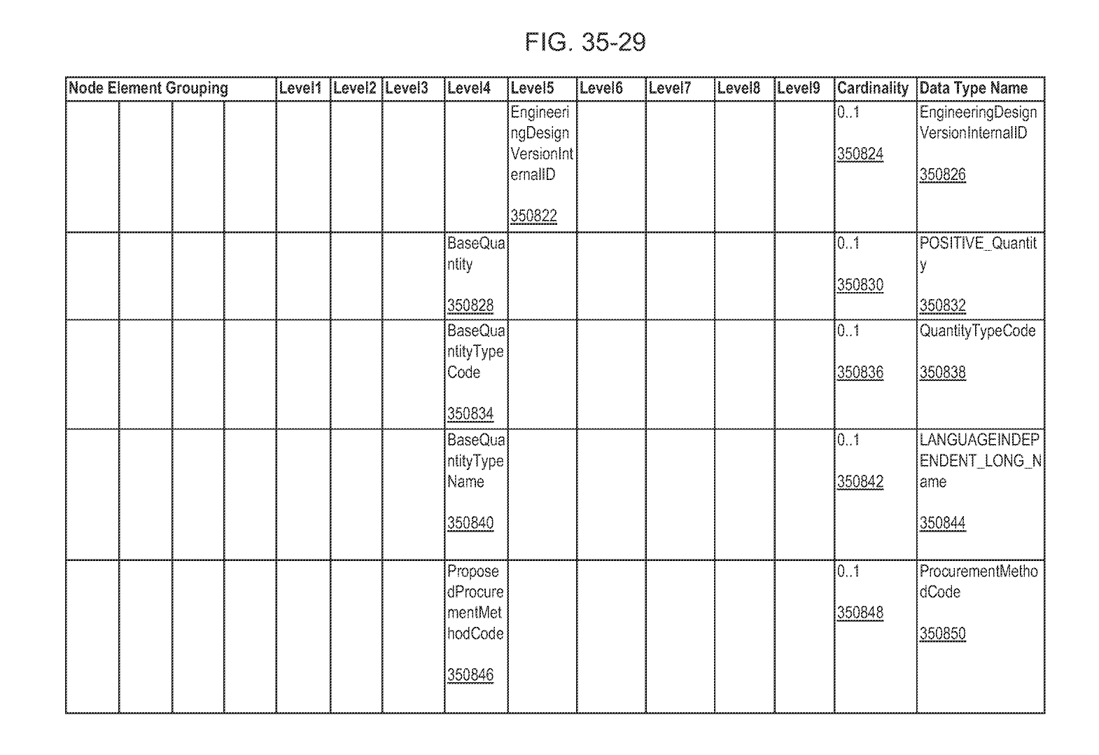

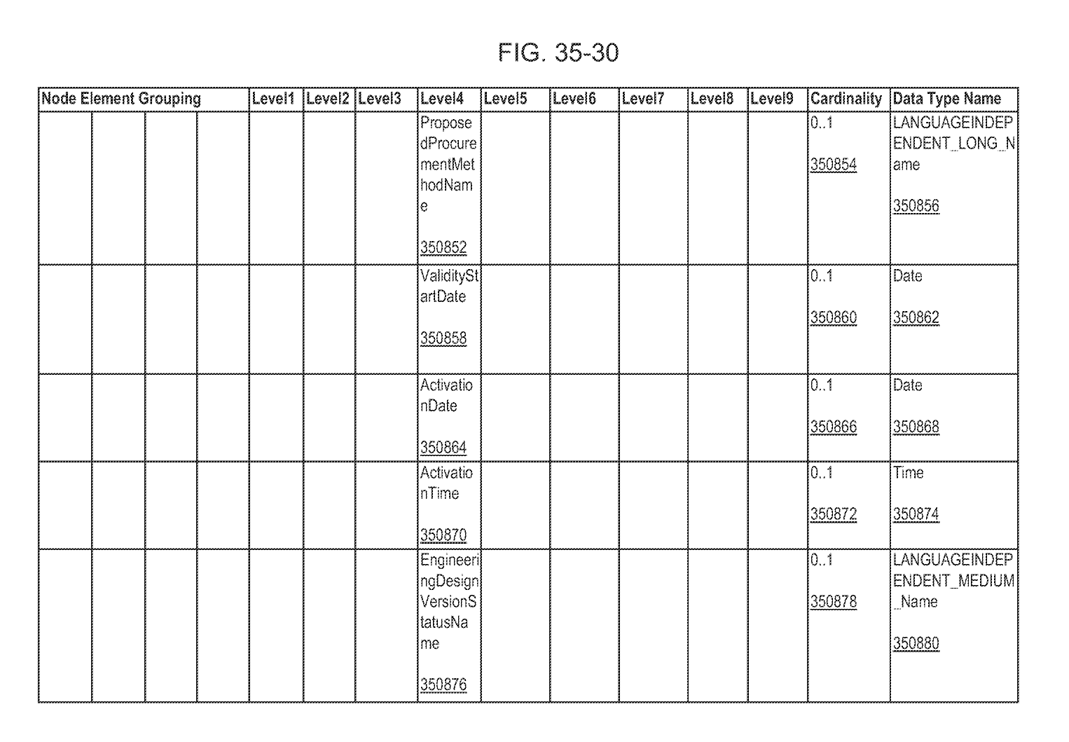

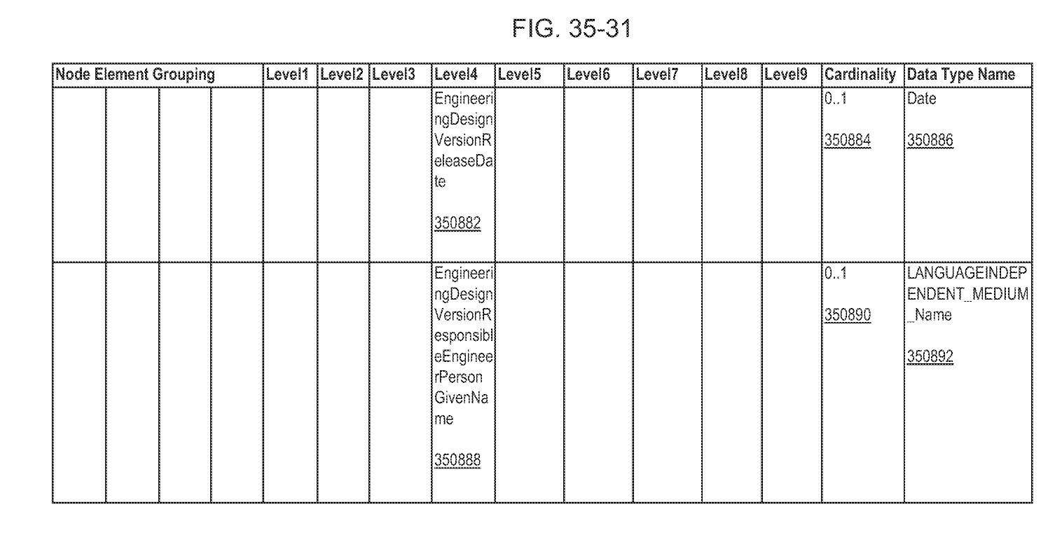

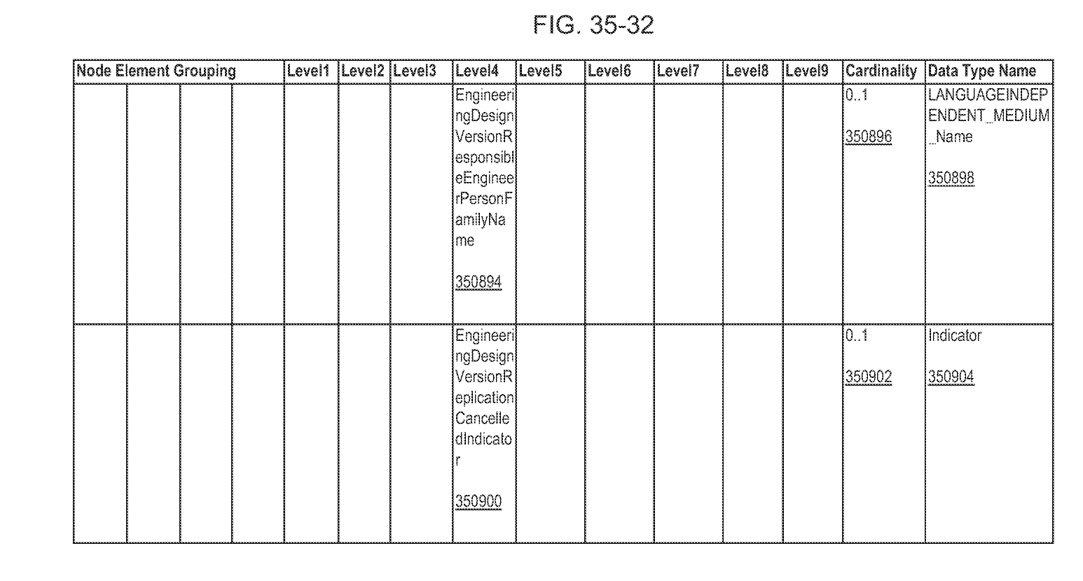

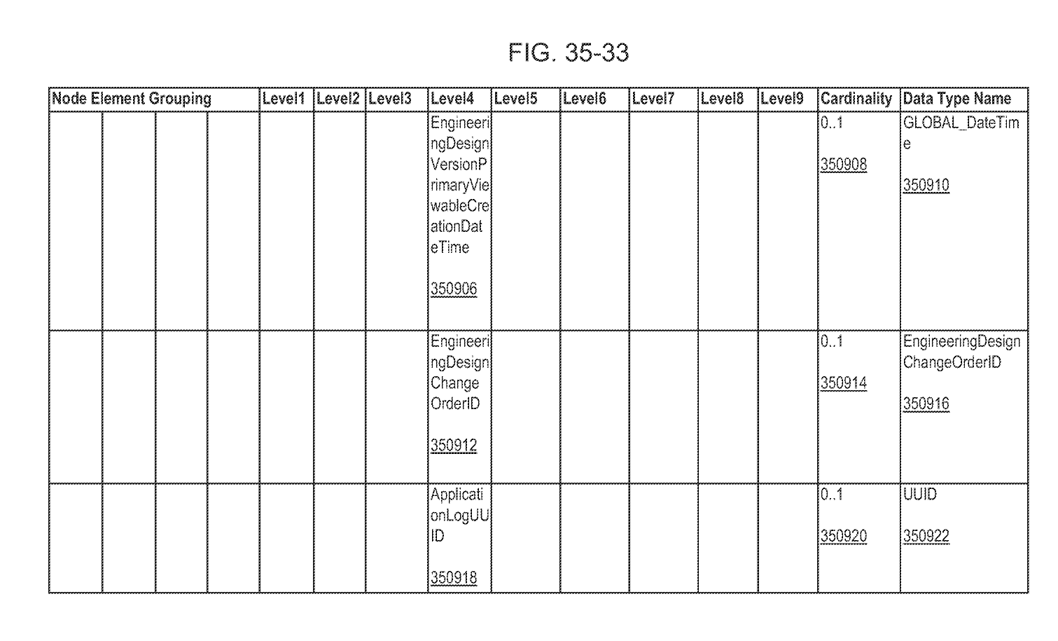

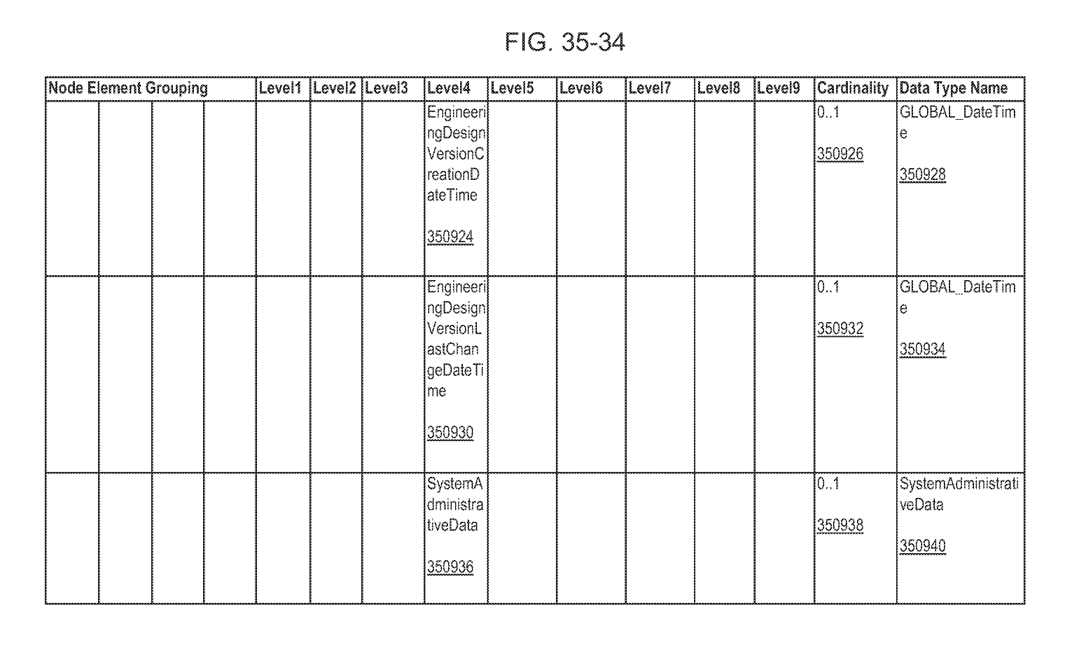

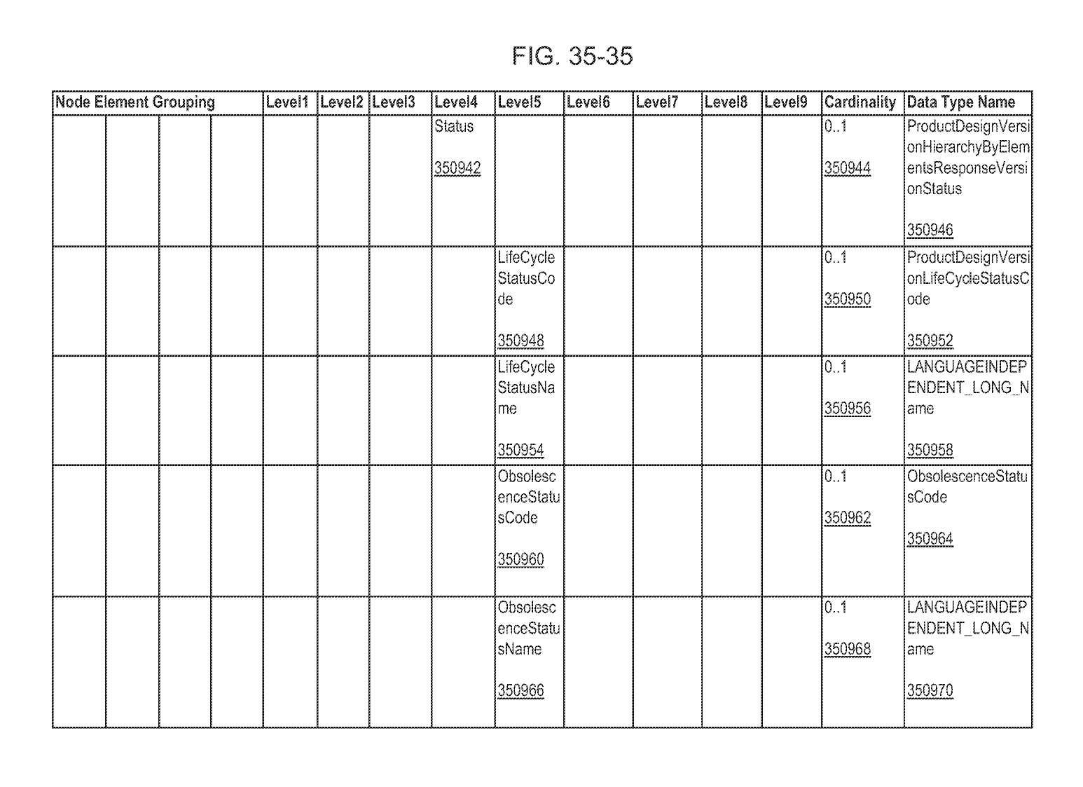

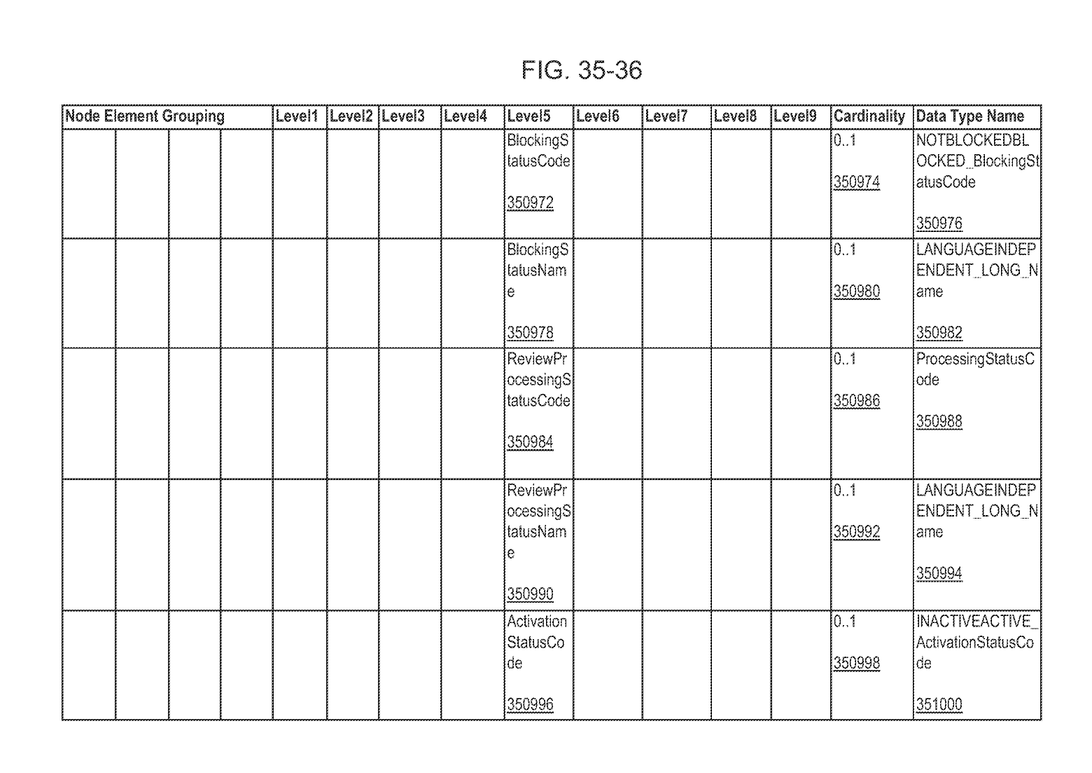

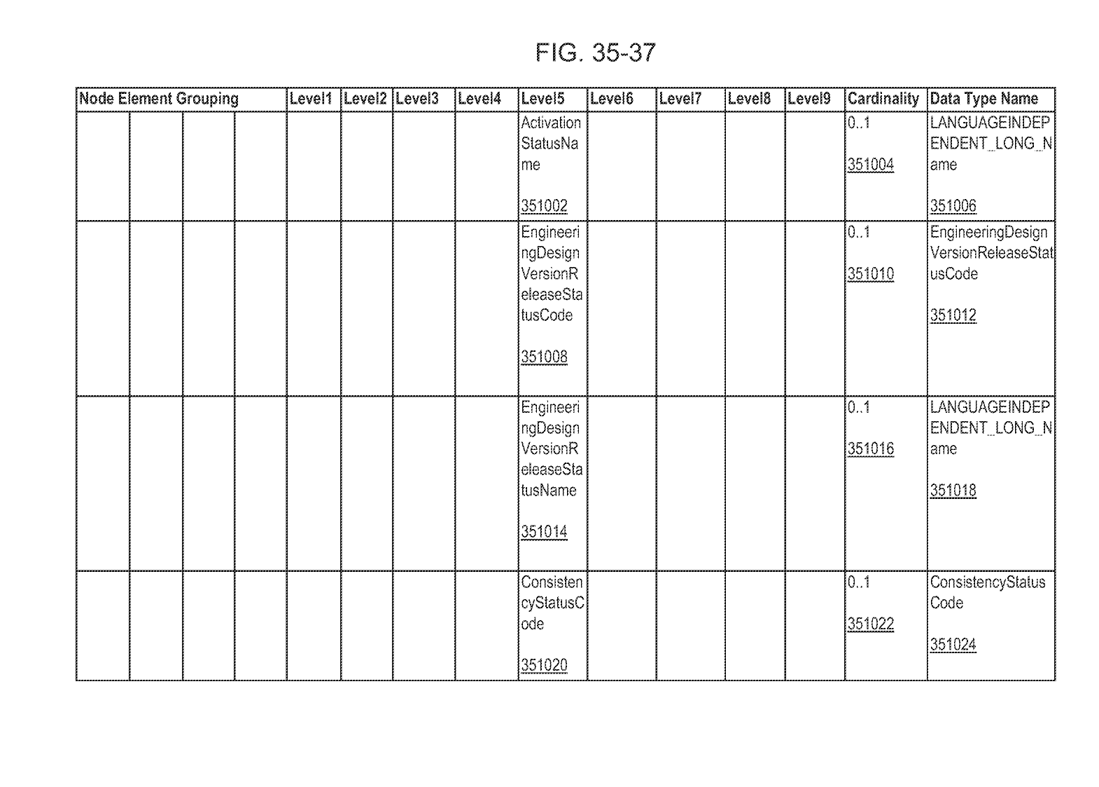

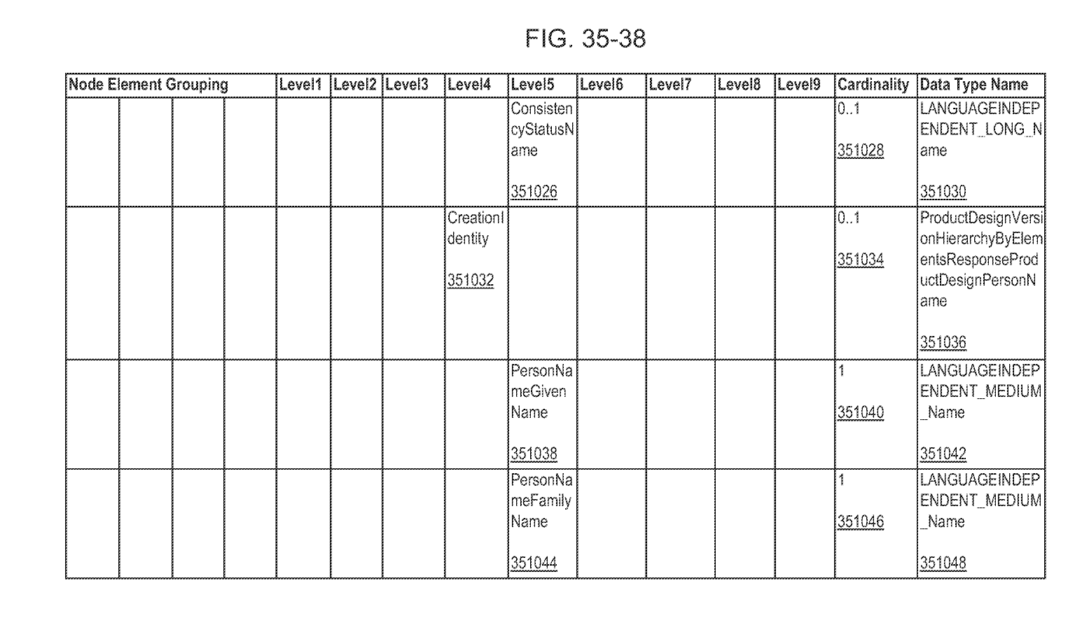

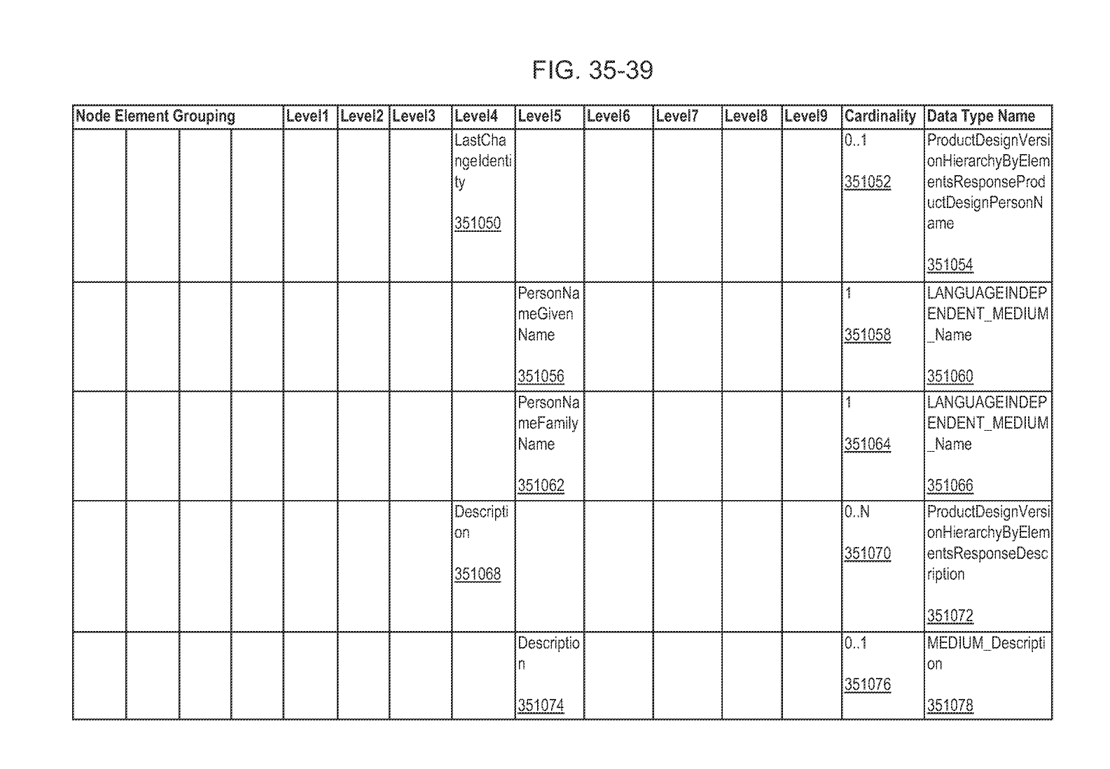

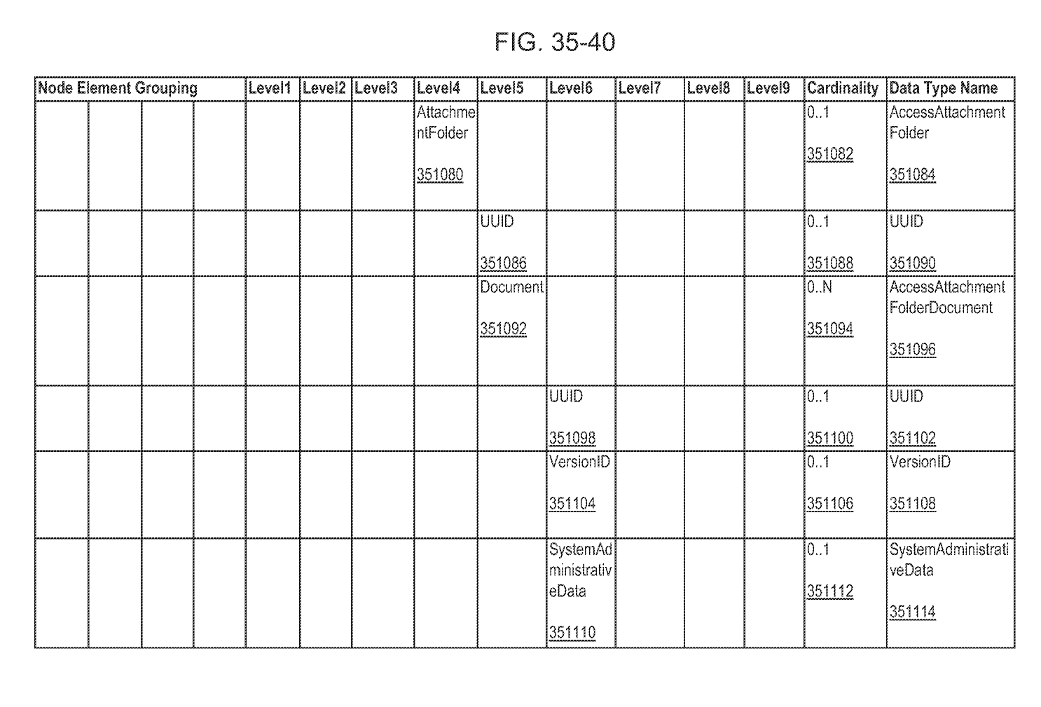

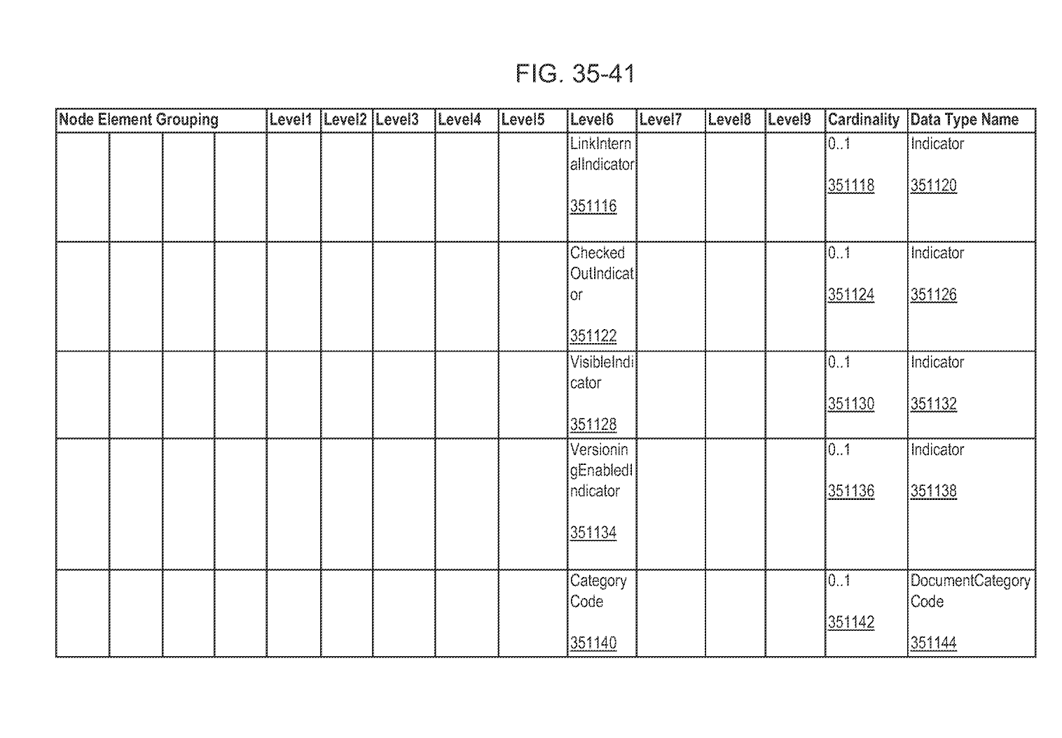

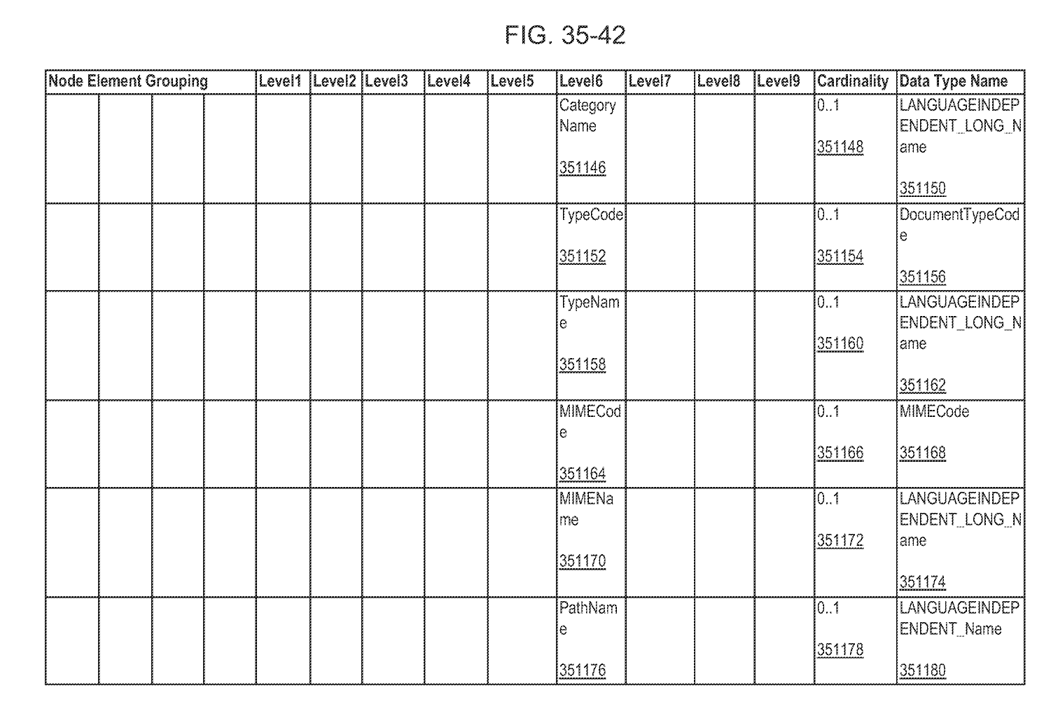

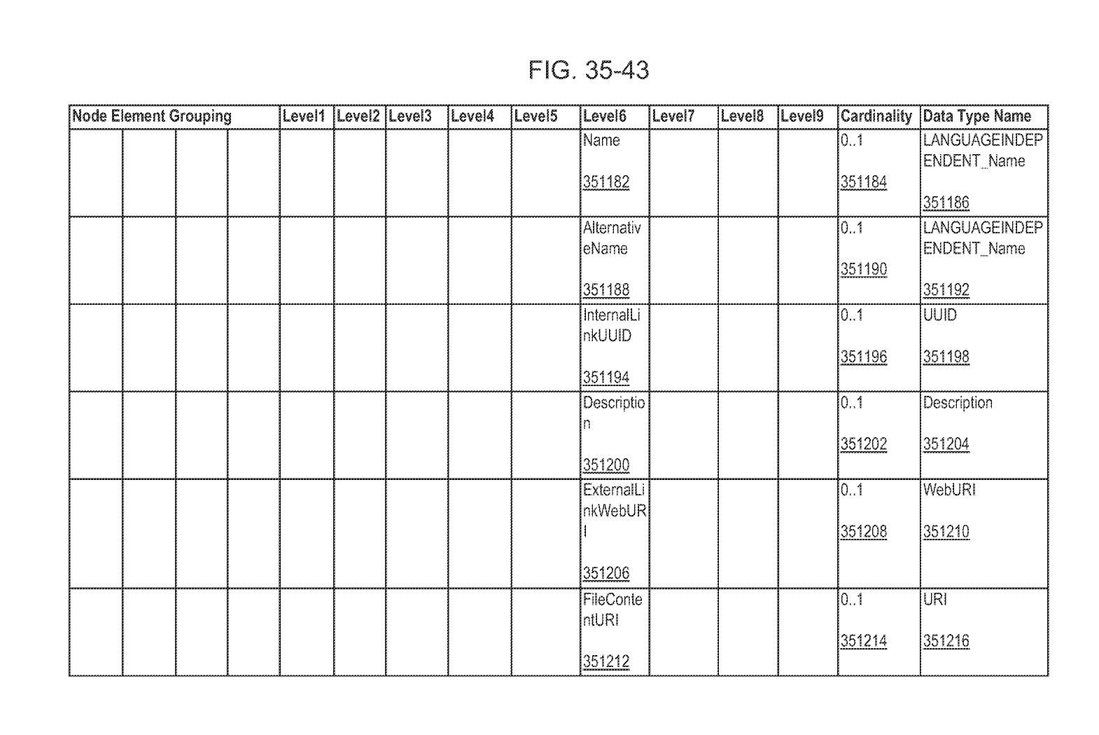

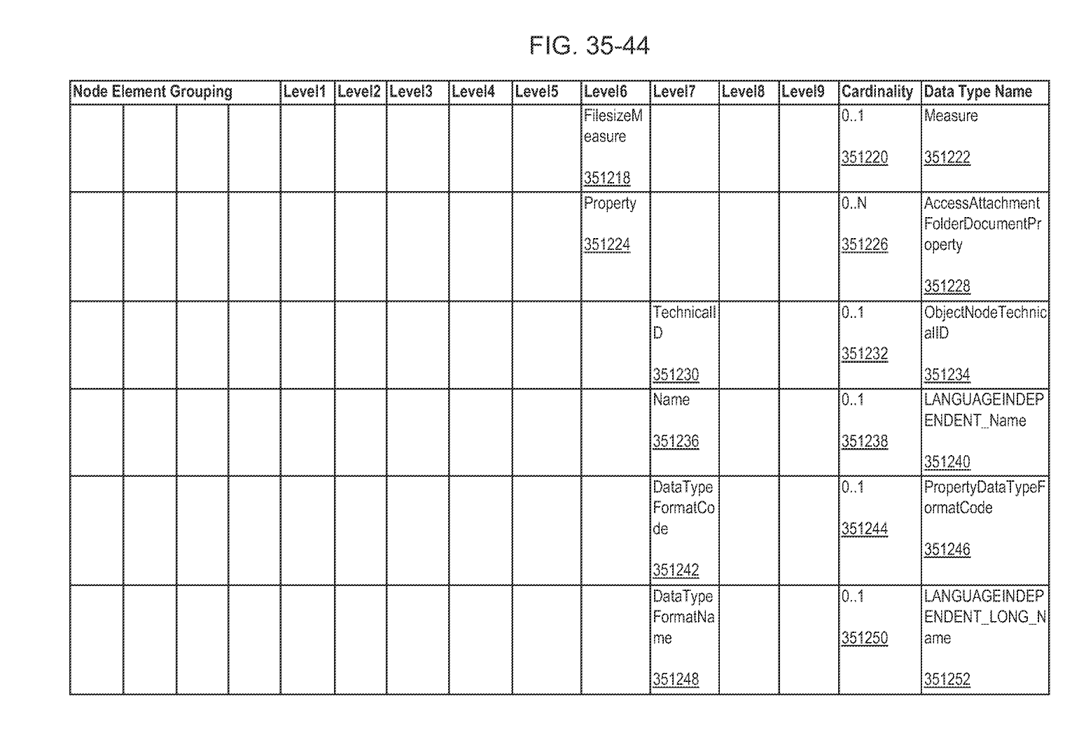

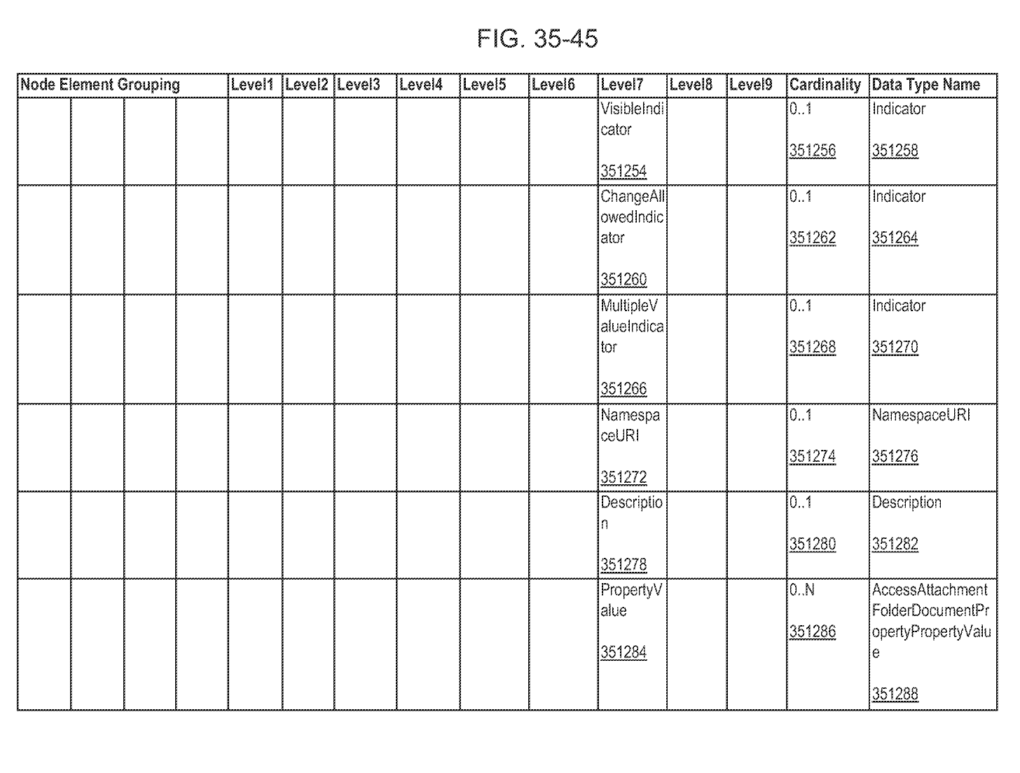

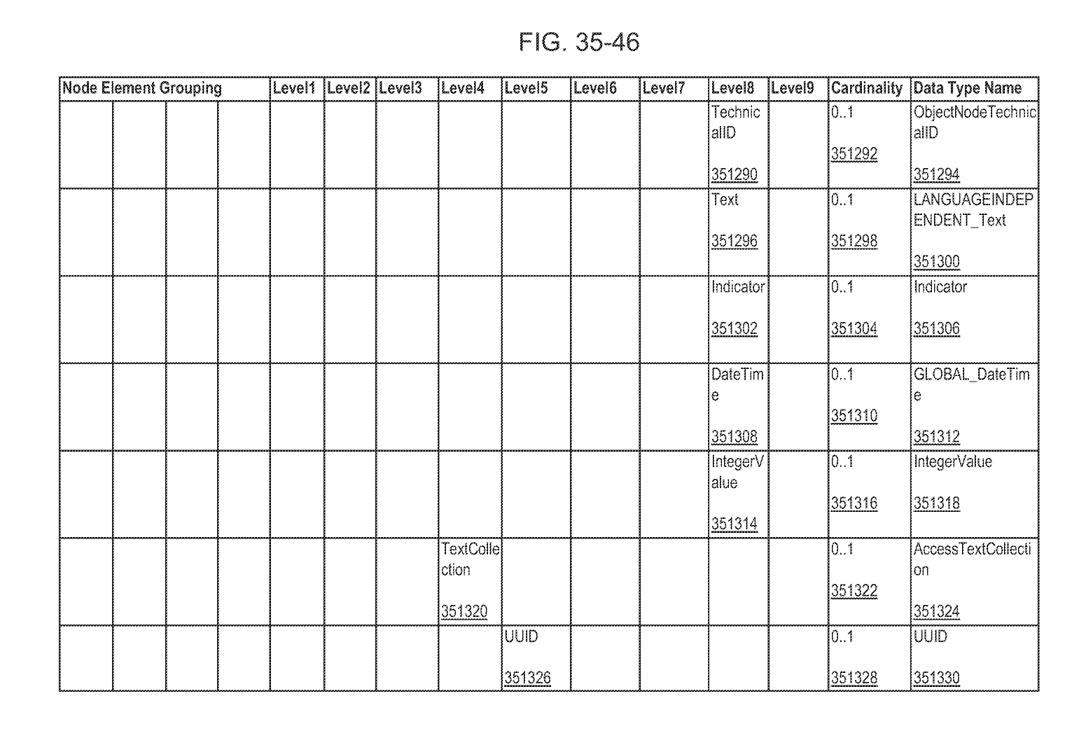

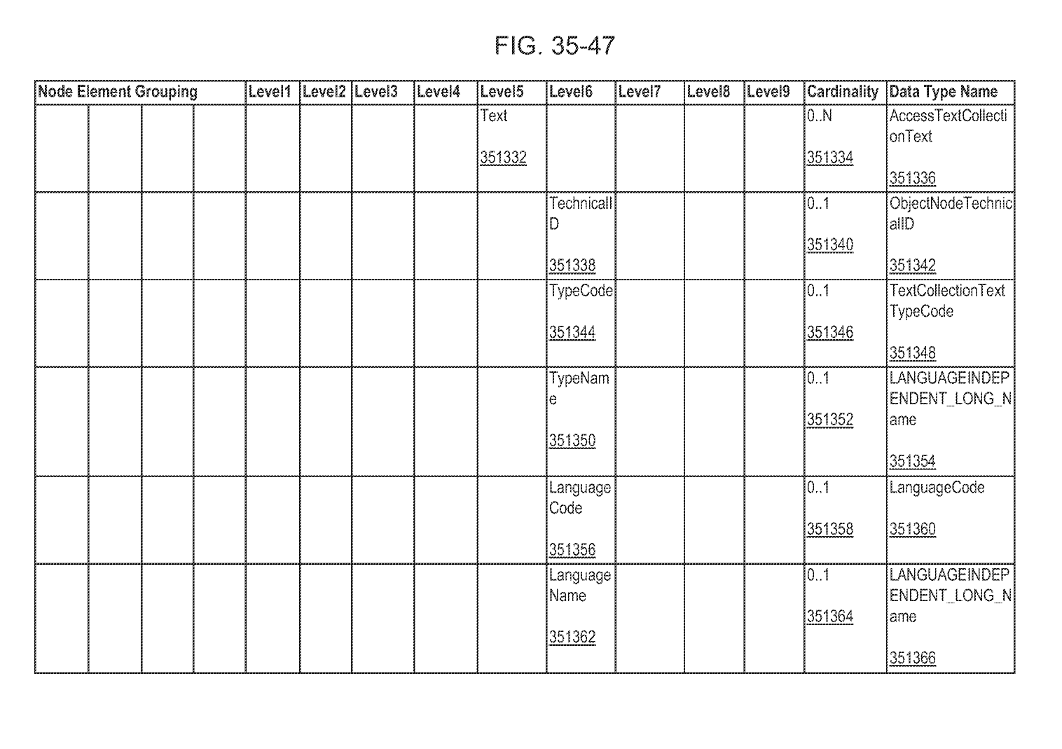

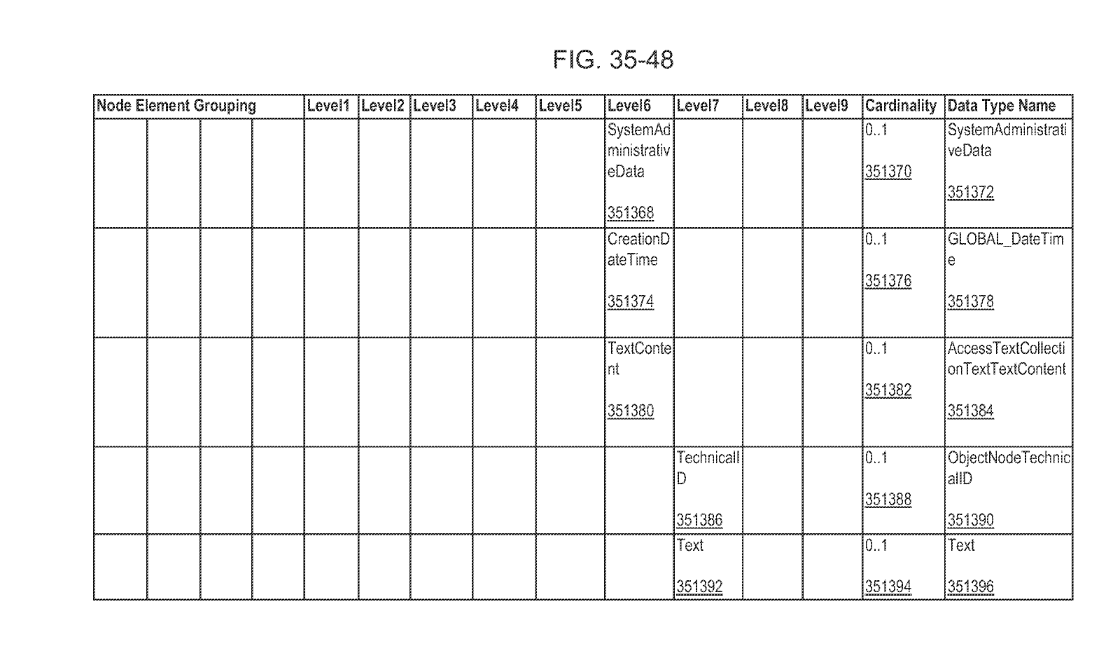

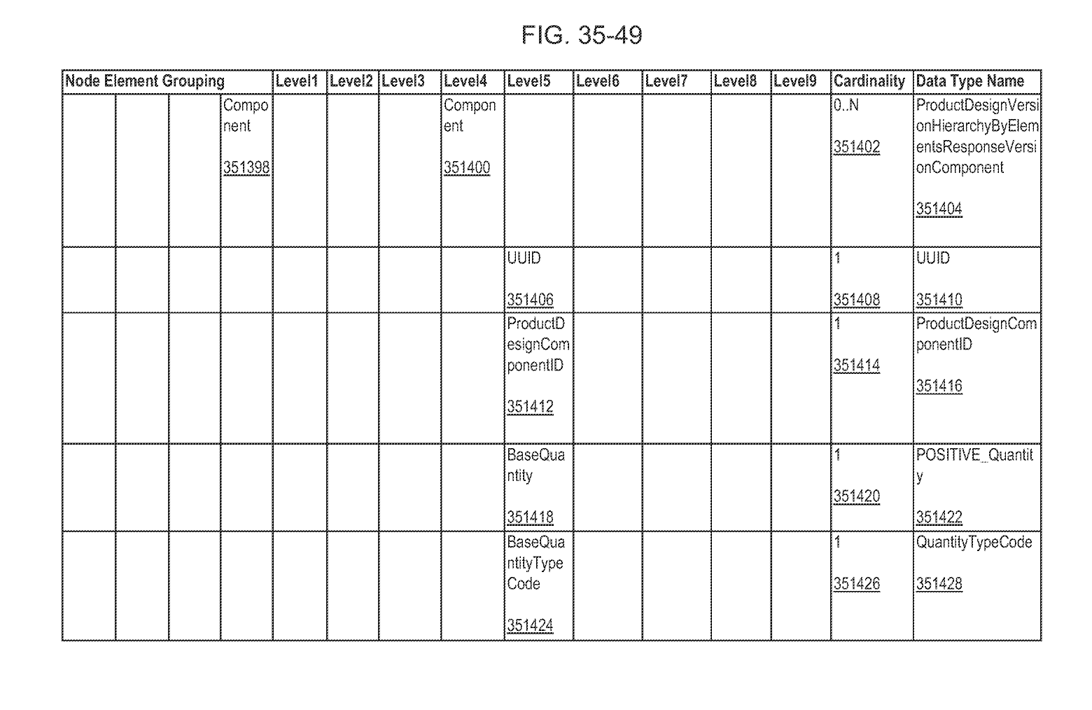

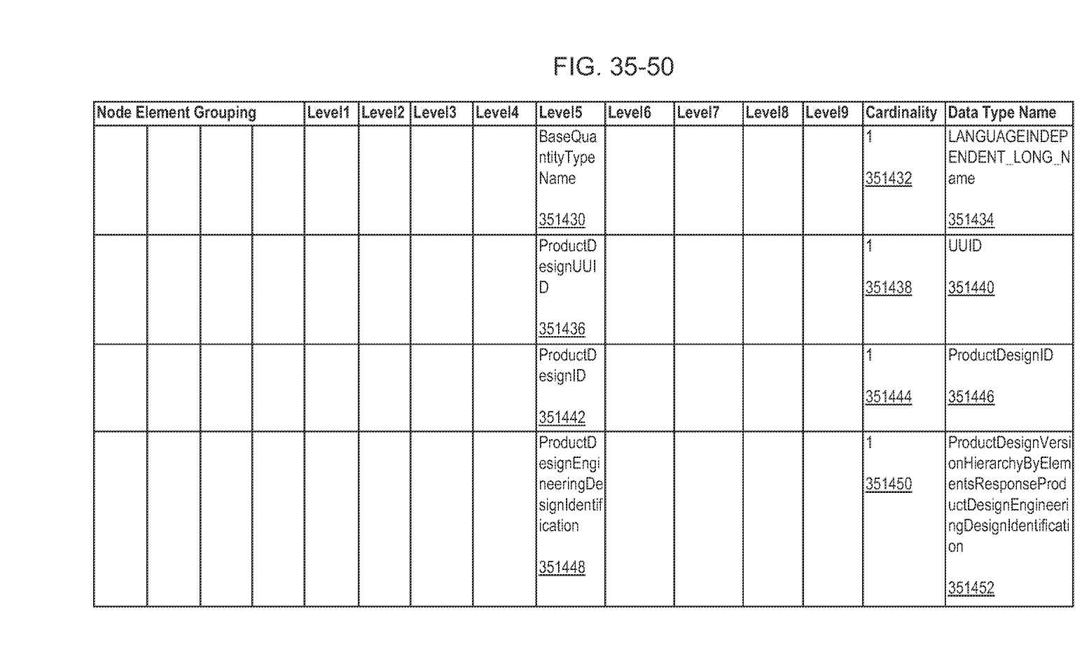

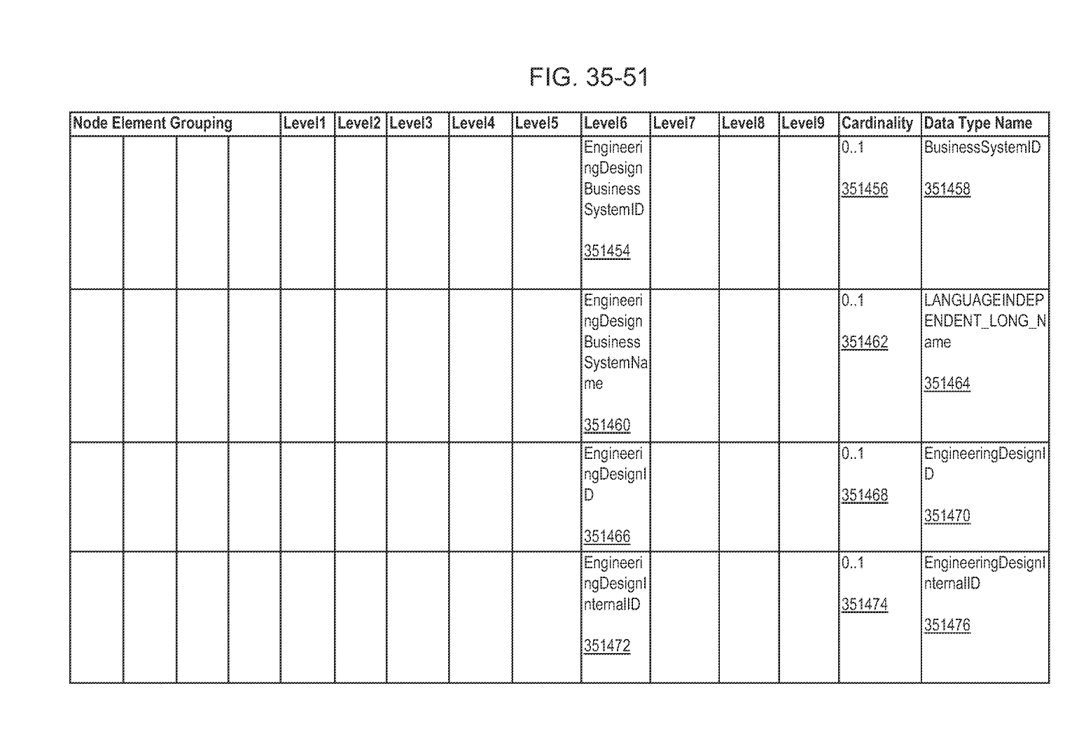

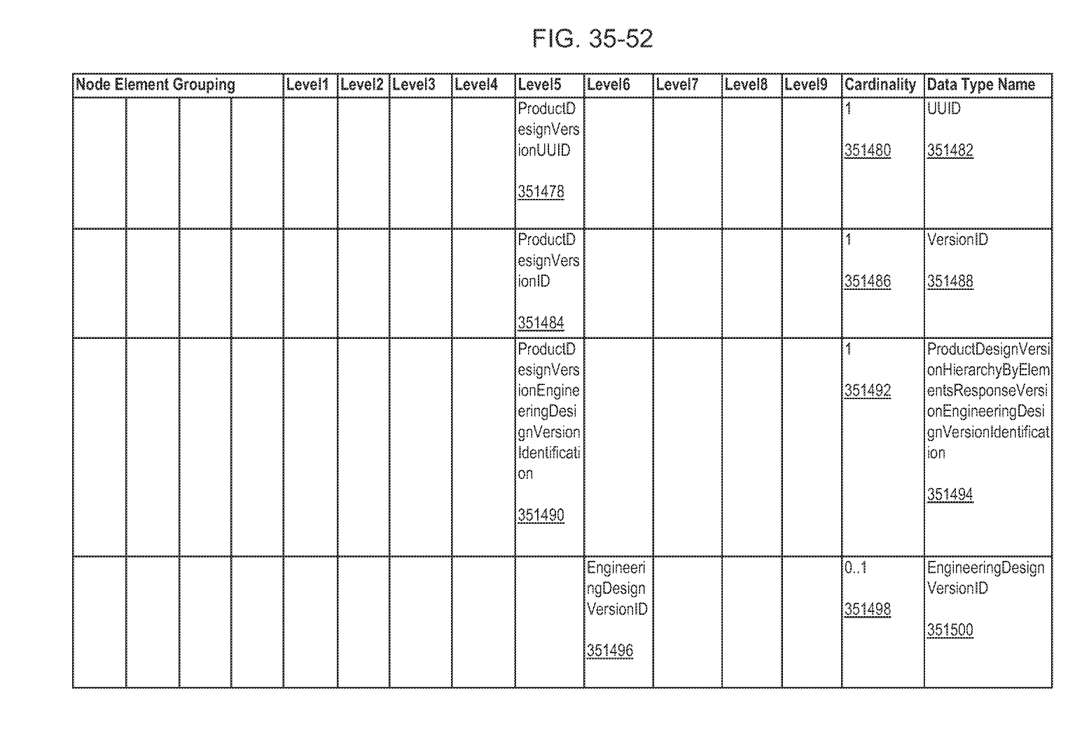

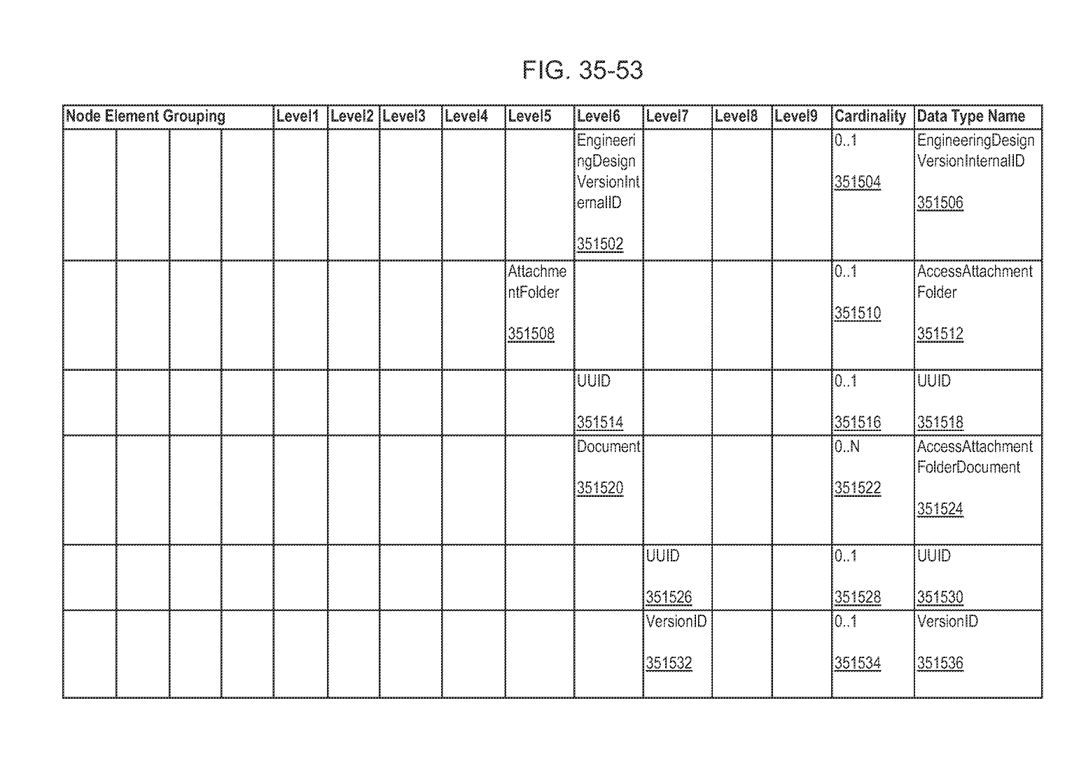

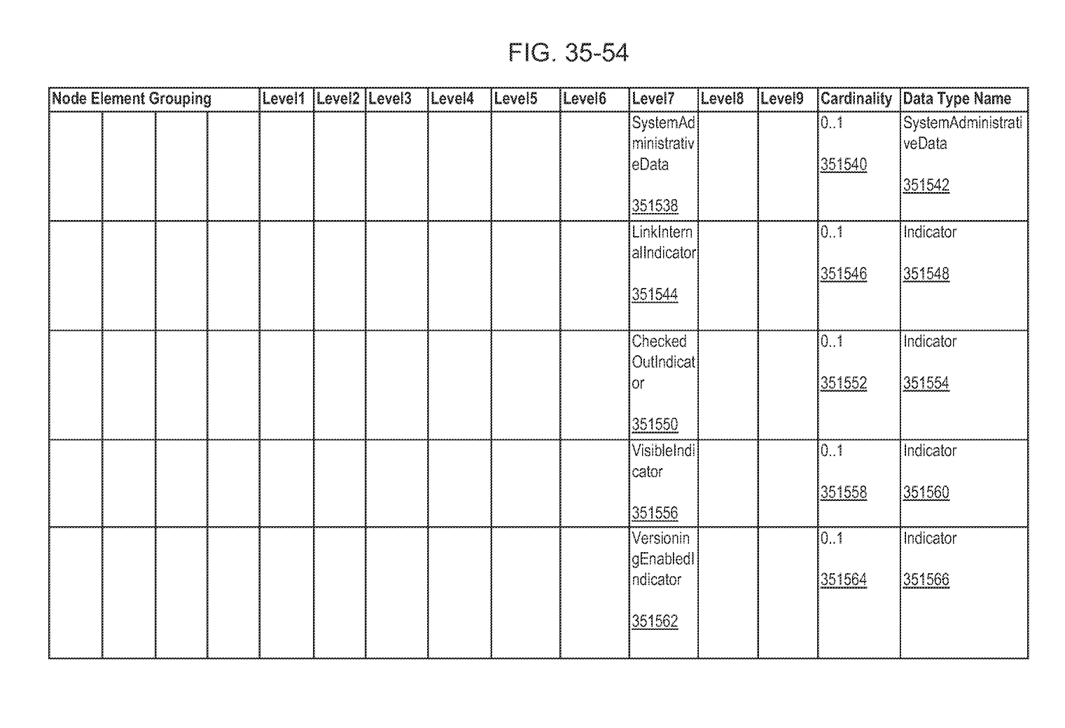

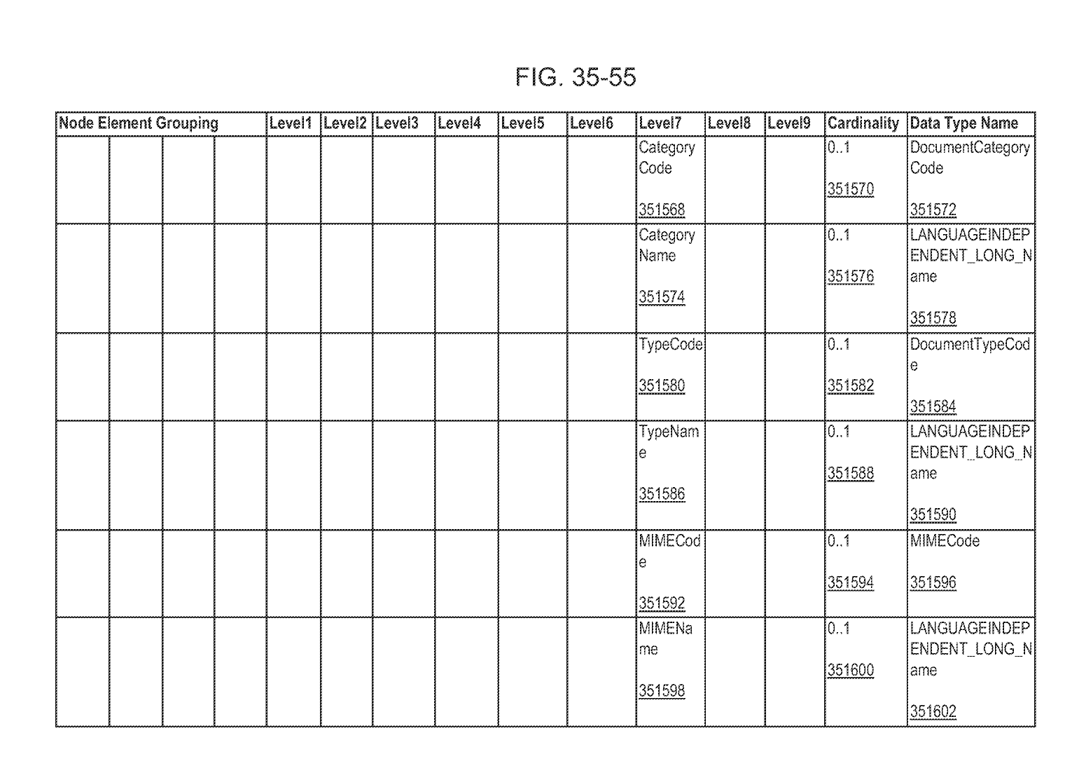

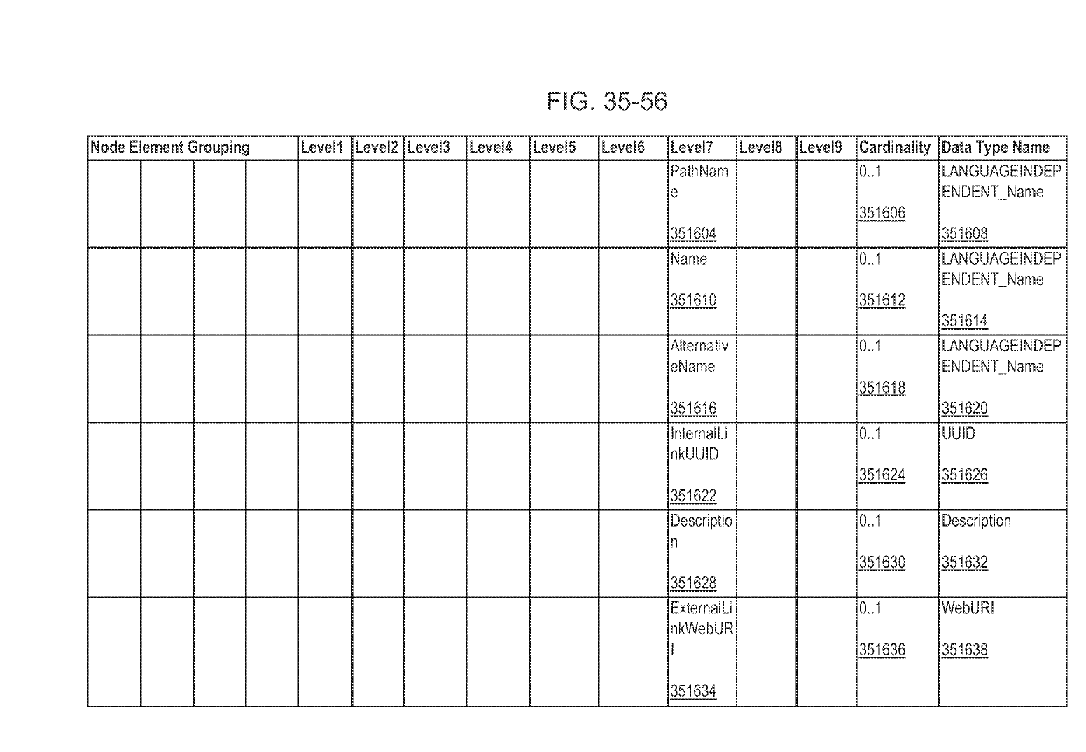

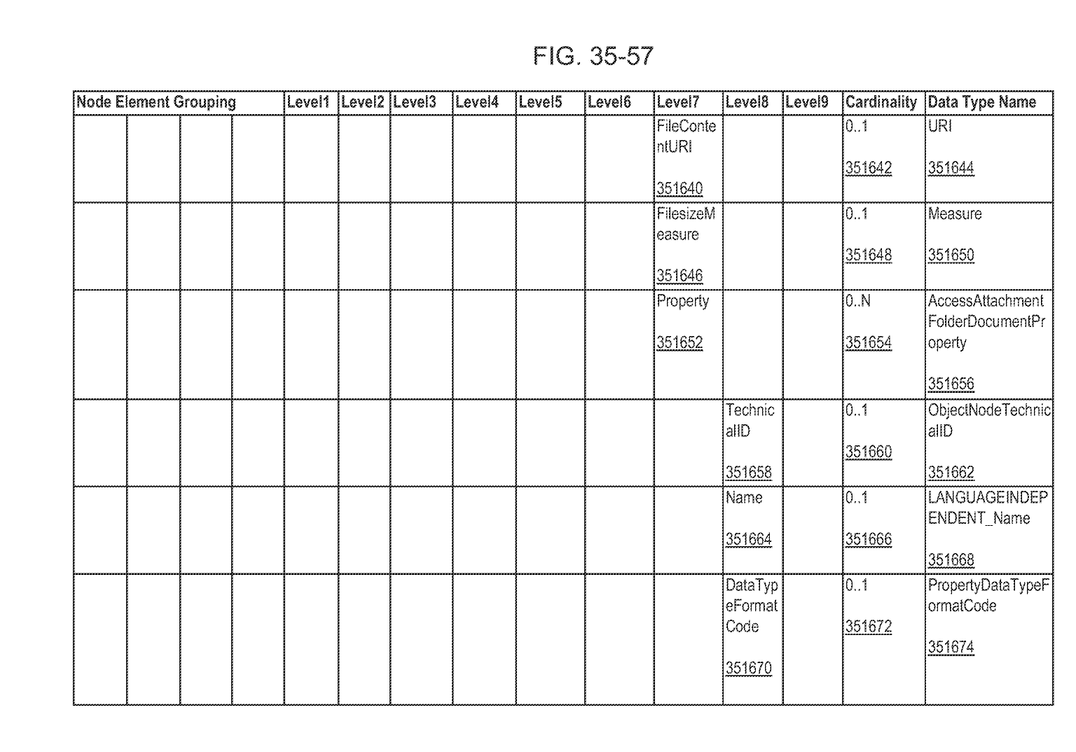

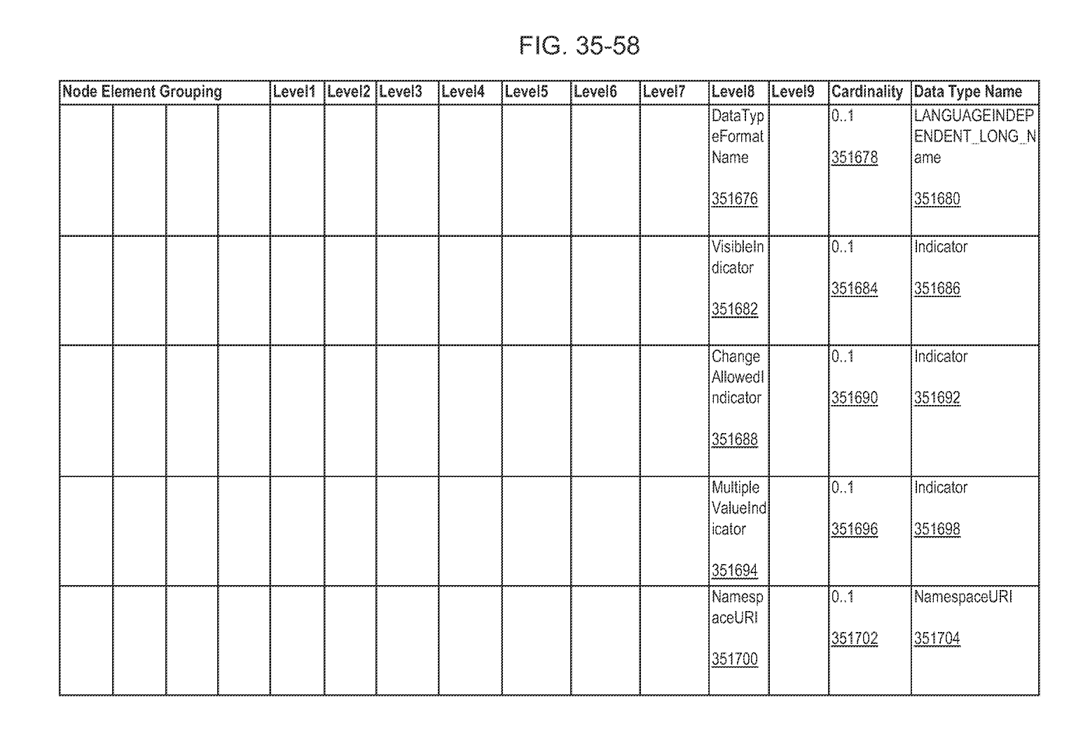

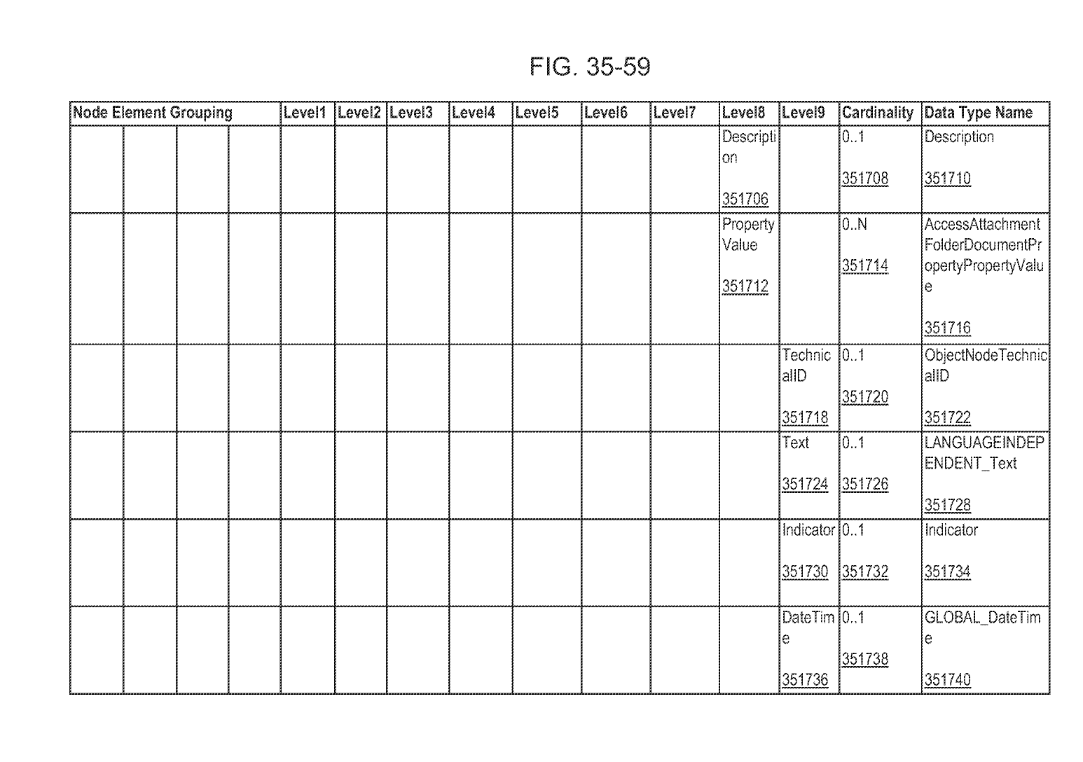

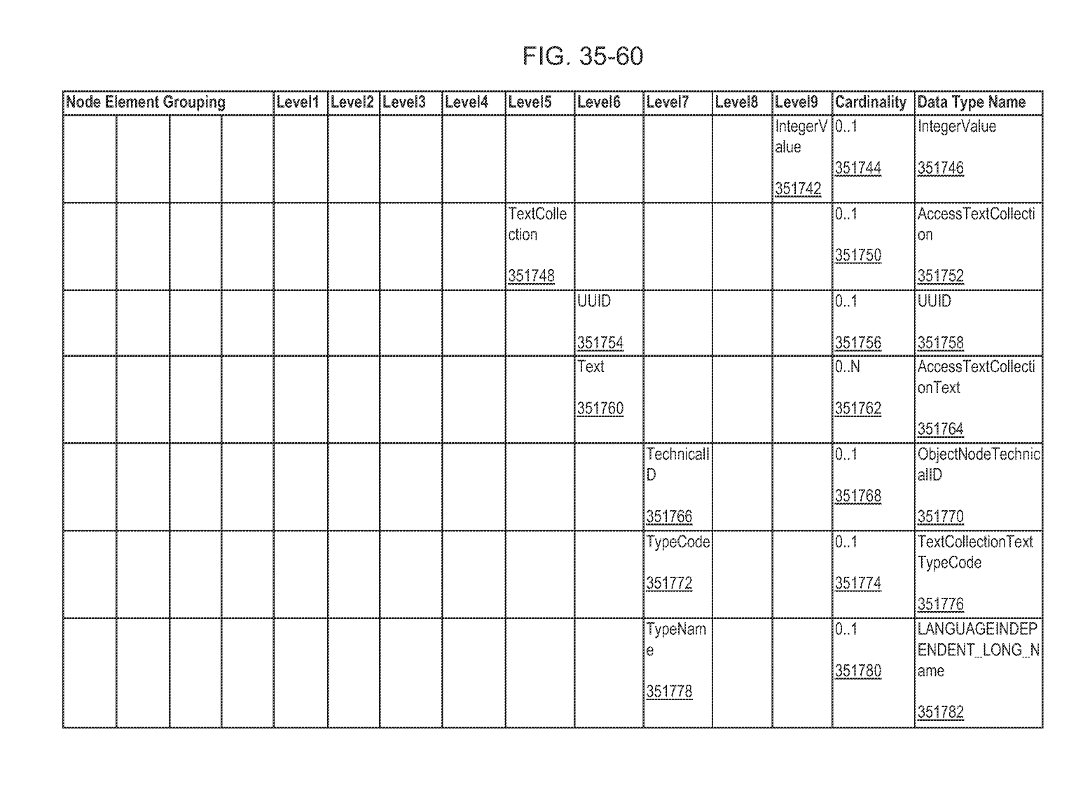

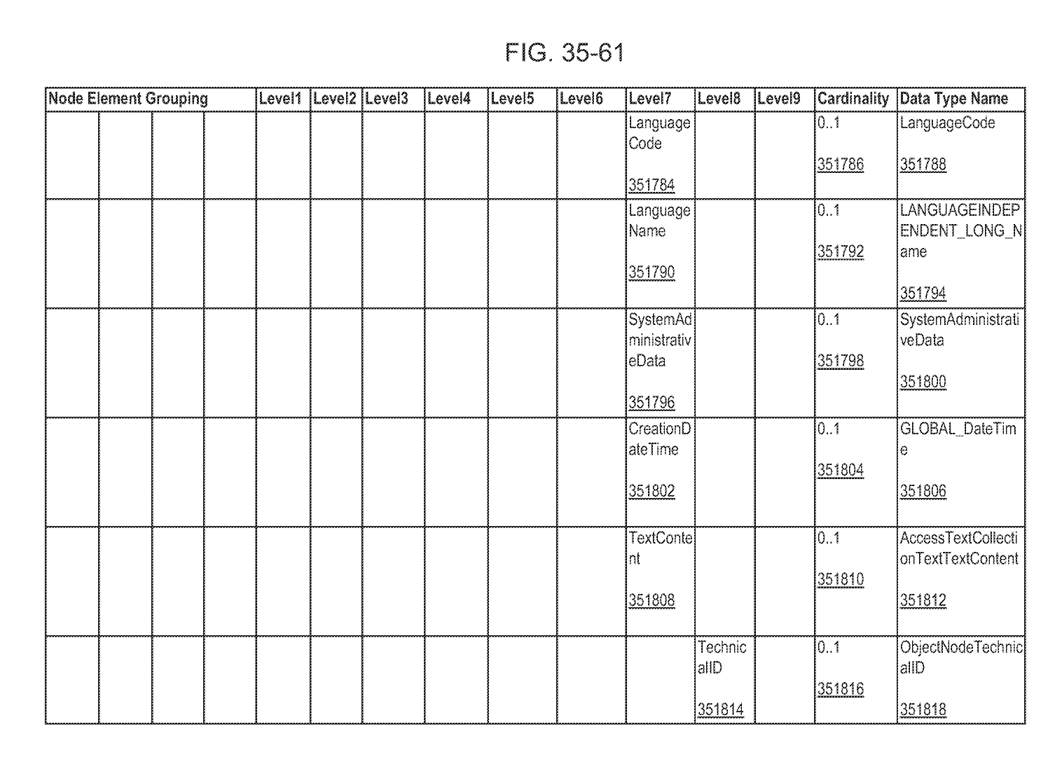

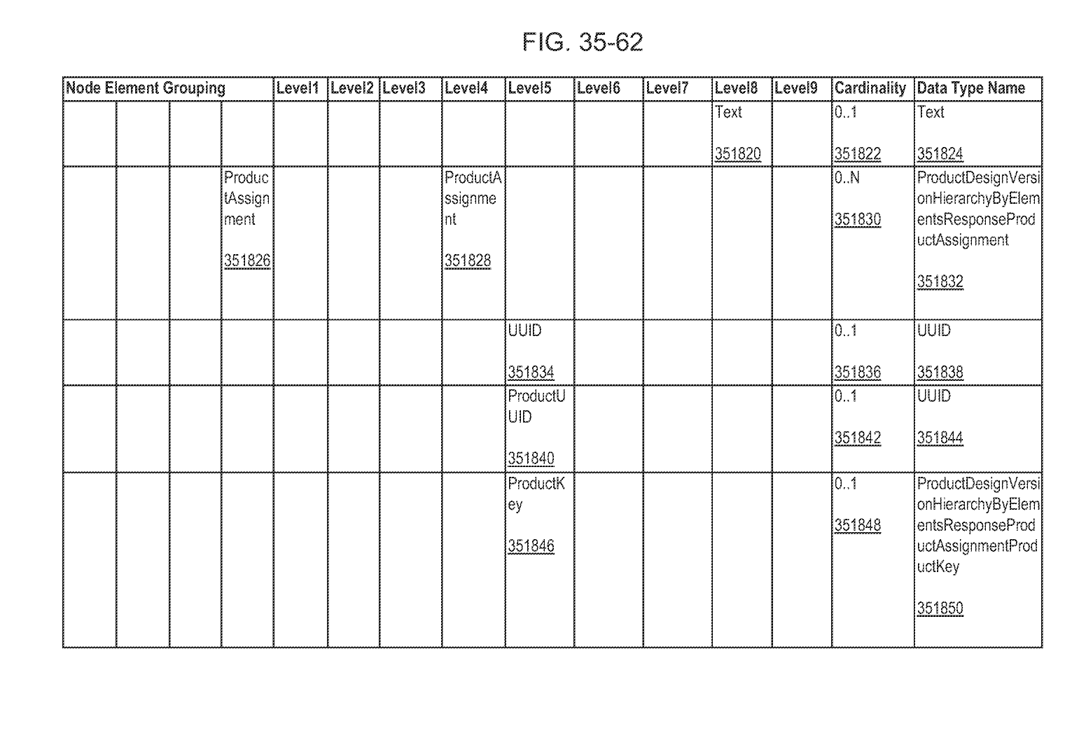

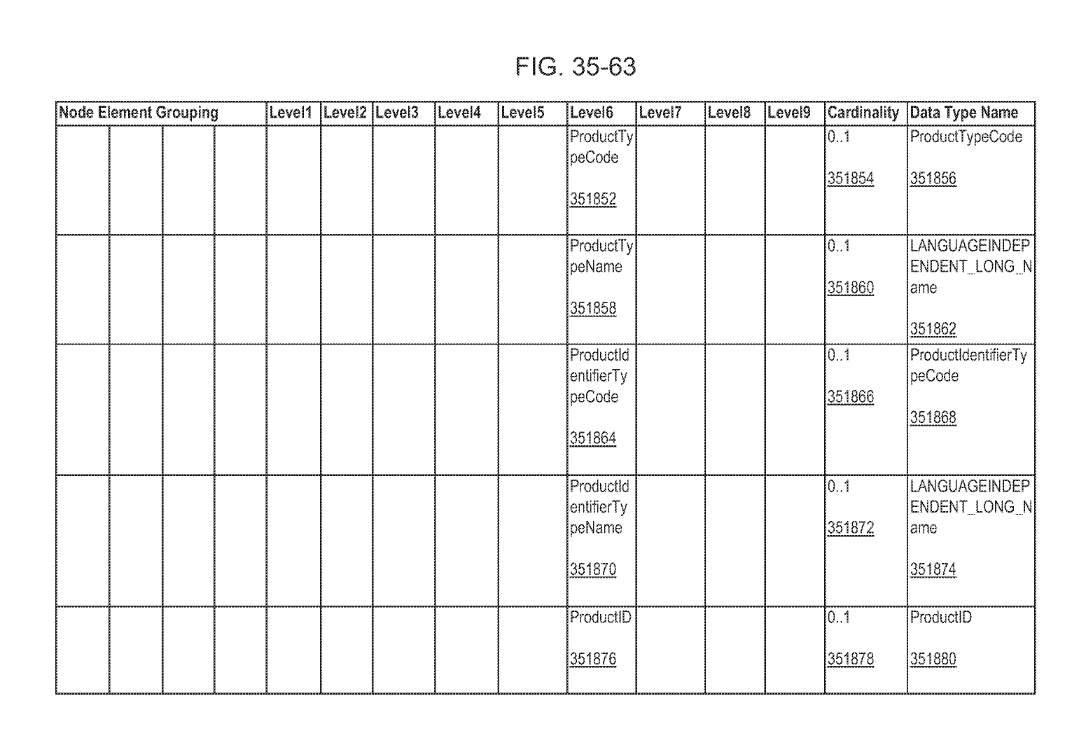

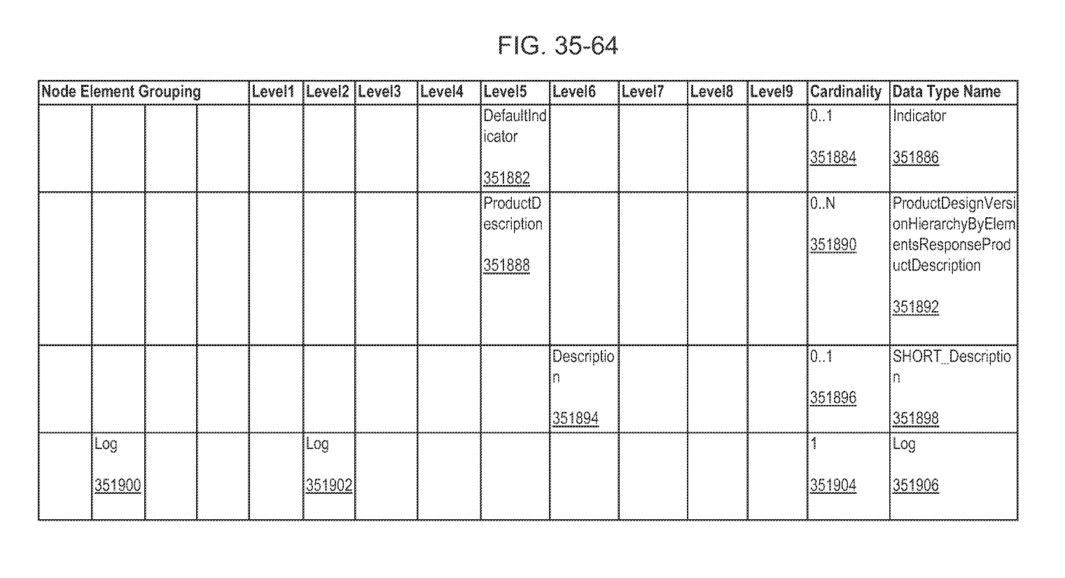

FIGS. 35-1 through 35-64 show an example configuration of an Element Structure that includes a ProductDesignVersionHierarchyByElementsResponse_sync 350000 node element grouping. Specifically, these figures depict the arrangement and hierarchy of various components such as one or more levels of node element groupings, entities, and datatypes, shown here as 350000 through 351906. As described above, node element groupings may be used to represent hierarchy levels. Entities are discrete business elements that are used during a business transaction. Data types are used to type object entities and interfaces with a structure. For example, the ProductDesignVersionHierarchyByElementsResponsesync 350000 includes, among other things, a ProductDesignVersionHierarchyByElementsResponsesync 350002. Accordingly, heterogeneous applications may communicate using this consistent message configured as such. The ProductDesignVersionHierarchyByElementsResponse_sync 350000 node element grouping is a ProductDesignVersionHierarchyByElementsResponseMessage_sync 350004 data type. The ProductDesignVersionHierarchyByElementsResponse_sync 350000 node element grouping includes a ProductDesignVersionHierarchyByElementsResponse_sync 350002 entity. The ProductDesignVersionHierarchyByElementsResponse_sync 350000 node element grouping includes various node element groupings, namely a MessageHeader 350006, a ProductDesignVersionHierarchy 350014, a ProductDesign 350114 and a Log 351900.

The MessageHeader 350006 node element grouping is a BusinessDocumentMessageHeader 350012 data type. The MessageHeader 350006 node element grouping includes a MessageHeader 350008 entity.

The MessageHeader 350008 entity has a cardinality of 1 350010 meaning that for each instance of the MessageHeader 350006 node element grouping there is one MessageHeader 350008 entity.

The ProductDesignVersionHierarchy 350014 node element grouping is a ProductDesignVersionHierarchyByElementsResponse 350020 data type. The ProductDesignVersionHierarchy 350014 node element grouping includes a ProductDesignVersionHierarchy 350016 entity. The ProductDesignVersionHierarchy 350014 node element grouping includes a Component 350070 node element grouping.

The ProductDesignVersionHierarchy 350016 entity has a cardinality of 0 . . . N 350018 meaning that for each instance of the ProductDesignVersionHierarchy 350014 node element grouping there may be one or more ProductDesignVersionHierarchy 350016 entities. The ProductDesignVersionHierarchy 350016 entity includes various attributes, namely an UUID 350022, a ProductDesignVersionUUID 350028, a ProductDesignID 350034, a ProductDesignVersionID 350040, an EngineeringDesignBusinessSystemID 350046, an EngineeringDesignInternalID 350052, an EngineeringDesignVersionInternalID 350058 and a Log 350064.

The UUID 350022 attribute is an UUID 350026 data type. The UUID 350022 attribute has a cardinality of 1 350024 meaning that for each instance of the ProductDesignVersionHierarchy 350016 entity there is one UUID 350022 attribute. The ProductDesignVersionUUID 350028 attribute is an UUID 350032 data type. The ProductDesignVersionUUID 350028 attribute has a cardinality of 0 . . . 1 350030 meaning that for each instance of the ProductDesignVersionHierarchy 350016 entity there may be one ProductDesignVersionUUID 350028 attribute.

The ProductDesignID 350034 attribute is a ProductDesignID 350038 data type. The ProductDesignID 350034 attribute has a cardinality of 0 . . . 1 350036 meaning that for each instance of the ProductDesignVersionHierarchy 350016 entity there may be one ProductDesignID 350034 attribute.

The ProductDesignVersionID 350040 attribute is a VersionID 350044 data type. The ProductDesignVersionID 350040 attribute has a cardinality of 0 . . . 1 350042 meaning that for each instance of the ProductDesignVersionHierarchy 350016 entity there may be one ProductDesignVersionID 350040 attribute.

The EngineeringDesignBusinessSystemID 350046 attribute is a BusinessSystemID 350050 data type. The EngineeringDesignBusinessSystemID 350046 attribute has a cardinality of 0 . . . 1 350048 meaning that for each instance of the ProductDesignVersionHierarchy 350016 entity there may be one EngineeringDesignBusinessSystemID 350046 attribute.

The EngineeringDesignInternalID 350052 attribute is an EngineeringDesignInternalID 350056 data type. The EngineeringDesignInternalID 350052 attribute has a cardinality of 0 . . . 1 350054 meaning that for each instance of the ProductDesignVersionHierarchy 350016 entity there may be one EngineeringDesignInternalID 350052 attribute.

The EngineeringDesignVersionInternalID 350058 attribute is an EngineeringDesignVersionInternalID 350062 data type. The EngineeringDesignVersionInternalID 350058 attribute has a cardinality of 0 . . . 1 350060 meaning that for each instance of the ProductDesignVersionHierarchy 350016 entity there may be one EngineeringDesignVersionInternalID 350058 attribute.

The Log 350064 attribute is a Log 350068 data type. The Log 350064 attribute has a cardinality of 1 350066 meaning that for each instance of the ProductDesignVersionHierarchy 350016 entity there is one Log 350064 attribute.

The Component 350070 node element grouping is a ProductDesignVersionHierarchyByElementsResponseComponent 350076 data type. The Component 350070 node element grouping includes a Component 350072 entity. The Component 350072 entity has a cardinality of 0 . . . N 350074 meaning that for each instance of the Component 350070 node element grouping there may be one or more Component 350072 entities. The Component 350072 entity includes various attributes, namely an UUID 350078, a ParentComponentUUID 350084, a ProductDesignUUID 350090, a ProductDesignVersionUUID 350096, a Quantity 350102 and a ProductDesignVersionComponentID 350108.

The UUID 350078 attribute is an UUID 350082 data type. The UUID 350078 attribute has a cardinality of 0 . . . 1 350080 meaning that for each instance of the Component 350072 entity there may be one UUID 350078 attribute.

The ParentComponentUUID 350084 attribute is an UUID 350088 data type. The ParentComponentUUID 350084 attribute has a cardinality of 0 . . . 1 350086 meaning that for each instance of the Component 350072 entity there may be one ParentComponentUUID 350084 attribute.

The ProductDesignUUID 350090 attribute is an UUID 350094 data type. The ProductDesignUUID 350090 attribute has a cardinality of 0 . . . 1 350092 meaning that for each instance of the Component 350072 entity there may be one ProductDesignUUID 350090 attribute.

The ProductDesignVersionUUID 350096 attribute is an UUID 350100 data type. The ProductDesignVersionUUID 350096 attribute has a cardinality of 0 . . . 1 350098 meaning that for each instance of the Component 350072 entity there may be one ProductDesignVersionUUID 350096 attribute.

The Quantity 350102 attribute is a NONNEGATIVE_Quantity 350106 data type. The Quantity 350102 attribute has a cardinality of 0 . . . 1 350104 meaning that for each instance of the Component 350072 entity there may be one Quantity 350102 attribute.

The ProductDesignVersionComponentID 350108 attribute is a ProductDesignComponentID 350112 data type. The ProductDesignVersionComponentID 350108 attribute has a cardinality of 0 . . . 1 350110 meaning that for each instance of the Component 350072 entity there may be one ProductDesignVersionComponentID 350108 attribute.

The ProductDesign 350114 node element grouping is a ProductDesignVersionHierarchyByElementsResponseProductDesign 350120 data type. The ProductDesign 350114 node element grouping includes a ProductDesign 350116 entity. The ProductDesign 350114 node element grouping includes various node element groupings, namely a ProductionBillOfMaterialVariantHandover 350584 and a Version 350724.

The ProductDesign 350116 entity has a cardinality of 0 . . . N 350118 meaning that for each instance of the ProductDesign 350114 node element grouping there may be one or more ProductDesign 350116 entities. The ProductDesign 350116 entity includes various attributes, namely an UUID 350122, an ID 350128, a CategoryCode 350134, a CategoryName 350140, a ResponsibleEmployeeUUID 350146, a ResponsibleEmployeeID 350152, a MostRecentlyCreatedVersionUUID 350188 and a SystemAdministrativeData 350194. The ProductDesign 350116 entity includes various subordinate entities, namely an EngineeringDesignIdentification 350158, a CreationIdentity 350200, a LastChangeIdentity 350218, a ResponsibleEmployee 350236, a Description 350254, an AttachmentFolder 350266 and a TextCollection 350506.

The UUID 350122 attribute is an UUID 350126 data type. The UUID 350122 attribute has a cardinality of 0 . . . 1 350124 meaning that for each instance of the ProductDesign 350116 entity there may be one UUID 350122 attribute.

The ID 350128 attribute is a ProductDesignID 350132 data type. The ID 350128 attribute has a cardinality of 0 . . . 1 350130 meaning that for each instance of the ProductDesign 350116 entity there may be one ID 350128 attribute.

The CategoryCode 350134 attribute is a ProductDesignCategoryCode 350138 data type. The CategoryCode 350134 attribute has a cardinality of 0 . . . 1 350136 meaning that for each instance of the ProductDesign 350116 entity there may be one CategoryCode 350134 attribute.

The CategoryName 350140 attribute is a LANGUAGEINDEPENDENT_LONG_Name 350144 data type. The CategoryName 350140 attribute has a cardinality of 0 . . . 1 350142 meaning that for each instance of the ProductDesign 350116 entity there may be one CategoryName 350140 attribute.

The ResponsibleEmployeeUUID 350146 attribute is an UUID 350150 data type. The ResponsibleEmployeeUUID 350146 attribute has a cardinality of 0 . . . 1 350148 meaning that for each instance of the ProductDesign 350116 entity there may be one ResponsibleEmployeeUUID 350146 attribute.

The ResponsibleEmployeeID 350152 attribute is an EmployeeID 350156 data type. The ResponsibleEmployeeID 350152 attribute has a cardinality of 0 . . . 1 350154 meaning that for each instance of the ProductDesign 350116 entity there may be one ResponsibleEmployeeID 350152 attribute.

The MostRecentlyCreatedVersionUUID 350188 attribute is an UUID 350192 data type. The MostRecentlyCreatedVersionUUID 350188 attribute has a cardinality of 0 . . . 1 350190 meaning that for each instance of the ProductDesign 350116 entity there may be one MostRecentlyCreatedVersionUUID 350188 attribute.

The SystemAdministrativeData 350194 attribute is a SystemAdministrativeData 350198 data type. The SystemAdministrativeData 350194 attribute has a cardinality of 0 . . . 1 350196 meaning that for each instance of the ProductDesign 350116 entity there may be one SystemAdministrativeData 350194 attribute.

The EngineeringDesignIdentification 350158 entity has a cardinality of 0 . . . 1 350160 meaning that for each instance of the ProductDesign 350116 entity there may be one EngineeringDesignIdentification 350158 entity. The EngineeringDesignIdentification 350158 entity includes various attributes, namely an EngineeringDesignBusinessSystemID 350164, an EngineeringDesignBusinessSystemName 350170, an EngineeringDesignID 350176 and an EngineeringDesignInternalID 350182.

The EngineeringDesignBusinessSystemID 350164 attribute is a BusinessSystemID 350168 data type. The EngineeringDesignBusinessSystemID 350164 attribute has a cardinality of 0 . . . 1 350166 meaning that for each instance of the EngineeringDesignIdentification 350158 entity there may be one EngineeringDesignBusinessSystemID 350164 attribute.

The EngineeringDesignBusinessSystemName 350170 attribute is a LANGUAGEINDEPENDENT_LONG_Name 350174 data type. The EngineeringDesignBusinessSystemName 350170 attribute has a cardinality of 0 . . . 1 350172 meaning that for each instance of the EngineeringDesignIdentification 350158 entity there may be one EngineeringDesignBusinessSystemName 350170 attribute.

The EngineeringDesignID 350176 attribute is an EngineeringDesignID 350180 data type. The EngineeringDesignID 350176 attribute has a cardinality of 0 . . . 1 350178 meaning that for each instance of the EngineeringDesignIdentification 350158 entity there may be one EngineeringDesignID 350176 attribute.

The EngineeringDesignInternalID 350182 attribute is an EngineeringDesignInternalID 350186 data type. The EngineeringDesignInternalID 350182 attribute has a cardinality of 0 . . . 1 350184 meaning that for each instance of the EngineeringDesignIdentification 350158 entity there may be one EngineeringDesignInternalID 350182 attribute. The CreationIdentity 350200 entity has a cardinality of 1 350202 meaning that for each instance of the ProductDesign 350116 entity there is one CreationIdentity 350200 entity. The CreationIdentity 350200 entity includes various attributes, namely a PersonNameGivenName 350206 and a PersonNameFamilyName 350212.

The PersonNameGivenName 350206 attribute is a LANGUAGEINDEPENDENT_MEDIUM_Name 350210 data type. The PersonNameGivenName 350206 attribute has a cardinality of 1 350208 meaning that for each instance of the CreationIdentity 350200 entity there is one PersonNameGivenName 350206 attribute.

The PersonNameFamilyName 350212 attribute is a LANGUAGEINDEPENDENT_MEDIUM_Name 350216 data type. The PersonNameFamilyName 350212 attribute has a cardinality of 1 350214 meaning that for each instance of the CreationIdentity 350200 entity there is one PersonNameFamilyName 350212 attribute. The LastChangeIdentity 350218 entity has a cardinality of 1 350220 meaning that for each instance of the ProductDesign 350116 entity there is one LastChangeIdentity 350218 entity. The LastChangeIdentity 350218 entity includes various attributes, namely a PersonNameGivenName 350224 and a PersonNameFamilyName 350230.

The PersonNameGivenName 350224 attribute is a LANGUAGEINDEPENDENT_MEDIUM_Name 350228 data type. The PersonNameGivenName 350224 attribute has a cardinality of 1 350226 meaning that for each instance of the LastChangeIdentity 350218 entity there is one PersonNameGivenName 350224 attribute.

The PersonNameFamilyName 350230 attribute is a LANGUAGEINDEPENDENT_MEDIUM_Name 350234 data type. The PersonNameFamilyName 350230 attribute has a cardinality of 1 350232 meaning that for each instance of the LastChangeIdentity 350218 entity there is one PersonNameFamilyName 350230 attribute.

The ResponsibleEmployee 350236 entity has a cardinality of 0 . . . 1 350238 meaning that for each instance of the ProductDesign 350116 entity there may be one ResponsibleEmployee 350236 entity. The ResponsibleEmployee 350236 entity includes various attributes, namely a PersonNameGivenName 350242 and a PersonNameFamilyName 350248.

The PersonNameGivenName 350242 attribute is a LANGUAGEINDEPENDENT_MEDIUM_Name 350246 data type. The PersonNameGivenName 350242 attribute has a cardinality of 1 350244 meaning that for each instance of the ResponsibleEmployee 350236 entity there is one PersonNameGivenName 350242 attribute.

The PersonNameFamilyName 350248 attribute is a LANGUAGEINDEPENDENT_MEDIUM_Name 350252 data type. The PersonNameFamilyName 350248 attribute has a cardinality of 1 350250 meaning that for each instance of the ResponsibleEmployee 350236 entity there is one PersonNameFamilyName 350248 attribute.

The Description 350254 entity has a cardinality of 0 . . . N 350256 meaning that for each instance of the ProductDesign 350116 entity there may be one or more Description 350254 entities. The Description 350254 entity includes a Description 350260 attribute.

The Description 350260 attribute is a MEDIUM_Description 350264 data type. The Description 350260 attribute has a cardinality of 0 . . . 1 350262 meaning that for each instance of the Description 350254 entity there may be one Description 350260 attribute.

The AttachmentFolder 350266 entity has a cardinality of 0 . . . 1 350268 meaning that for each instance of the ProductDesign 350116 entity there may be one AttachmentFolder 350266 entity. The AttachmentFolder 350266 entity includes an UUID 350272 attribute. The AttachmentFolder 350266 entity includes a Document 350278 subordinate entity.

The UUID 350272 attribute is an UUID 350276 data type. The UUID 350272 attribute has a cardinality of 0 . . . 1 350274 meaning that for each instance of the AttachmentFolder 350266 entity there may be one UUID 350272 attribute.

The Document 350278 entity has a cardinality of 0 . . . N 350280 meaning that for each instance of the AttachmentFolder 350266 entity there may be one or more Document 350278 entities. The Document 350278 entity includes various attributes, namely an UUID 350284, a VersionID 350290, a SystemAdministrativeData 350296, a LinkInternalIndicator 350302, a CheckedOutIndicator 350308, a VisibleIndicator 350314, a VersioningEnabledIndicator 350320, a CategoryCode 350326, a CategoryName 350332, a TypeCode 350338, a TypeName 350344, a MIMECode 350350, a MIMEName 350356, a PathName 350362, a Name 350368, an AlternativeName 350374, an InternalLinkUUID 350380, a Description 350386, an ExternalLinkWebURI 350392, a FileContentURI 350398 and a FilesizeMeasure 350404. The Document 350278 entity includes a Property 350410 subordinate entity.

The UUID 350284 attribute is an UUID 350288 data type. The UUID 350284 attribute has a cardinality of 0 . . . 1 350286 meaning that for each instance of the Document 350278 entity there may be one UUID 350284 attribute.

The VersionID 350290 attribute is a VersionID 350294 data type. The VersionID 350290 attribute has a cardinality of 0 . . . 1 350292 meaning that for each instance of the Document 350278 entity there may be one VersionID 350290 attribute.

The SystemAdministrativeData 350296 attribute is a SystemAdministrativeData 350300 data type. The SystemAdministrativeData 350296 attribute has a cardinality of 0 . . . 1 350298 meaning that for each instance of the Document 350278 entity there may be one SystemAdministrativeData 350296 attribute.

The LinkInternalIndicator 350302 attribute is an Indicator 350306 data type. The LinkInternalIndicator 350302 attribute has a cardinality of 0 . . . 1 350304 meaning that for each instance of the Document 350278 entity there may be one LinkInternalIndicator 350302 attribute.

The CheckedOutIndicator 350308 attribute is an Indicator 350312 data type. The CheckedOutIndicator 350308 attribute has a cardinality of 0 . . . 1 350310 meaning that for each instance of the Document 350278 entity there may be one CheckedOutIndicator 350308 attribute.

The VisibleIndicator 350314 attribute is an Indicator 350318 data type. The VisibleIndicator 350314 attribute has a cardinality of 0 . . . 1 350316 meaning that for each instance of the Document 350278 entity there may be one VisibleIndicator 350314 attribute.

The VersioningEnabledIndicator 350320 attribute is an Indicator 350324 data type. The VersioningEnabledIndicator 350320 attribute has a cardinality of 0 . . . 1 350322 meaning that for each instance of the Document 350278 entity there may be one VersioningEnabledIndicator 350320 attribute.

The CategoryCode 350326 attribute is a DocumentCategoryCode 350330 data type. The CategoryCode 350326 attribute has a cardinality of 0 . . . 1 350328 meaning that for each instance of the Document 350278 entity there may be one CategoryCode 350326 attribute.

The CategoryName 350332 attribute is a LANGUAGEINDEPENDENT_LONG_Name 350336 data type. The CategoryName 350332 attribute has a cardinality of 0 . . . 1 350334 meaning that for each instance of the Document 350278 entity there may be one CategoryName 350332 attribute.

The TypeCode 350338 attribute is a DocumentTypeCode 350342 data type. The TypeCode 350338 attribute has a cardinality of 0 . . . 1 350340 meaning that for each instance of the Document 350278 entity there may be one TypeCode 350338 attribute.

The TypeName 350344 attribute is a LANGUAGEINDEPENDENT_LONG_Name 350348 data type. The TypeName 350344 attribute has a cardinality of 0 . . . 1 350346 meaning that for each instance of the Document 350278 entity there may be one TypeName 350344 attribute.

The MIMECode 350350 attribute is a MIMECode 350354 data type. The MIMECode 350350 attribute has a cardinality of 0 . . . 1 350352 meaning that for each instance of the Document 350278 entity there may be one MIMECode 350350 attribute. The MIMEName 350356 attribute is a LANGUAGEINDEPENDENT_LONG_Name 350360 data type. The MIMEName 350356 attribute has a cardinality of 0 . . . 1 350358 meaning that for each instance of the Document 350278 entity there may be one MIMEName 350356 attribute.

The PathName 350362 attribute is a LANGUAGEINDEPENDENT_Name 350366 data type. The PathName 350362 attribute has a cardinality of 0 . . . 1 350364 meaning that for each instance of the Document 350278 entity there may be one PathName 350362 attribute.

The Name 350368 attribute is a LANGUAGEINDEPENDENT_Name 350372 data type. The Name 350368 attribute has a cardinality of 0 . . . 1 350370 meaning that for each instance of the Document 350278 entity there may be one Name 350368 attribute.

The AlternativeName 350374 attribute is a LANGUAGEINDEPENDENT_Name 350378 data type. The AlternativeName 350374 attribute has a cardinality of 0 . . . 1 350376 meaning that for each instance of the Document 350278 entity there may be one AlternativeName 350374 attribute.

The InternalLinkUUID 350380 attribute is an UUID 350384 data type. The InternalLinkUUID 350380 attribute has a cardinality of 0 . . . 1 350382 meaning that for each instance of the Document 350278 entity there may be one InternalLinkUUID 350380 attribute.

The Description 350386 attribute is a Description 350390 data type. The Description 350386 attribute has a cardinality of 0 . . . 1 350388 meaning that for each instance of the Document 350278 entity there may be one Description 350386 attribute.

The ExternalLinkWebURI 350392 attribute is a WebURI 350396 data type. The ExternalLinkWebURI 350392 attribute has a cardinality of 0 . . . 1 350394 meaning that for each instance of the Document 350278 entity there may be one ExternalLinkWebURI 350392 attribute.

The FileContentURI 350398 attribute is an URI 350402 data type. The FileContentURI 350398 attribute has a cardinality of 0 . . . 1 350400 meaning that for each instance of the Document 350278 entity there may be one FileContentURI 350398 attribute.

The FilesizeMeasure 350404 attribute is a Measure 350408 data type. The FilesizeMeasure 350404 attribute has a cardinality of 0 . . . 1 350406 meaning that for each instance of the Document 350278 entity there may be one FilesizeMeasure 350404 attribute. The Property 350410 entity has a cardinality of 0 . . . N 350412 meaning that for each instance of the Document 350278 entity there may be one or more Property 350410 entities. The Property 350410 entity includes various attributes, namely a TechnicalID 350416, a Name 350422, a DataTypeFormatCode 350428, a DataTypeFormatName 350434, a VisibleIndicator 350440, a ChangeAllowedIndicator 350446, a MultipleValueIndicator 350452, a NamespaceURI 350458 and a Description 350464. The Property 350410 entity includes a PropertyValue 350470 subordinate entity.

The TechnicalID 350416 attribute is an ObjectNodeTechnicalID 350420 data type. The TechnicalID 350416 attribute has a cardinality of 0 . . . 1 350418 meaning that for each instance of the Property 350410 entity there may be one TechnicalID 350416 attribute.

The Name 350422 attribute is a LANGUAGEINDEPENDENT_Name 350426 data type. The Name 350422 attribute has a cardinality of 0 . . . 1 350424 meaning that for each instance of the Property 350410 entity there may be one Name 350422 attribute.

The DataTypeFormatCode 350428 attribute is a PropertyDataTypeFormatCode 350432 data type. The DataTypeFormatCode 350428 attribute has a cardinality of 0 . . . 1 350430 meaning that for each instance of the Property 350410 entity there may be one DataTypeFormatCode 350428 attribute.

The DataTypeFormatName 350434 attribute is a LANGUAGEINDEPENDENT_LONG_Name 350438 data type. The DataTypeFormatName 350434 attribute has a cardinality of 0 . . . 1 350436 meaning that for each instance of the Property 350410 entity there may be one DataTypeFormatName 350434 attribute.

The VisibleIndicator 350440 attribute is an Indicator 350444 data type. The VisibleIndicator 350440 attribute has a cardinality of 0 . . . 1 350442 meaning that for each instance of the Property 350410 entity there may be one VisibleIndicator 350440 attribute.

The ChangeAllowedIndicator 350446 attribute is an Indicator 350450 data type. The ChangeAllowedIndicator 350446 attribute has a cardinality of 0 . . . 1 350448 meaning that for each instance of the Property 350410 entity there may be one ChangeAllowedIndicator 350446 attribute.

The MultipleValueIndicator 350452 attribute is an Indicator 350456 data type. The MultipleValueIndicator 350452 attribute has a cardinality of 0 . . . 1 350454 meaning that for each instance of the Property 350410 entity there may be one MultipleValueIndicator 350452 attribute.

The NamespaceURI 350458 attribute is a NamespaceURI 350462 data type. The NamespaceURI 350458 attribute has a cardinality of 0 . . . 1 350460 meaning that for each instance of the Property 350410 entity there may be one NamespaceURI 350458 attribute.

The Description 350464 attribute is a Description 350468 data type. The Description 350464 attribute has a cardinality of 0 . . . 1 350466 meaning that for each instance of the Property 350410 entity there may be one Description 350464 attribute.

The PropertyValue 350470 entity has a cardinality of 0 . . . N 350472 meaning that for each instance of the Property 350410 entity there may be one or more PropertyValue 350470 entities. The PropertyValue 350470 entity includes various attributes, namely a TechnicalID 350476, a Text 350482, an Indicator 350488, a DateTime 350494 and an IntegerValue 350500.

The TechnicalID 350476 attribute is an ObjectNodeTechnicalID 350480 data type. The TechnicalID 350476 attribute has a cardinality of 0 . . . 1 350478 meaning that for each instance of the PropertyValue 350470 entity there may be one TechnicalID 350476 attribute.

The Text 350482 attribute is a LANGUAGEINDEPENDENT_Text 350486 data type. The Text 350482 attribute has a cardinality of 0 . . . 1 350484 meaning that for each instance of the PropertyValue 350470 entity there may be one Text 350482 attribute. The Indicator 350488 attribute is an Indicator 350492 data type. The Indicator 350488 attribute has a cardinality of 0 . . . 1 350490 meaning that for each instance of the PropertyValue 350470 entity there may be one Indicator 350488 attribute.

The DateTime 350494 attribute is a GLOBAL_DateTime 350498 data type. The DateTime 350494 attribute has a cardinality of 0 . . . 1 350496 meaning that for each instance of the PropertyValue 350470 entity there may be one DateTime 350494 attribute.

The IntegerValue 350500 attribute is an IntegerValue 350504 data type. The IntegerValue 350500 attribute has a cardinality of 0 . . . 1 350502 meaning that for each instance of the PropertyValue 350470 entity there may be one IntegerValue 350500 attribute.

The TextCollection 350506 entity has a cardinality of 0 . . . 1 350508 meaning that for each instance of the ProductDesign 350116 entity there may be one TextCollection 350506 entity. The TextCollection 350506 entity includes an UUID 350512 attribute. The TextCollection 350506 entity includes a Text 350518 subordinate entity.

The UUID 350512 attribute is an UUID 350516 data type. The UUID 350512 attribute has a cardinality of 0 . . . 1 350514 meaning that for each instance of the TextCollection 350506 entity there may be one UUID 350512 attribute.

The Text 350518 entity has a cardinality of 0 . . . N 350520 meaning that for each instance of the TextCollection 350506 entity there may be one or more Text 350518 entities.

The Text 350518 entity includes various attributes, namely a TechnicalID 350524, a TypeCode 350530, a TypeName 350536, a LanguageCode 350542, a LanguageName 350548, a SystemAdministrativeData 350554 and a CreationDateTime 350560. The Text 350518 entity includes a TextContent 350566 subordinate entity.

The TechnicalID 350524 attribute is an ObjectNodeTechnicalID 350528 data type. The TechnicalID 350524 attribute has a cardinality of 0 . . . 1 350526 meaning that for each instance of the Text 350518 entity there may be one TechnicalID 350524 attribute.

The TypeCode 350530 attribute is a TextCollectionTextTypeCode 350534 data type. The TypeCode 350530 attribute has a cardinality of 0 . . . 1 350532 meaning that for each instance of the Text 350518 entity there may be one TypeCode 350530 attribute.

The TypeName 350536 attribute is a LANGUAGEINDEPENDENT_LONG_Name 350540 data type. The TypeName 350536 attribute has a cardinality of 0 . . . 1 350538 meaning that for each instance of the Text 350518 entity there may be one TypeName 350536 attribute.

The LanguageCode 350542 attribute is a LanguageCode 350546 data type. The LanguageCode 350542 attribute has a cardinality of 0 . . . 1 350544 meaning that for each instance of the Text 350518 entity there may be one LanguageCode 350542 attribute.

The LanguageName 350548 attribute is a LANGUAGEINDEPENDENT_LONG_Name 350552 data type. The LanguageName 350548 attribute has a cardinality of 0 . . . 1 350550 meaning that for each instance of the Text 350518 entity there may be one LanguageName 350548 attribute.

The SystemAdministrativeData 350554 attribute is a SystemAdministrativeData 350558 data type. The SystemAdministrativeData 350554 attribute has a cardinality of 0 . . . 1 350556 meaning that for each instance of the Text 350518 entity there may be one SystemAdministrativeData 350554 attribute.

The CreationDateTime 350560 attribute is a GLOBAL_DateTime 350564 data type. The CreationDateTime 350560 attribute has a cardinality of 0 . . . 1 350562 meaning that for each instance of the Text 350518 entity there may be one CreationDateTime 350560 attribute. The TextContent 350566 entity has a cardinality of 0 . . . 1 350568 meaning that for each instance of the Text 350518 entity there may be one TextContent 350566 entity. The TextContent 350566 entity includes various attributes, namely a TechnicalID 350572 and a Text 350578.

The TechnicalID 350572 attribute is an ObjectNodeTechnicalID 350576 data type. The TechnicalID 350572 attribute has a cardinality of 0 . . . 1 350574 meaning that for each instance of the TextContent 350566 entity there may be one TechnicalID 350572 attribute.

The Text 350578 attribute is a Text 350582 data type. The Text 350578 attribute has a cardinality of 0 . . . 1 350580 meaning that for each instance of the TextContent 350566 entity there may be one Text 350578 attribute.

The ProductionBillOfMaterialVariantHandover 350584 node element grouping is a ProductDesignVersionHierarchyByElementsResponseProductionBillOfMaterialVariantHandover 350590 data type. The ProductionBillOfMaterialVariantHandover 350584 node element grouping includes a ProductionBillOfMaterialVariantHandover 350586 entity.

The ProductionBillOfMaterialVariantHandover 350586 entity has a cardinality of 0 . . . N 350588 meaning that for each instance of the ProductionBillOfMaterialVariantHandover 350584 node element grouping there may be one or more ProductionBillOfMaterialVariantHandover 350586 entities. The ProductionBillOfMaterialVariantHandover 350586 entity includes various attributes, namely an UUID 350592, a ProductDesignVersionUUID 350598, a ProductDesignVersionID 350604, an EngineeringChangeOrderUUID 350610, an EngineeringChangeOrderID 350616, a ProductionBillOfMaterialVariantUUID 350622 and a SystemAdministrativeData 350646. The ProductionBillOfMaterialVariantHandover 350586 entity includes various subordinate entities, namely a ProductionBillOfMaterialVariantKey 350628, a CreationIdentity 350652, a LastChangeIdentity 350670, an EngineeringChangeOrderDescription 350688, a ProductionBillOfMaterialVariantDescription 350700 and a ProductionBillOfMateriaIDescription 350712.

The UUID 350592 attribute is an UUID 350596 data type. The UUID 350592 attribute has a cardinality of 0 . . . 1 350594 meaning that for each instance of the ProductionBillOfMaterialVariantHandover 350586 entity there may be one UUID 350592 attribute.

The ProductDesignVersionUUID 350598 attribute is an UUID 350602 data type. The ProductDesignVersionUUID 350598 attribute has a cardinality of 0 . . . 1 350600 meaning that for each instance of the ProductionBillOfMaterialVariantHandover 350586 entity there may be one ProductDesignVersionUUID 350598 attribute.

The ProductDesignVersionID 350604 attribute is a VersionID 350608 data type. The ProductDesignVersionID 350604 attribute has a cardinality of 0 . . . 1 350606 meaning that for each instance of the ProductionBillOfMaterialVariantHandover 350586 entity there may be one ProductDesignVersionID 350604 attribute.

The EngineeringChangeOrderUUID 350610 attribute is an UUID 350614 data type. The EngineeringChangeOrderUUID 350610 attribute has a cardinality of 0 . . . 1 350612 meaning that for each instance of the ProductionBillOfMaterialVariantHandover 350586 entity there may be one EngineeringChangeOrderUUID 350610 attribute. The EngineeringChangeOrderID 350616 attribute is an EngineeringChangeOrderID 350620 data type. The EngineeringChangeOrderID 350616 attribute has a cardinality of 0 . . . 1 350618 meaning that for each instance of the ProductionBillOfMaterialVariantHandover 350586 entity there may be one EngineeringChangeOrderID 350616 attribute.

The ProductionBillOfMaterialVariantUUID 350622 attribute is an UUID 350626 data type. The ProductionBillOfMaterialVariantUUID 350622 attribute has a cardinality of 0 . . . 1 350624 meaning that for each instance of the ProductionBillOfMaterialVariantHandover 350586 entity there may be one ProductionBillOfMaterialVariantUUID 350622 attribute.

The SystemAdministrativeData 350646 attribute is a SystemAdministrativeData 350650 data type. The SystemAdministrativeData 350646 attribute has a cardinality of 0 . . . 1 350648 meaning that for each instance of the ProductionBillOfMaterialVariantHandover 350586 entity there may be one SystemAdministrativeData 350646 attribute.

The ProductionBillOfMaterialVariantKey 350628 entity has a cardinality of 0 . . . 1 350630 meaning that for each instance of the ProductionBillOfMaterialVariantHandover 350586 entity there may be one ProductionBillOfMaterialVariantKey 350628 entity. The ProductionBillOfMaterialVariantKey 350628 entity includes various attributes, namely a BillOfMaterialVariantID 350634 and a BillOfMaterialID 350640.

The BillOfMaterialVariantID 350634 attribute is a BillOfMaterialVariantID 350638 data type. The BillOfMaterialVariantID 350634 attribute has a cardinality of 0 . . . 1 350636 meaning that for each instance of the ProductionBillOfMaterialVariantKey 350628 entity there may be one BillOfMaterialVariantID 350634 attribute.

The BillOfMaterialID 350640 attribute is a BillOfMaterialID 350644 data type. The BillOfMaterialID 350640 attribute has a cardinality of 0 . . . 1 350642 meaning that for each instance of the ProductionBillOfMaterialVariantKey 350628 entity there may be one BillOfMaterialID 350640 attribute.

The CreationIdentity 350652 entity has a cardinality of 1 350654 meaning that for each instance of the ProductionBillOfMaterialVariantHandover 350586 entity there is one CreationIdentity 350652 entity. The CreationIdentity 350652 entity includes various attributes, namely a PersonNameGivenName 350658 and a PersonNameFamilyName 350664.

The PersonNameGivenName 350658 attribute is a LANGUAGEINDEPENDENT_MEDIUM_Name 350662 data type. The PersonNameGivenName 350658 attribute has a cardinality of 1 350660 meaning that for each instance of the CreationIdentity 350652 entity there is one PersonNameGivenName 350658 attribute.

The PersonNameFamilyName 350664 attribute is a LANGUAGEINDEPENDENT_MEDIUM_Name 350668 data type. The PersonNameFamilyName 350664 attribute has a cardinality of 1 350666 meaning that for each instance of the CreationIdentity 350652 entity there is one PersonNameFamilyName 350664 attribute.

The LastChangeIdentity 350670 entity has a cardinality of 1 350672 meaning that for each instance of the ProductionBillOfMaterialVariantHandover 350586 entity there is one LastChangeIdentity 350670 entity. The LastChangeIdentity 350670 entity includes various attributes, namely a PersonNameGivenName 350676 and a PersonNameFamilyName 350682.

The PersonNameGivenName 350676 attribute is a LANGUAGEINDEPENDENT_MEDIUM_Name 350680 data type. The PersonNameGivenName 350676 attribute has a cardinality of 1 350678 meaning that for each instance of the LastChangeIdentity 350670 entity there is one PersonNameGivenName 350676 attribute.

The PersonNameFamilyName 350682 attribute is a LANGUAGEINDEPENDENT_MEDIUM_Name 350686 data type. The PersonNameFamilyName 350682 attribute has a cardinality of 1 350684 meaning that for each instance of the LastChangeIdentity 350670 entity there is one PersonNameFamilyName 350682 attribute.

The EngineeringChangeOrderDescription 350688 entity has a cardinality of 0 . . . N 350690 meaning that for each instance of the ProductionBillOfMaterialVariantHandover 350586 entity there may be one or more EngineeringChangeOrderDescription 350688 entities. The EngineeringChangeOrderDescription 350688 entity includes a Description 350694 attribute.

The Description 350694 attribute is a SHORT_Description 350698 data type. The Description 350694 attribute has a cardinality of 0 . . . 1 350696 meaning that for each instance of the EngineeringChangeOrderDescription 350688 entity there may be one Description 350694 attribute.

The ProductionBillOfMaterialVariantDescription 350700 entity has a cardinality of 0 . . . N 350702 meaning that for each instance of the ProductionBillOfMaterialVariantHandover 350586 entity there may be one or more ProductionBillOfMaterialVariantDescription 350700 entities. The ProductionBillOfMaterialVariantDescription 350700 entity includes a Description 350706 attribute.

The Description 350706 attribute is a MEDIUM_Description 350710 data type. The Description 350706 attribute has a cardinality of 0 . . . 1 350708 meaning that for each instance of the ProductionBillOfMaterialVariantDescription 350700 entity there may be one Description 350706 attribute.

The ProductionBillOfMateriaIDescription 350712 entity has a cardinality of 0 . . . N 350714 meaning that for each instance of the ProductionBillOfMaterialVariantHandover 350586 entity there may be one or more ProductionBillOfMateriaIDescription 350712 entities. The ProductionBillOfMateriaIDescription 350712 entity includes a Description 350718 attribute.

The Description 350718 attribute is a MEDIUM_Description 350722 data type. The Description 350718 attribute has a cardinality of 0 . . . 1 350720 meaning that for each instance of the ProductionBillOfMateriaIDescription 350712 entity there may be one Description 350718 attribute.

The Version 350724 node element grouping is a ProductDesignVersionHierarchyByElementsResponseProductDesignVersion 350730 data type. The Version 350724 node element grouping includes a Version 350726 entity. The Version 350724 node element grouping includes various node element groupings, namely a Component 351398 and a ProductAssignment 351826.

The Version 350726 entity has a cardinality of 0 . . . N 350728 meaning that for each instance of the Version 350724 node element grouping there may be one or more Version 350726 entities. The Version 350726 entity includes various attributes, namely an UUID 350732, an ID 350738, a Name 350744, a ManuallyCreatedIndicator 350768, an AssemblyIndicator 350774, a PredecessorVersionUUID 350780, a BaseQuantity 350828, a BaseQuantityTypeCode 350834, a BaseQuantityTypeName 350840, a ProposedProcurementMethodCode 350846, a ProposedProcurementMethodName 350852, a ValidityStartDate 350858, an ActivationDate 350864, an ActivationTime 350870, an EngineeringDesignVersionStatusName 350876, an EngineeringDesignVersionReleaseDate 350882, an EngineeringDesignVersionResponsibleEngineerPersonGivenName 350888, an EngineeringDesignVersionResponsibleEngineerPersonFamilyName 350894, an EngineeringDesignVersionReplicationCancelledIndicator 350900, an EngineeringDesignVersionPrimaryViewableCreationDateTime 350906, an EngineeringDesignChangeOrderID 350912, an ApplicationLogUUID 350918, an EngineeringDesignVersionCreationDateTime 350924, an EngineeringDesignVersionLastChangeDateTime 350930 and a SystemAdministrativeData 350936. The Version 350726 entity includes various subordinate entities, namely an EngineeringDesignVersionIdentification 350750, a PredecessorVersionEngineeringDesignVersionIdentification 350786, a Status 350942, a CreationIdentity 351032, a LastChangeIdentity 351050, a Description 351068, an AttachmentFolder 351080 and a TextCollection 351320.

The UUID 350732 attribute is an UUID 350736 data type. The UUID 350732 attribute has a cardinality of 0 . . . 1 350734 meaning that for each instance of the Version 350726 entity there may be one UUID 350732 attribute.

The ID 350738 attribute is a VersionID 350742 data type. The ID 350738 attribute has a cardinality of 0 . . . 1 350740 meaning that for each instance of the Version 350726 entity there may be one ID 350738 attribute.

The Name 350744 attribute is a LANGUAGEINDEPENDENT_MEDIUM_Name 350748 data type. The Name 350744 attribute has a cardinality of 0 . . . 1 350746 meaning that for each instance of the Version 350726 entity there may be one Name 350744 attribute.

The ManuallyCreatedIndicator 350768 attribute is an Indicator 350772 data type. The ManuallyCreatedIndicator 350768 attribute has a cardinality of 0 . . . 1 350770 meaning that for each instance of the Version 350726 entity there may be one ManuallyCreatedIndicator 350768 attribute.

The AssemblyIndicator 350774 attribute is an Indicator 350778 data type. The AssemblyIndicator 350774 attribute has a cardinality of 0 . . . 1 350776 meaning that for each instance of the Version 350726 entity there may be one AssemblyIndicator 350774 attribute.

The PredecessorVersionUUID 350780 attribute is an UUID 350784 data type. The PredecessorVersionUUID 350780 attribute has a cardinality of 0 . . . 1 350782 meaning that for each instance of the Version 350726 entity there may be one PredecessorVersionUUID 350780 attribute.

The BaseQuantity 350828 attribute is a POSITIVE_Quantity 350832 data type. The BaseQuantity 350828 attribute has a cardinality of 0 . . . 1 350830 meaning that for each instance of the Version 350726 entity there may be one BaseQuantity 350828 attribute.

The BaseQuantityTypeCode 350834 attribute is a QuantityTypeCode 350838 data type. The BaseQuantityTypeCode 350834 attribute has a cardinality of 0 . . . 1 350836 meaning that for each instance of the Version 350726 entity there may be one BaseQuantityTypeCode 350834 attribute.

The BaseQuantityTypeName 350840 attribute is a LANGUAGEINDEPENDENT_LONG_Name 350844 data type. The BaseQuantityTypeName 350840 attribute has a cardinality of 0 . . . 1 350842 meaning that for each instance of the Version 350726 entity there may be one BaseQuantityTypeName 350840 attribute.

The ProposedProcurementMethodCode 350846 attribute is a ProcurementMethodCode 350850 data type. The ProposedProcurementMethodCode 350846 attribute has a cardinality of 0 . . . 1 350848 meaning that for each instance of the Version 350726 entity there may be one ProposedProcurementMethodCode 350846 attribute.

The ProposedProcurementMethodName 350852 attribute is a LANGUAGEINDEPENDENT_LONG_Name 350856 data type. The ProposedProcurementMethodName 350852 attribute has a cardinality of 0 . . . 1 350854 meaning that for each instance of the Version 350726 entity there may be one ProposedProcurementMethodName 350852 attribute.

The ValidityStartDate 350858 attribute is a Date 350862 data type. The ValidityStartDate 350858 attribute has a cardinality of 0 . . . 1 350860 meaning that for each instance of the Version 350726 entity there may be one ValidityStartDate 350858 attribute.

The ActivationDate 350864 attribute is a Date 350868 data type. The ActivationDate 350864 attribute has a cardinality of 0 . . . 1 350866 meaning that for each instance of the Version 350726 entity there may be one ActivationDate 350864 attribute.

The ActivationTime 350870 attribute is a Time 350874 data type. The ActivationTime 350870 attribute has a cardinality of 0 . . . 1 350872 meaning that for each instance of the Version 350726 entity there may be one ActivationTime 350870 attribute.

The EngineeringDesignVersionStatusName 350876 attribute is a LANGUAGEINDEPENDENT_MEDIUM_Name 350880 data type. The EngineeringDesignVersionStatusName 350876 attribute has a cardinality of 0 . . . 1 350878 meaning that for each instance of the Version 350726 entity there may be one EngineeringDesignVersionStatusName 350876 attribute.

The EngineeringDesignVersionReleaseDate 350882 attribute is a Date 350886 data type. The EngineeringDesignVersionReleaseDate 350882 attribute has a cardinality of 0 . . . 1 350884 meaning that for each instance of the Version 350726 entity there may be one EngineeringDesignVersionReleaseDate 350882 attribute. The EngineeringDesignVersionResponsibleEngineerPersonGivenName 350888 attribute is a LANGUAGEINDEPENDENT_MEDIUM_Name 350892 data type. The EngineeringDesignVersionResponsibleEngineerPersonGivenName 350888 attribute has a cardinality of 0 . . . 1 350890 meaning that for each instance of the Version 350726 entity there may be one EngineeringDesignVersionResponsibleEngineerPersonGivenName 350888 attribute.

The EngineeringDesignVersionResponsibleEngineerPersonFamilyName 350894 attribute is a LANGUAGEINDEPENDENT_MEDIUM_Name 350898 data type. The EngineeringDesignVersionResponsibleEngineerPersonFamilyName 350894 attribute has a cardinality of 0 . . . 1 350896 meaning that for each instance of the Version 350726 entity there may be one EngineeringDesignVersionResponsibleEngineerPersonFamilyName 350894 attribute.

The EngineeringDesignVersionReplicationCancelledIndicator 350900 attribute is an Indicator 350904 data type. The EngineeringDesignVersionReplicationCancelledIndicator 350900 attribute has a cardinality of 0 . . . 1 350902 meaning that for each instance of the Version 350726 entity there may be one EngineeringDesignVersionReplicationCancelledIndicator 350900 attribute.

The EngineeringDesignVersionPrimaryViewableCreationDateTime 350906 attribute is a GLOBAL_DateTime 350910 data type. The EngineeringDesignVersionPrimaryViewableCreationDateTime 350906 attribute has a cardinality of 0 . . . 1 350908 meaning that for each instance of the Version 350726 entity there may be one EngineeringDesignVersionPrimaryViewableCreationDateTime 350906 attribute.

The EngineeringDesignChangeOrderID 350912 attribute is an EngineeringDesignChangeOrderID 350916 data type. The EngineeringDesignChangeOrderID 350912 attribute has a cardinality of 0 . . . 1 350914 meaning that for each instance of the Version 350726 entity there may be one EngineeringDesignChangeOrderID 350912 attribute.

The ApplicationLogUUID 350918 attribute is an UUID 350922 data type. The ApplicationLogUUID 350918 attribute has a cardinality of 0 . . . 1 350920 meaning that for each instance of the Version 350726 entity there may be one ApplicationLogUUID 350918 attribute.

The EngineeringDesignVersionCreationDateTime 350924 attribute is a GLOBAL_DateTime 350928 data type. The EngineeringDesignVersionCreationDateTime 350924 attribute has a cardinality of 0 . . . 1 350926 meaning that for each instance of the Version 350726 entity there may be one EngineeringDesignVersionCreationDateTime 350924 attribute.

The EngineeringDesignVersionLastChangeDateTime 350930 attribute is a GLOBAL_DateTime 350934 data type. The EngineeringDesignVersionLastChangeDateTime 350930 attribute has a cardinality of 0 . . . 1 350932 meaning that for each instance of the Version 350726 entity there may be one EngineeringDesignVersionLastChangeDateTime 350930 attribute.

The SystemAdministrativeData 350936 attribute is a SystemAdministrativeData 350940 data type. The SystemAdministrativeData 350936 attribute has a cardinality of 0 . . . 1 350938 meaning that for each instance of the Version 350726 entity there may be one SystemAdministrativeData 350936 attribute.

The EngineeringDesignVersionIdentification 350750 entity has a cardinality of 0 . . . 1 350752 meaning that for each instance of the Version 350726 entity there may be one EngineeringDesignVersionIdentification 350750 entity. The EngineeringDesignVersionIdentification 350750 entity includes various attributes, namely an EngineeringDesignVersionID 350756 and an EngineeringDesignVersionInternalID 350762.

The EngineeringDesignVersionID 350756 attribute is an EngineeringDesignVersionID 350760 data type. The EngineeringDesignVersionID 350756 attribute has a cardinality of 0 . . . 1 350758 meaning that for each instance of the EngineeringDesignVersionIdentification 350750 entity there may be one EngineeringDesignVersionID 350756 attribute.

The EngineeringDesignVersionInternalID 350762 attribute is an EngineeringDesignVersionInternalID 350766 data type. The EngineeringDesignVersionInternalID 350762 attribute has a cardinality of 0 . . . 1 350764 meaning that for each instance of the EngineeringDesignVersionIdentification 350750 entity there may be one EngineeringDesignVersionInternalID 350762 attribute.

The PredecessorVersionEngineeringDesignVersionIdentification 350786 entity has a cardinality of 0 . . . 1 350788 meaning that for each instance of the Version 350726 entity there may be one PredecessorVersionEngineeringDesignVersionIdentification 350786 entity. The PredecessorVersionEngineeringDesignVersionIdentification 350786 entity includes various attributes, namely an EngineeringDesignBusinessSystemID 350792, an EngineeringDesignBusinessSystemName 350798, an EngineeringDesignID 350804, an EngineeringDesignInternalID 350810, an EngineeringDesignVersionID 350816 and an EngineeringDesignVersionInternalID 350822.

The EngineeringDesignBusinessSystemID 350792 attribute is a BusinessSystemID 350796 data type. The EngineeringDesignBusinessSystemID 350792 attribute has a cardinality of 0 . . . 1 350794 meaning that for each instance of the PredecessorVersionEngineeringDesignVersionIdentification 350786 entity there may be one EngineeringDesignBusinessSystemID 350792 attribute.

The EngineeringDesignBusinessSystemName 350798 attribute is a LANGUAGEINDEPENDENT_LONG_Name 350802 data type. The EngineeringDesignBusinessSystemName 350798 attribute has a cardinality of 0 . . . 1 350800 meaning that for each instance of the PredecessorVersionEngineeringDesignVersionIdentification 350786 entity there may be one EngineeringDesignBusinessSystemName 350798 attribute.

The EngineeringDesignID 350804 attribute is an EngineeringDesignID 350808 data type. The EngineeringDesignID 350804 attribute has a cardinality of 0 . . . 1 350806 meaning that for each instance of the PredecessorVersionEngineeringDesignVersionIdentification 350786 entity there may be one EngineeringDesignID 350804 attribute.

The EngineeringDesignInternalID 350810 attribute is an EngineeringDesignInternalID 350814 data type. The EngineeringDesignInternalID 350810 attribute has a cardinality of 0 . . . 1 350812 meaning that for each instance of the PredecessorVersionEngineeringDesignVersionIdentification 350786 entity there may be one EngineeringDesignInternalID 350810 attribute.

The EngineeringDesignVersionID 350816 attribute is an EngineeringDesignVersionID 350820 data type. The EngineeringDesignVersionID 350816 attribute has a cardinality of 0 . . . 1 350818 meaning that for each instance of the PredecessorVersionEngineeringDesignVersionIdentification 350786 entity there may be one EngineeringDesignVersionID 350816 attribute.

The EngineeringDesignVersionInternalID 350822 attribute is an EngineeringDesignVersionInternalID 350826 data type. The EngineeringDesignVersionInternalID 350822 attribute has a cardinality of 0 . . . 1 350824 meaning that for each instance of the PredecessorVersionEngineeringDesignVersionIdentification 350786 entity there may be one EngineeringDesignVersionInternalID 350822 attribute. The Status 350942 entity has a cardinality of 0 . . . 1 350944 meaning that for each instance of the Version 350726 entity there may be one Status 350942 entity. The Status 350942 entity includes various attributes, namely a LifeCycleStatusCode 350948, a LifeCycleStatusName 350954, an ObsolescenceStatusCode 350960, an ObsolescenceStatusName 350966, a BlockingStatusCode 350972, a BlockingStatusName 350978, a ReviewProcessingStatusCode 350984, a ReviewProcessingStatusName 350990, an ActivationStatusCode 350996, an ActivationStatusName 351002, an EngineeringDesignVersionReleaseStatusCode 351008, an EngineeringDesignVersionReleaseStatusName 351014, a ConsistencyStatusCode 351020 and a ConsistencyStatusName 351026.

The LifeCycleStatusCode 350948 attribute is a ProductDesignVersionLifeCycleStatusCode 350952 data type. The LifeCycleStatusCode 350948 attribute has a cardinality of 0 . . . 1 350950 meaning that for each instance of the Status 350942 entity there may be one LifeCycleStatusCode 350948 attribute.

The LifeCycleStatusName 350954 attribute is a LANGUAGEINDEPENDENT_LONG_Name 350958 data type. The LifeCycleStatusName 350954 attribute has a cardinality of 0 . . . 1 350956 meaning that for each instance of the Status 350942 entity there may be one LifeCycleStatusName 350954 attribute.

The ObsolescenceStatusCode 350960 attribute is an ObsolescenceStatusCode 350964 data type. The ObsolescenceStatusCode 350960 attribute has a cardinality of 0 . . . 1 350962 meaning that for each instance of the Status 350942 entity there may be one ObsolescenceStatusCode 350960 attribute.

The ObsolescenceStatusName 350966 attribute is a LANGUAGEINDEPENDENT_LONG_Name 350970 data type. The ObsolescenceStatusName 350966 attribute has a cardinality of 0 . . . 1 350968 meaning that for each instance of the Status 350942 entity there may be one ObsolescenceStatusName 350966 attribute.

The BlockingStatusCode 350972 attribute is a NOTBLOCKEDBLOCKED_BlockingStatusCode 350976 data type. The BlockingStatusCode 350972 attribute has a cardinality of 0 . . . 1 350974 meaning that for each instance of the Status 350942 entity there may be one BlockingStatusCode 350972 attribute.

The BlockingStatusName 350978 attribute is a LANGUAGEINDEPENDENT_LONG_Name 350982 data type. The BlockingStatusName 350978 attribute has a cardinality of 0 . . . 1 350980 meaning that for each instance of the Status 350942 entity there may be one BlockingStatusName 350978 attribute.

The ReviewProcessingStatusCode 350984 attribute is a ProcessingStatusCode 350988 data type. The ReviewProcessingStatusCode 350984 attribute has a cardinality of 0 . . . 1 350986 meaning that for each instance of the Status 350942 entity there may be one ReviewProcessingStatusCode 350984 attribute.

The ReviewProcessingStatusName 350990 attribute is a LANGUAGEINDEPENDENT_LONG_Name 350994 data type. The ReviewProcessingStatusName 350990 attribute has a cardinality of 0 . . . 1 350992 meaning that for each instance of the Status 350942 entity there may be one ReviewProcessingStatusName 350990 attribute.

The ActivationStatusCode 350996 attribute is an INACTIVEACTIVE_ActivationStatusCode 351000 data type. The ActivationStatusCode 350996 attribute has a cardinality of 0 . . . 1 350998 meaning that for each instance of the Status 350942 entity there may be one ActivationStatusCode 350996 attribute.

The ActivationStatusName 351002 attribute is a LANGUAGEINDEPENDENT_LONG_Name 351006 data type. The ActivationStatusName 351002 attribute has a cardinality of 0 . . . 1 351004 meaning that for each instance of the Status 350942 entity there may be one ActivationStatusName 351002 attribute.

The EngineeringDesignVersionReleaseStatusCode 351008 attribute is an EngineeringDesignVersionReleaseStatusCode 351012 data type. The EngineeringDesignVersionReleaseStatusCode 351008 attribute has a cardinality of 0 . . . 1 351010 meaning that for each instance of the Status 350942 entity there may be one EngineeringDesignVersionReleaseStatusCode 351008 attribute.

The EngineeringDesignVersionReleaseStatusName 351014 attribute is a LANGUAGEINDEPENDENT_LONG_Name 351018 data type. The EngineeringDesignVersionReleaseStatusName 351014 attribute has a cardinality of 0 . . . 1 351016 meaning that for each instance of the Status 350942 entity there may be one EngineeringDesignVersionReleaseStatusName 351014 attribute.

The ConsistencyStatusCode 351020 attribute is a ConsistencyStatusCode 351024 data type. The ConsistencyStatusCode 351020 attribute has a cardinality of 0 . . . 1 351022 meaning that for each instance of the Status 350942 entity there may be one ConsistencyStatusCode 351020 attribute.

The ConsistencyStatusName 351026 attribute is a LANGUAGEINDEPENDENT_LONG_Name 351030 data type. The ConsistencyStatusName 351026 attribute has a cardinality of 0 . . . 1 351028 meaning that for each instance of the Status 350942 entity there may be one ConsistencyStatusName 351026 attribute.

The CreationIdentity 351032 entity has a cardinality of 0 . . . 1 351034 meaning that for each instance of the Version 350726 entity there may be one CreationIdentity 351032 entity. The CreationIdentity 351032 entity includes various attributes, namely a PersonNameGivenName 351038 and a PersonNameFamilyName 351044.

The PersonNameGivenName 351038 attribute is a LANGUAGEINDEPENDENT_MEDIUM_Name 351042 data type. The PersonNameGivenName 351038 attribute has a cardinality of 1 351040 meaning that for each instance of the CreationIdentity 351032 entity there is one PersonNameGivenName 351038 attribute.

The PersonNameFamilyName 351044 attribute is a LANGUAGEINDEPENDENT_MEDIUM_Name 351048 data type. The PersonNameFamilyName 351044 attribute has a cardinality of 1 351046 meaning that for each instance of the CreationIdentity 351032 entity there is one PersonNameFamilyName 351044 attribute.

The LastChangeIdentity 351050 entity has a cardinality of 0 . . . 1 351052 meaning that for each instance of the Version 350726 entity there may be one LastChangeIdentity 351050 entity. The LastChangeIdentity 351050 entity includes various attributes, namely a PersonNameGivenName 351056 and a PersonNameFamilyName 351062.

The PersonNameGivenName 351056 attribute is a LANGUAGEINDEPENDENT_MEDIUM_Name 351060 data type. The PersonNameGivenName 351056 attribute has a cardinality of 1 351058 meaning that for each instance of the LastChangeIdentity 351050 entity there is one PersonNameGivenName 351056 attribute.

The PersonNameFamilyName 351062 attribute is a LANGUAGEINDEPENDENT_MEDIUM_Name 351066 data type. The PersonNameFamilyName 351062 attribute has a cardinality of 1 351064 meaning that for each instance of the LastChangeIdentity 351050 entity there is one PersonNameFamilyName 351062 attribute.

The Description 351068 entity has a cardinality of 0 . . . N 351070 meaning that for each instance of the Version 350726 entity there may be one or more Description 351068 entities. The Description 351068 entity includes a Description 351074 attribute.

The Description 351074 attribute is a MEDIUM_Description 351078 data type. The Description 351074 attribute has a cardinality of 0 . . . 1 351076 meaning that for each instance of the Description 351068 entity there may be one Description 351074 attribute.

The AttachmentFolder 351080 entity has a cardinality of 0 . . . 1 351082 meaning that for each instance of the Version 350726 entity there may be one AttachmentFolder 351080 entity. The AttachmentFolder 351080 entity includes an UUID 351086 attribute. The AttachmentFolder 351080 entity includes a Document 351092 subordinate entity.

The UUID 351086 attribute is an UUID 351090 data type. The UUID 351086 attribute has a cardinality of 0 . . . 1 351088 meaning that for each instance of the AttachmentFolder 351080 entity there may be one UUID 351086 attribute.

The Document 351092 entity has a cardinality of 0 . . . N 351094 meaning that for each instance of the AttachmentFolder 351080 entity there may be one or more Document 351092 entities. The Document 351092 entity includes various attributes, namely an UUID 351098, a VersionID 351104, a SystemAdministrativeData 351110, a LinkInternalIndicator 351116, a CheckedOutIndicator 351122, a VisibleIndicator 351128, a VersioningEnabledIndicator 351134, a CategoryCode 351140, a CategoryName 351146, a TypeCode 351152, a TypeName 351158, a MIMECode 351164, a MIMEName 351170, a PathName 351176, a Name 351182, an AlternativeName 351188, an InternalLinkUUID 351194, a Description 351200, an ExternalLinkWebURI 351206, a FileContentURI 351212 and a FilesizeMeasure 351218. The Document 351092 entity includes a Property 351224 subordinate entity.

The UUID 351098 attribute is an UUID 351102 data type. The UUID 351098 attribute has a cardinality of 0 . . . 1 351100 meaning that for each instance of the Document 351092 entity there may be one UUID 351098 attribute.

The VersionID 351104 attribute is a VersionID 351108 data type. The VersionID 351104 attribute has a cardinality of 0 . . . 1 351106 meaning that for each instance of the Document 351092 entity there may be one VersionID 351104 attribute.

The SystemAdministrativeData 351110 attribute is a SystemAdministrativeData 351114 data type. The SystemAdministrativeData 351110 attribute has a cardinality of 0 . . . 1 351112 meaning that for each instance of the Document 351092 entity there may be one SystemAdministrativeData 351110 attribute.

The LinkInternalIndicator 351116 attribute is an Indicator 351120 data type. The LinkInternalIndicator 351116 attribute has a cardinality of 0 . . . 1 351118 meaning that for each instance of the Document 351092 entity there may be one LinkInternalIndicator 351116 attribute.

The CheckedOutIndicator 351122 attribute is an Indicator 351126 data type. The CheckedOutIndicator 351122 attribute has a cardinality of 0 . . . 1 351124 meaning that for each instance of the Document 351092 entity there may be one CheckedOutIndicator 351122 attribute.

The VisibleIndicator 351128 attribute is an Indicator 351132 data type. The VisibleIndicator 351128 attribute has a cardinality of 0 . . . 1 351130 meaning that for each instance of the Document 351092 entity there may be one VisibleIndicator 351128 attribute.

The VersioningEnabledIndicator 351134 attribute is an Indicator 351138 data type. The VersioningEnabledIndicator 351134 attribute has a cardinality of 0 . . . 1 351136 meaning that for each instance of the Document 351092 entity there may be one VersioningEnabledIndicator 351134 attribute.

The CategoryCode 351140 attribute is a DocumentCategoryCode 351144 data type. The CategoryCode 351140 attribute has a cardinality of 0 . . . 1 351142 meaning that for each instance of the Document 351092 entity there may be one CategoryCode 351140 attribute.

The CategoryName 351146 attribute is a LANGUAGEINDEPENDENT_LONG_Name 351150 data type. The CategoryName 351146 attribute has a cardinality of 0 . . . 1 351148 meaning that for each instance of the Document 351092 entity there may be one CategoryName 351146 attribute.

The TypeCode 351152 attribute is a DocumentTypeCode 351156 data type. The TypeCode 351152 attribute has a cardinality of 0 . . . 1 351154 meaning that for each instance of the Document 351092 entity there may be one TypeCode 351152 attribute.

The TypeName 351158 attribute is a LANGUAGEINDEPENDENT_LONG_Name 351162 data type. The TypeName 351158 attribute has a cardinality of 0 . . . 1 351160 meaning that for each instance of the Document 351092 entity there may be one TypeName 351158 attribute.

The MIMECode 351164 attribute is a MIMECode 351168 data type. The MIMECode 351164 attribute has a cardinality of 0 . . . 1 351166 meaning that for each instance of the Document 351092 entity there may be one MIMECode 351164 attribute.

The MIMEName 351170 attribute is a LANGUAGEINDEPENDENT_LONG_Name 351174 data type. The MIMEName 351170 attribute has a cardinality of 0 . . . 1 351172 meaning that for each instance of the Document 351092 entity there may be one MIMEName 351170 attribute.

The PathName 351176 attribute is a LANGUAGEINDEPENDENT_Name 351180 data type. The PathName 351176 attribute has a cardinality of 0 . . . 1 351178 meaning that for each instance of the Document 351092 entity there may be one PathName 351176 attribute.

The Name 351182 attribute is a LANGUAGEINDEPENDENT_Name 351186 data type. The Name 351182 attribute has a cardinality of 0 . . . 1 351184 meaning that for each instance of the Document 351092 entity there may be one Name 351182 attribute.

The AlternativeName 351188 attribute is a LANGUAGEINDEPENDENT_Name 351192 data type. The AlternativeName 351188 attribute has a cardinality of 0 . . . 1 351190 meaning that for each instance of the Document 351092 entity there may be one AlternativeName 351188 attribute.

The InternalLinkUUID 351194 attribute is an UUID 351198 data type. The InternalLinkUUID 351194 attribute has a cardinality of 0 . . . 1 351196 meaning that for each instance of the Document 351092 entity there may be one InternalLinkUUID 351194 attribute.

The Description 351200 attribute is a Description 351204 data type. The Description 351200 attribute has a cardinality of 0 . . . 1 351202 meaning that for each instance of the Document 351092 entity there may be one Description 351200 attribute.

The ExternalLinkWebURI 351206 attribute is a WebURI 351210 data type. The ExternalLinkWebURI 351206 attribute has a cardinality of 0 . . . 1 351208 meaning that for each instance of the Document 351092 entity there may be one ExternalLinkWebURI 351206 attribute.

The FileContentURI 351212 attribute is an URI 351216 data type. The FileContentURI 351212 attribute has a cardinality of 0 . . . 1 351214 meaning that for each instance of the Document 351092 entity there may be one FileContentURI 351212 attribute.

The FilesizeMeasure 351218 attribute is a Measure 351222 data type. The FilesizeMeasure 351218 attribute has a cardinality of 0 . . . 1 351220 meaning that for each instance of the Document 351092 entity there may be one FilesizeMeasure 351218 attribute.

The Property 351224 entity has a cardinality of 0 . . . N 351226 meaning that for each instance of the Document 351092 entity there may be one or more Property 351224 entities. The Property 351224 entity includes various attributes, namely a TechnicalID 351230, a Name 351236, a DataTypeFormatCode 351242, a DataTypeFormatName 351248, a VisibleIndicator 351254, a ChangeAllowedIndicator 351260, a MultipleValueIndicator 351266, a NamespaceURI 351272 and a Description 351278. The Property 351224 entity includes a PropertyValue 351284 subordinate entity.

The TechnicalID 351230 attribute is an ObjectNodeTechnicalID 351234 data type. The TechnicalID 351230 attribute has a cardinality of 0 . . . 1 351232 meaning that for each instance of the Property 351224 entity there may be one TechnicalID 351230 attribute.

The Name 351236 attribute is a LANGUAGEINDEPENDENT_Name 351240 data type. The Name 351236 attribute has a cardinality of 0 . . . 1 351238 meaning that for each instance of the Property 351224 entity there may be one Name 351236 attribute.

The DataTypeFormatCode 351242 attribute is a PropertyDataTypeFormatCode 351246 data type. The DataTypeFormatCode 351242 attribute has a cardinality of 0 . . . 1 351244 meaning that for each instance of the Property 351224 entity there may be one DataTypeFormatCode 351242 attribute.

The DataTypeFormatName 351248 attribute is a LANGUAGEINDEPENDENT_LONG_Name 351252 data type. The DataTypeFormatName 351248 attribute has a cardinality of 0 . . . 1 351250 meaning that for each instance of the Property 351224 entity there may be one DataTypeFormatName 351248 attribute.

The VisibleIndicator 351254 attribute is an Indicator 351258 data type. The VisibleIndicator 351254 attribute has a cardinality of 0 . . . 1 351256 meaning that for each instance of the Property 351224 entity there may be one VisibleIndicator 351254 attribute.

The ChangeAllowedIndicator 351260 attribute is an Indicator 351264 data type. The ChangeAllowedIndicator 351260 attribute has a cardinality of 0 . . . 1 351262 meaning that for each instance of the Property 351224 entity there may be one ChangeAllowedIndicator 351260 attribute.

The MultipleValueIndicator 351266 attribute is an Indicator 351270 data type. The MultipleValueIndicator 351266 attribute has a cardinality of 0 . . . 1 351268 meaning that for each instance of the Property 351224 entity there may be one MultipleValueIndicator 351266 attribute.

The NamespaceURI 351272 attribute is a NamespaceURI 351276 data type. The NamespaceURI 351272 attribute has a cardinality of 0 . . . 1 351274 meaning that for each instance of the Property 351224 entity there may be one NamespaceURI 351272 attribute.

The Description 351278 attribute is a Description 351282 data type. The Description 351278 attribute has a cardinality of 0 . . . 1 351280 meaning that for each instance of the Property 351224 entity there may be one Description 351278 attribute.

The PropertyValue 351284 entity has a cardinality of 0 . . . N 351286 meaning that for each instance of the Property 351224 entity there may be one or more PropertyValue 351284 entities. The PropertyValue 351284 entity includes various attributes, namely a TechnicalID 351290, a Text 351296, an Indicator 351302, a DateTime 351308 and an IntegerValue 351314.

The TechnicalID 351290 attribute is an ObjectNodeTechnicalID 351294 data type. The TechnicalID 351290 attribute has a cardinality of 0 . . . 1 351292 meaning that for each instance of the PropertyValue 351284 entity there may be one TechnicalID 351290 attribute.

The Text 351296 attribute is a LANGUAGEINDEPENDENT_Text 351300 data type. The Text 351296 attribute has a cardinality of 0 . . . 1 351298 meaning that for each instance of the PropertyValue 351284 entity there may be one Text 351296 attribute.

The Indicator 351302 attribute is an Indicator 351306 data type. The Indicator 351302 attribute has a cardinality of 0 . . . 1 351304 meaning that for each instance of the PropertyValue 351284 entity there may be one Indicator 351302 attribute.

The DateTime 351308 attribute is a GLOBAL_DateTime 351312 data type. The DateTime 351308 attribute has a cardinality of 0 . . . 1 351310 meaning that for each instance of the PropertyValue 351284 entity there may be one DateTime 351308 attribute.

The IntegerValue 351314 attribute is an IntegerValue 351318 data type. The IntegerValue 351314 attribute has a cardinality of 0 . . . 1 351316 meaning that for each instance of the PropertyValue 351284 entity there may be one IntegerValue 351314 attribute.

The TextCollection 351320 entity has a cardinality of 0 . . . 1 351322 meaning that for each instance of the Version 350726 entity there may be one TextCollection 351320 entity. The TextCollection 351320 entity includes an UUID 351326 attribute. The TextCollection 351320 entity includes a Text 351332 subordinate entity.

The UUID 351326 attribute is an UUID 351330 data type. The UUID 351326 attribute has a cardinality of 0 . . . 1 351328 meaning that for each instance of the TextCollection 351320 entity there may be one UUID 351326 attribute.

The Text 351332 entity has a cardinality of 0 . . . N 351334 meaning that for each instance of the TextCollection 351320 entity there may be one or more Text 351332 entities. The Text 351332 entity includes various attributes, namely a TechnicalID 351338, a TypeCode 351344, a TypeName 351350, a LanguageCode 351356, a LanguageName 351362, a SystemAdministrativeData 351368 and a CreationDateTime 351374. The Text 351332 entity includes a TextContent 351380 subordinate entity.

The TechnicalID 351338 attribute is an ObjectNodeTechnicalID 351342 data type. The TechnicalID 351338 attribute has a cardinality of 0 . . . 1 351340 meaning that for each instance of the Text 351332 entity there may be one TechnicalID 351338 attribute.

The TypeCode 351344 attribute is a TextCollectionTextTypeCode 351348 data type. The TypeCode 351344 attribute has a cardinality of 0 . . . 1 351346 meaning that for each instance of the Text 351332 entity there may be one TypeCode 351344 attribute.

The TypeName 351350 attribute is a LANGUAGEINDEPENDENT_LONG_Name 351354 data type. The TypeName 351350 attribute has a cardinality of 0 . . . 1 351352 meaning that for each instance of the Text 351332 entity there may be one TypeName 351350 attribute.

The LanguageCode 351356 attribute is a LanguageCode 351360 data type. The LanguageCode 351356 attribute has a cardinality of 0 . . . 1 351358 meaning that for each instance of the Text 351332 entity there may be one LanguageCode 351356 attribute.

The LanguageName 351362 attribute is a LANGUAGEINDEPENDENT_LONG_Name 351366 data type. The LanguageName 351362 attribute has a cardinality of 0 . . . 1 351364 meaning that for each instance of the Text 351332 entity there may be one LanguageName 351362 attribute.

The SystemAdministrativeData 351368 attribute is a SystemAdministrativeData 351372 data type. The SystemAdministrativeData 351368 attribute has a cardinality of 0 . . . 1 351370 meaning that for each instance of the Text 351332 entity there may be one SystemAdministrativeData 351368 attribute.

The CreationDateTime 351374 attribute is a GLOBAL_DateTime 351378 data type. The CreationDateTime 351374 attribute has a cardinality of 0 . . . 1 351376 meaning that for each instance of the Text 351332 entity there may be one CreationDateTime 351374 attribute.

The TextContent 351380 entity has a cardinality of 0 . . . 1 351382 meaning that for each instance of the Text 351332 entity there may be one TextContent 351380 entity. The TextContent 351380 entity includes various attributes, namely a TechnicalID 351386 and a Text 351392.

The TechnicalID 351386 attribute is an ObjectNodeTechnicalID 351390 data type. The TechnicalID 351386 attribute has a cardinality of 0 . . . 1 351388 meaning that for each instance of the TextContent 351380 entity there may be one TechnicalID 351386 attribute. The Text 351392 attribute is a Text 351396 data type. The Text 351392 attribute has a cardinality of 0 . . . 1 351394 meaning that for each instance of the TextContent 351380 entity there may be one Text 351392 attribute.

The Component 351398 node element grouping is a ProductDesignVersionHierarchyByElementsResponseVersionComponent 351404 data type. The Component 351398 node element grouping includes a Component 351400 entity.

The Component 351400 entity has a cardinality of 0 . . . N 351402 meaning that for each instance of the Component 351398 node element grouping there may be one or more Component 351400 entities. The Component 351400 entity includes various attributes, namely an UUID 351406, a ProductDesignComponentID 351412, a BaseQuantity 351418, a BaseQuantityTypeCode 351424, a BaseQuantityTypeName 351430, a ProductDesignUUID 351436, a ProductDesignID 351442, a ProductDesignVersionUUID 351478 and a ProductDesignVersionID 351484. The Component 351400 entity includes various subordinate entities, namely a ProductDesignEngineeringDesignIdentification 351448, a ProductDesignVersionEngineeringDesignVersionIdentification 351490, an AttachmentFolder 351508 and a TextCollection 351748.

The UUID 351406 attribute is an UUID 351410 data type. The UUID 351406 attribute has a cardinality of 1 351408 meaning that for each instance of the Component 351400 entity there is one UUID 351406 attribute.

The ProductDesignComponentID 351412 attribute is a ProductDesignComponentID 351416 data type. The ProductDesignComponentID 351412 attribute has a cardinality of 1 351414 meaning that for each instance of the Component 351400 entity there is one ProductDesignComponentID 351412 attribute.

The BaseQuantity 351418 attribute is a POSITIVE_Quantity 351422 data type. The BaseQuantity 351418 attribute has a cardinality of 1 351420 meaning that for each instance of the Component 351400 entity there is one BaseQuantity 351418 attribute.

The BaseQuantityTypeCode 351424 attribute is a QuantityTypeCode 351428 data type. The BaseQuantityTypeCode 351424 attribute has a cardinality of 1 351426 meaning that for each instance of the Component 351400 entity there is one BaseQuantityTypeCode 351424 attribute.

The BaseQuantityTypeName 351430 attribute is a LANGUAGEINDEPENDENT_LONG_Name 351434 data type. The BaseQuantityTypeName 351430 attribute has a cardinality of 1 351432 meaning that for each instance of the Component 351400 entity there is one BaseQuantityTypeName 351430 attribute.

The ProductDesignUUID 351436 attribute is an UUID 351440 data type. The ProductDesignUUID 351436 attribute has a cardinality of 1 351438 meaning that for each instance of the Component 351400 entity there is one ProductDesignUUID 351436 attribute.

The ProductDesignID 351442 attribute is a ProductDesignID 351446 data type. The ProductDesignID 351442 attribute has a cardinality of 1 351444 meaning that for each instance of the Component 351400 entity there is one ProductDesignID 351442 attribute.

The ProductDesignVersionUUID 351478 attribute is an UUID 351482 data type. The ProductDesignVersionUUID 351478 attribute has a cardinality of 1 351480 meaning that for each instance of the Component 351400 entity there is one ProductDesignVersionUUID 351478 attribute.

The ProductDesignVersionID 351484 attribute is a VersionID 351488 data type. The ProductDesignVersionID 351484 attribute has a cardinality of 1 351486 meaning that for each instance of the Component 351400 entity there is one ProductDesignVersionID 351484 attribute.

The ProductDesignEngineeringDesignIdentification 351448 entity has a cardinality of 1 351450 meaning that for each instance of the Component 351400 entity there is one ProductDesignEngineeringDesignIdentification 351448 entity. The ProductDesignEngineeringDesignIdentification 351448 entity includes various attributes, namely an EngineeringDesignBusinessSystemID 351454, an EngineeringDesignBusinessSystemName 351460, an EngineeringDesignID 351466 and an EngineeringDesignInternalID 351472.

The EngineeringDesignBusinessSystemID 351454 attribute is a BusinessSystemID 351458 data type. The EngineeringDesignBusinessSystemID 351454 attribute has a cardinality of 0 . . . 1 351456 meaning that for each instance of the ProductDesignEngineeringDesignIdentification 351448 entity there may be one EngineeringDesignBusinessSystemID 351454 attribute.

The EngineeringDesignBusinessSystemName 351460 attribute is a LANGUAGEINDEPENDENT_LONG_Name 351464 data type. The EngineeringDesignBusinessSystemName 351460 attribute has a cardinality of 0 . . . 1 351462 meaning that for each instance of the ProductDesignEngineeringDesignIdentification 351448 entity there may be one EngineeringDesignBusinessSystemName 351460 attribute.

The EngineeringDesignID 351466 attribute is an EngineeringDesignID 351470 data type. The EngineeringDesignID 351466 attribute has a cardinality of 0 . . . 1 351468 meaning that for each instance of the ProductDesignEngineeringDesignIdentification 351448 entity there may be one EngineeringDesignID 351466 attribute.

The EngineeringDesignInternalID 351472 attribute is an EngineeringDesignInternalID 351476 data type. The EngineeringDesignInternalID 351472 attribute has a cardinality of 0 . . . 1 351474 meaning that for each instance of the ProductDesignEngineeringDesignIdentification 351448 entity there may be one EngineeringDesignInternalID 351472 attribute.

The ProductDesignVersionEngineeringDesignVersionIdentification 351490 entity has a cardinality of 1 351492 meaning that for each instance of the Component 351400 entity there is one ProductDesignVersionEngineeringDesignVersionIdentification 351490 entity. The ProductDesignVersionEngineeringDesignVersionIdentification 351490 entity includes various attributes, namely an EngineeringDesignVersionID 351496 and an EngineeringDesignVersionInternalID 351502.

The EngineeringDesignVersionID 351496 attribute is an EngineeringDesignVersionID 351500 data type. The EngineeringDesignVersionID 351496 attribute has a cardinality of 0 . . . 1 351498 meaning that for each instance of the ProductDesignVersionEngineeringDesignVersionIdentification 351490 entity there may be one EngineeringDesignVersionID 351496 attribute.

The EngineeringDesignVersionInternalID 351502 attribute is an EngineeringDesignVersionInternalID 351506 data type. The EngineeringDesignVersionInternalID 351502 attribute has a cardinality of 0 . . . 1 351504 meaning that for each instance of the ProductDesignVersionEngineeringDesignVersionIdentification 351490 entity there may be one EngineeringDesignVersionInternalID 351502 attribute.

The AttachmentFolder 351508 entity has a cardinality of 0 . . . 1 351510 meaning that for each instance of the Component 351400 entity there may be one AttachmentFolder 351508 entity. The AttachmentFolder 351508 entity includes an UUID 351514 attribute. The AttachmentFolder 351508 entity includes a Document 351520 subordinate entity.

The UUID 351514 attribute is an UUID 351518 data type. The UUID 351514 attribute has a cardinality of 0 . . . 1 351516 meaning that for each instance of the AttachmentFolder 351508 entity there may be one UUID 351514 attribute.

The Document 351520 entity has a cardinality of 0 . . . N 351522 meaning that for each instance of the AttachmentFolder 351508 entity there may be one or more Document 351520 entities. The Document 351520 entity includes various attributes, namely an UUID 351526, a VersionID 351532, a SystemAdministrativeData 351538, a LinkInternalIndicator 351544, a CheckedOutIndicator 351550, a VisibleIndicator 351556, a VersioningEnabledIndicator 351562, a CategoryCode 351568, a CategoryName 351574, a TypeCode 351580, a TypeName 351586, a MIMECode 351592, a MIMEName 351598, a PathName 351604, a Name 351610, an AlternativeName 351616, an InternalLinkUUID 351622, a Description 351628, an ExternalLinkWebURI 351634, a FileContentURI 351640 and a FilesizeMeasure 351646. The Document 351520 entity includes a Property 351652 subordinate entity.

The UUID 351526 attribute is an UUID 351530 data type. The UUID 351526 attribute has a cardinality of 0 . . . 1 351528 meaning that for each instance of the Document 351520 entity there may be one UUID 351526 attribute.

The VersionID 351532 attribute is a VersionID 351536 data type. The VersionID 351532 attribute has a cardinality of 0 . . . 1 351534 meaning that for each instance of the Document 351520 entity there may be one VersionID 351532 attribute.

The SystemAdministrativeData 351538 attribute is a SystemAdministrativeData 351542 data type. The SystemAdministrativeData 351538 attribute has a cardinality of 0 . . . 1 351540 meaning that for each instance of the Document 351520 entity there may be one SystemAdministrativeData 351538 attribute.

The LinkInternalIndicator 351544 attribute is an Indicator 351548 data type. The LinkInternalIndicator 351544 attribute has a cardinality of 0 . . . 1 351546 meaning that for each instance of the Document 351520 entity there may be one LinkInternalIndicator 351544 attribute.

The CheckedOutIndicator 351550 attribute is an Indicator 351554 data type. The CheckedOutIndicator 351550 attribute has a cardinality of 0 . . . 1 351552 meaning that for each instance of the Document 351520 entity there may be one CheckedOutIndicator 351550 attribute.

The VisibleIndicator 351556 attribute is an Indicator 351560 data type. The VisibleIndicator 351556 attribute has a cardinality of 0 . . . 1 351558 meaning that for each instance of the Document 351520 entity there may be one VisibleIndicator 351556 attribute.

The VersioningEnabledIndicator 351562 attribute is an Indicator 351566 data type. The VersioningEnabledIndicator 351562 attribute has a cardinality of 0 . . . 1 351564 meaning that for each instance of the Document 351520 entity there may be one VersioningEnabledIndicator 351562 attribute.

The CategoryCode 351568 attribute is a DocumentCategoryCode 351572 data type. The CategoryCode 351568 attribute has a cardinality of 0 . . . 1 351570 meaning that for each instance of the Document 351520 entity there may be one CategoryCode 351568 attribute.

The CategoryName 351574 attribute is a LANGUAGEINDEPENDENT_LONG_Name 351578 data type. The CategoryName 351574 attribute has a cardinality of 0 . . . 1 351576 meaning that for each instance of the Document 351520 entity there may be one CategoryName 351574 attribute.

The TypeCode 351580 attribute is a DocumentTypeCode 351584 data type. The TypeCode 351580 attribute has a cardinality of 0 . . . 1 351582 meaning that for each instance of the Document 351520 entity there may be one TypeCode 351580 attribute.

The TypeName 351586 attribute is a LANGUAGEINDEPENDENT_LONG_Name 351590 data type. The TypeName 351586 attribute has a cardinality of 0 . . . 1 351588 meaning that for each instance of the Document 351520 entity there may be one TypeName 351586 attribute.

The MIMECode 351592 attribute is a MIMECode 351596 data type. The MIMECode 351592 attribute has a cardinality of 0 . . . 1 351594 meaning that for each instance of the Document 351520 entity there may be one MIMECode 351592 attribute.

The MIMEName 351598 attribute is a LANGUAGEINDEPENDENT_LONG_Name 351602 data type. The MIMEName 351598 attribute has a cardinality of 0 . . . 1 351600 meaning that for each instance of the Document 351520 entity there may be one MIMEName 351598 attribute.

The PathName 351604 attribute is a LANGUAGEINDEPENDENT_Name 351608 data type. The PathName 351604 attribute has a cardinality of 0 . . . 1 351606 meaning that for each instance of the Document 351520 entity there may be one PathName 351604 attribute.

The Name 351610 attribute is a LANGUAGEINDEPENDENT_Name 351614 data type. The Name 351610 attribute has a cardinality of 0 . . . 1 351612 meaning that for each instance of the Document 351520 entity there may be one Name 351610 attribute.

The AlternativeName 351616 attribute is a LANGUAGEINDEPENDENT_Name 351620 data type. The AlternativeName 351616 attribute has a cardinality of 0 . . . 1 351618 meaning that for each instance of the Document 351520 entity there may be one AlternativeName 351616 attribute.

The InternalLinkUUID 351622 attribute is an UUID 351626 data type. The InternalLinkUUID 351622 attribute has a cardinality of 0 . . . 1 351624 meaning that for each instance of the Document 351520 entity there may be one InternalLinkUUID 351622 attribute.

The Description 351628 attribute is a Description 351632 data type. The Description 351628 attribute has a cardinality of 0 . . . 1 351630 meaning that for each instance of the Document 351520 entity there may be one Description 351628 attribute.

The ExternalLinkWebURI 351634 attribute is a WebURI 351638 data type. The ExternalLinkWebURI 351634 attribute has a cardinality of 0 . . . 1 351636 meaning that for each instance of the Document 351520 entity there may be one ExternalLinkWebURI 351634 attribute.

The FileContentURI 351640 attribute is an URI 351644 data type. The FileContentURI 351640 attribute has a cardinality of 0 . . . 1 351642 meaning that for each instance of the Document 351520 entity there may be one FileContentURI 351640 attribute.

The FilesizeMeasure 351646 attribute is a Measure 351650 data type. The FilesizeMeasure 351646 attribute has a cardinality of 0 . . . 1 351648 meaning that for each instance of the Document 351520 entity there may be one FilesizeMeasure 351646 attribute.

The Property 351652 entity has a cardinality of 0 . . . N 351654 meaning that for each instance of the Document 351520 entity there may be one or more Property 351652 entities. The Property 351652 entity includes various attributes, namely a TechnicalID 351658, a Name 351664, a DataTypeFormatCode 351670, a DataTypeFormatName 351676, a VisibleIndicator 351682, a ChangeAllowedIndicator 351688, a MultipleValueIndicator 351694, a NamespaceURI 351700 and a Description 351706. The Property 351652 entity includes a PropertyValue 351712 subordinate entity.

The TechnicalID 351658 attribute is an ObjectNodeTechnicalID 351662 data type. The TechnicalID 351658 attribute has a cardinality of 0 . . . 1 351660 meaning that for each instance of the Property 351652 entity there may be one TechnicalID 351658 attribute.

The Name 351664 attribute is a LANGUAGEINDEPENDENT_Name 351668 data type. The Name 351664 attribute has a cardinality of 0 . . . 1 351666 meaning that for each instance of the Property 351652 entity there may be one Name 351664 attribute.

The DataTypeFormatCode 351670 attribute is a PropertyDataTypeFormatCode 351674 data type. The DataTypeFormatCode 351670 attribute has a cardinality of 0 . . . 1 351672 meaning that for each instance of the Property 351652 entity there may be one DataTypeFormatCode 351670 attribute.

The DataTypeFormatName 351676 attribute is a LANGUAGEINDEPENDENT_LONG_Name 351680 data type. The DataTypeFormatName 351676 attribute has a cardinality of 0 . . . 1 351678 meaning that for each instance of the Property 351652 entity there may be one DataTypeFormatName 351676 attribute.

The VisibleIndicator 351682 attribute is an Indicator 351686 data type. The VisibleIndicator 351682 attribute has a cardinality of 0 . . . 1 351684 meaning that for each instance of the Property 351652 entity there may be one VisibleIndicator 351682 attribute.

The ChangeAllowedIndicator 351688 attribute is an Indicator 351692 data type. The ChangeAllowedIndicator 351688 attribute has a cardinality of 0 . . . 1 351690 meaning that for each instance of the Property 351652 entity there may be one ChangeAllowedIndicator 351688 attribute.

The MultipleValueIndicator 351694 attribute is an Indicator 351698 data type. The MultipleValueIndicator 351694 attribute has a cardinality of 0 . . . 1 351696 meaning that for each instance of the Property 351652 entity there may be one MultipleValueIndicator 351694 attribute.

The NamespaceURI 351700 attribute is a NamespaceURI 351704 data type. The NamespaceURI 351700 attribute has a cardinality of 0 . . . 1 351702 meaning that for each instance of the Property 351652 entity there may be one NamespaceURI 351700 attribute.

The Description 351706 attribute is a Description 351710 data type. The Description 351706 attribute has a cardinality of 0 . . . 1 351708 meaning that for each instance of the Property 351652 entity there may be one Description 351706 attribute.

The PropertyValue 351712 entity has a cardinality of 0 . . . N 351714 meaning that for each instance of the Property 351652 entity there may be one or more PropertyValue 351712 entities. The PropertyValue 351712 entity includes various attributes, namely a TechnicalID 351718, a Text 351724, an Indicator 351730, a DateTime 351736 and an IntegerValue 351742.

The TechnicalID 351718 attribute is an ObjectNodeTechnicalID 351722 data type. The TechnicalID 351718 attribute has a cardinality of 0 . . . 1 351720 meaning that for each instance of the PropertyValue 351712 entity there may be one TechnicalID 351718 attribute.

The Text 351724 attribute is a LANGUAGEINDEPENDENT_Text 351728 data type. The Text 351724 attribute has a cardinality of 0 . . . 1 351726 meaning that for each instance of the PropertyValue 351712 entity there may be one Text 351724 attribute. The Indicator 351730 attribute is an Indicator 351734 data type. The Indicator 351730 attribute has a cardinality of 0 . . . 1 351732 meaning that for each instance of the PropertyValue 351712 entity there may be one Indicator 351730 attribute.

The DateTime 351736 attribute is a GLOBAL_DateTime 351740 data type. The DateTime 351736 attribute has a cardinality of 0 . . . 1 351738 meaning that for each instance of the PropertyValue 351712 entity there may be one DateTime 351736 attribute.

The IntegerValue 351742 attribute is an IntegerValue 351746 data type. The IntegerValue 351742 attribute has a cardinality of 0 . . . 1 351744 meaning that for each instance of the PropertyValue 351712 entity there may be one IntegerValue 351742 attribute.

The TextCollection 351748 entity has a cardinality of 0 . . . 1 351750 meaning that for each instance of the Component 351400 entity there may be one TextCollection 351748 entity. The TextCollection 351748 entity includes an UUID 351754 attribute. The TextCollection 351748 entity includes a Text 351760 subordinate entity.

The UUID 351754 attribute is an UUID 351758 data type. The UUID 351754 attribute has a cardinality of 0 . . . 1 351756 meaning that for each instance of the TextCollection 351748 entity there may be one UUID 351754 attribute.

The Text 351760 entity has a cardinality of 0 . . . N 351762 meaning that for each instance of the TextCollection 351748 entity there may be one or more Text 351760 entities.

The Text 351760 entity includes various attributes, namely a TechnicalID 351766, a TypeCode 351772, a TypeName 351778, a LanguageCode 351784, a LanguageName 351790, a SystemAdministrativeData 351796 and a CreationDateTime 351802. The Text 351760 entity includes a TextContent 351808 subordinate entity.

The TechnicalID 351766 attribute is an ObjectNodeTechnicalID 351770 data type. The TechnicalID 351766 attribute has a cardinality of 0 . . . 1 351768 meaning that for each instance of the Text 351760 entity there may be one TechnicalID 351766 attribute.

The TypeCode 351772 attribute is a TextCollectionTextTypeCode 351776 data type. The TypeCode 351772 attribute has a cardinality of 0 . . . 1 351774 meaning that for each instance of the Text 351760 entity there may be one TypeCode 351772 attribute.

The TypeName 351778 attribute is a LANGUAGEINDEPENDENT_LONG_Name 351782 data type. The TypeName 351778 attribute has a cardinality of 0 . . . 1 351780 meaning that for each instance of the Text 351760 entity there may be one TypeName 351778 attribute.

The LanguageCode 351784 attribute is a LanguageCode 351788 data type. The LanguageCode 351784 attribute has a cardinality of 0 . . . 1 351786 meaning that for each instance of the Text 351760 entity there may be one LanguageCode 351784 attribute.

The LanguageName 351790 attribute is a LANGUAGEINDEPENDENT_LONG_Name 351794 data type. The LanguageName 351790 attribute has a cardinality of 0 . . . 1 351792 meaning that for each instance of the Text 351760 entity there may be one LanguageName 351790 attribute.

The SystemAdministrativeData 351796 attribute is a SystemAdministrativeData 351800 data type. The SystemAdministrativeData 351796 attribute has a cardinality of 0 . . . 1 351798 meaning that for each instance of the Text 351760 entity there may be one SystemAdministrativeData 351796 attribute.

The CreationDateTime 351802 attribute is a GLOBAL_DateTime 351806 data type. The CreationDateTime 351802 attribute has a cardinality of 0 . . . 1 351804 meaning that for each instance of the Text 351760 entity there may be one CreationDateTime 351802 attribute.

The TextContent 351808 entity has a cardinality of 0 . . . 1 351810 meaning that for each instance of the Text 351760 entity there may be one TextContent 351808 entity. The TextContent 351808 entity includes various attributes, namely a TechnicalID 351814 and a Text 351820.

The TechnicalID 351814 attribute is an ObjectNodeTechnicalID 351818 data type. The TechnicalID 351814 attribute has a cardinality of 0 . . . 1 351816 meaning that for each instance of the TextContent 351808 entity there may be one TechnicalID 351814 attribute.

The Text 351820 attribute is a Text 351824 data type. The Text 351820 attribute has a cardinality of 0 . . . 1 351822 meaning that for each instance of the TextContent 351808 entity there may be one Text 351820 attribute.

The ProductAssignment 351826 node element grouping is a ProductDesignVersionHierarchyByElementsResponseProductAssignment 351832 data type. The ProductAssignment 351826 node element grouping includes a ProductAssignment 351828 entity.

The ProductAssignment 351828 entity has a cardinality of 0 . . . N 351830 meaning that for each instance of the ProductAssignment 351826 node element grouping there may be one or more ProductAssignment 351828 entities. The ProductAssignment 351828 entity includes various attributes, namely an UUID 351834, a ProductUUID 351840 and a DefaultIndicator 351882. The ProductAssignment 351828 entity includes various subordinate entities, namely a ProductKey 351846 and a ProductDescription 351888.

The UUID 351834 attribute is an UUID 351838 data type. The UUID 351834 attribute has a cardinality of 0 . . . 1 351836 meaning that for each instance of the ProductAssignment 351828 entity there may be one UUID 351834 attribute.

The ProductUUID 351840 attribute is an UUID 351844 data type. The ProductUUID 351840 attribute has a cardinality of 0 . . . 1 351842 meaning that for each instance of the ProductAssignment 351828 entity there may be one ProductUUID 351840 attribute.

The DefaultIndicator 351882 attribute is an Indicator 351886 data type. The DefaultIndicator 351882 attribute has a cardinality of 0 . . . 1 351884 meaning that for each instance of the ProductAssignment 351828 entity there may be one DefaultIndicator 351882 attribute.

The ProductKey 351846 entity has a cardinality of 0 . . . 1 351848 meaning that for each instance of the ProductAssignment 351828 entity there may be one ProductKey 351846 entity. The ProductKey 351846 entity includes various attributes, namely a ProductTypeCode 351852, a ProductTypeName 351858, a ProductIdentifierTypeCode 351864, a ProductIdentifierTypeName 351870 and a ProductID 351876.

The ProductTypeCode 351852 attribute is a ProductTypeCode 351856 data type. The ProductTypeCode 351852 attribute has a cardinality of 0 . . . 1 351854 meaning that for each instance of the ProductKey 351846 entity there may be one ProductTypeCode 351852 attribute.

The ProductTypeName 351858 attribute is a LANGUAGEINDEPENDENT_LONG_Name 351862 data type. The ProductTypeName 351858 attribute has a cardinality of 0 . . . 1 351860 meaning that for each instance of the ProductKey 351846 entity there may be one ProductTypeName 351858 attribute.

The ProductIdentifierTypeCode 351864 attribute is a ProductIdentifierTypeCode 351868 data type. The ProductIdentifierTypeCode 351864 attribute has a cardinality of 0 . . . 1 351866 meaning that for each instance of the ProductKey 351846 entity there may be one ProductIdentifierTypeCode 351864 attribute.

The ProductIdentifierTypeName 351870 attribute is a LANGUAGEINDEPENDENT_LONG_Name 351874 data type. The ProductIdentifierTypeName 351870 attribute has a cardinality of 0 . . . 1 351872 meaning that for each instance of the ProductKey 351846 entity there may be one ProductIdentifierTypeName 351870 attribute.

The ProductID 351876 attribute is a ProductID 351880 data type. The ProductID 351876 attribute has a cardinality of 0 . . . 1 351878 meaning that for each instance of the ProductKey 351846 entity there may be one ProductID 351876 attribute.

The ProductDescription 351888 entity has a cardinality of 0 . . . N 351890 meaning that for each instance of the ProductAssignment 351828 entity there may be one or more ProductDescription 351888 entities. The ProductDescription 351888 entity includes a Description 351894 attribute.

The Description 351894 attribute is a SHORT_Description 351898 data type. The Description 351894 attribute has a cardinality of 0 . . . 1 351896 meaning that for each instance of the ProductDescription 351888 entity there may be one Description 351894 attribute. The Log 351900 node element grouping is a Log 351906 data type. The Log 351900 node element grouping includes a Log 351902 entity. The Log 351902 entity has a cardinality of 1 351904 meaning that for each instance of the Log 351900 node element grouping there is one Log 351902 entity.

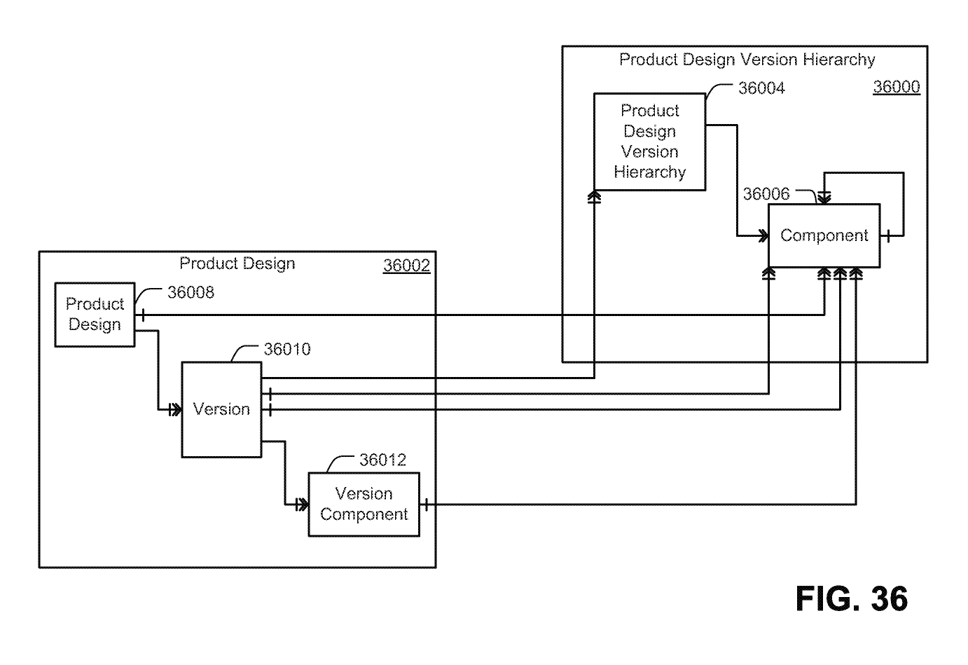

FIG. 36 illustrates an example object model for a Product Design Version Hierarchy business object 36000. Some details of the business object are described in detail on pages 158-181 in previously-filed U.S. patent application Ser. No. 12/816,083, entitled “Managing Consistent Interfaces For Customer Project Invoicing Agreement, Engineering Change Case, Product Design, Product Design Version Hierarchy, and Project Expense View Business Objects Across Heterogeneous Systems”, filed on Jun. 15, 2010, and is hereby incorporated by reference. Specifically, the object model depicts interactions among various components of the Product Design Version Hierarchy business object 36000, as well as external components that interact with the Product Design Version Hierarchy business object 36000 (shown here as 36002, and 36008 through 36012). The Product Design Version Hierarchy business object 36000 includes elements 36004 through 36006. The elements 36004 through 36006 can be hierarchical, as depicted. For example, the Product Design Version Hierarchy entity 36004 hierarchically includes Component entity 36006. Some or all of the entities 36004 through 36006 can correspond to packages and/or entities in the message data types described above.

The business object Product Design Version Hierarchy is a hierarchy of a product design version. The business object Product Design Version Hierarchy belongs to the process component Product Engineering Foundation. A hierarchy is an explosion of a product design version, including the product design versions referenced by its components at all levels. A hierarchy can be used to show the overall structure of a complex product as designed by engineering. For example, a version of the product design Bicycle includes the following product designs as components: Frame, Front Wheel, Rear Wheel, Gear Shift and Handle Bar. Each version of the product design Gear Shift is also an assembly, encapsulates the product designs Chain, Gear, Chain Ring, and Lever as components, and may be used by several product designs. The hierarchy of a version of the product design Bicycle is a two level hierarchy of product design assemblies. In general, a product design version hierarchy includes components that establish a tree of product design versions.

The business object Product Design Version Hierarchy includes a Product Design Version Hierarchy Transformation Node root node. The elements located directly at the node Product Design Version Hierarchy are defined by the data type ProductDesignVersionHierarchyElements. These elements include: UUID, ProductDesignVersionUUID, ProductDesignVersionKey, ProductDesignID, ProductDesignVersionID, ProductDesignVersionBaseQuantity, ProductDesignVersionBaseQuantityTypeCode, Quantity, ExplosionDate, MaximumHierarchyLevelOrdinalNumberValue, and InactiveVersionIncludedIndicator. UUID may be an alternative key, is an identifier of a product design version hierarchy instance, and may be based on datatype GDT: UUID. ProductDesignVersionUUID is a universally unique identifier of a product design version for which a hierarchy is built up, and may be based on datatype GDT: UUID. ProductDesignVersionKey is a key of a product design version for which a hierarchy is built up, and may be based on datatype KDT: ProductDesignVersionKey. ProductDesignID is a unique identifier of a product design, and may be based on datatype GDT: ProductDesignID. ProductDesignVersionID is unique identifier of a product design version, and may be based on datatype GDT: VersionID. The product design version is unique within the context of a product design. ProductDesignVersionBaseQuantity may be optional, is a base quantity of a product design version, and may be based on datatype GDT: NONNEGATIVE_Quantity, with a qualifier of Base. A base quantity expresses an output quantity of a product design version. ProductDesignVersionBaseQuantityTypeCode may be optional, is a type of a base quantity of a product design version, and may be based on datatype GDT: QuantityTypeCode, with a qualifier of Base. Quantity may be optional, is a quantity of a root level as specified in a hierarchical explosion, and may be based on datatype GDT: NONNEGATIVE_Quantity. ExplosionDate may be optional, is a date used to determine the newest valid version on sub-levels in a hierarchical explosion, and may be based on datatype GDT: Date, with a qualifier of Explosion. MaximumHierarchyLevelOrdinalNumberValue may be optional, is a maximum number of levels of a hierarchy at an initial explosion when an instance of the object is created, and may be based on datatype GDT: OrdinalNumberValue, with a qualifier of HierarchyLevel. MaximumHierarchyLevelOrdinalNumberValue may be used for creation of the instance of the hierarchy and for printforms. If the MaximumHierarchyLevelOrdinalNumberValue is initial, the explosion will be executed as far as possible. InactiveVersionIncludedIndicator indicates that all versions with lifecycle status not equal to obsolete on sub-levels should be taken into account, and may be based on datatype GDT: Indicator, with a qualifier of Included.

The following composition relationships to subordinate nodes exist: Component with a cardinality of 1:N. A Product Design Version inbound aggregation relationship may exist from the business object Product Design/node Version, with a cardinality of 1:CN, which identifies the product design version for which the hierarchy is built up. A Product Design specialization association for navigation may exist to business object Product Design/node Product Design, with a target cardinality of 1, which identifies the product design that is referenced by a product design version hierarchy. In some implementations, the following node attributes are derived from the same original node instance Product Design Version: ProductDesignVersionKey, ProductDesignVersionUUID, ProductDesignVersionBaseQuantity, and ProductDesignVersionBaseQuantityTypeCode.

A Query By Version And Explosion Criteria query rquery returns the result of a hierarchical explosion. The query elements are defined by the data type ProductDesignVersionHierarchyVersionAndExplosionCriteriaQueryElements. These elements include: ProductDesignVersionKey, ProductDesignID, ProductDesignVersionID, ExplosionDate, MaximumHierarchyLevelOrdinalNumberValue, and InactiveVersionIncludedIndicator. ProductDesignVersionKey may be based on datatype KDT: ProductDesignVersionKey. ProductDesignID is a unique identifier of a product design, and may be based on datatype GDT: ProductDesignID ProductDesignVersionID is a unique identifier of a product design version, and may be based on datatype GDT: VersionID. The product design version is unique within the context of a product design. ExplosionDate may be optional, and may be based on datatype GDT: Date, with a qualifier of Explosion. MaximumHierarchyLevelOrdinalNumberValue may be optional, and may be based on datatype GDT: OrdinalNumberValue, with a qualifier of HierarchyLevel. InactiveVersionIncludedIndicator and may be based on datatype GDT: Indicator, with a qualifier of Included.

A Component Transformation node includes detail of a product design version component. At the top level, the information of the product design version as the starting point of the hierarchical explosion is shown. There may be only one instance of the component assigned to the top level. The component node may include information from lower levels. Here it includes the information of the product design version component as well as a referenced product design and its version as determined within a hierarchical explosion path. The elements located directly at the node Component are defined by the data type ProductDesignVersionHierarchyComponentElements. These elements include: UUID, ParentComponentUUID, TopLevelProductDesignVersionUUID, ProductDesignVersionComponentUUID, ProductDesignUUID, ProductDesignVersionUUID, ProductDesignVersionComponentBaseQuantity, ProductDesignVersionComponentBaseQuantityTypeCode, Quantity, HierarchyLevelOrdinalNumberValue, and LeafIndicator. UUID may be an alternative key, is an identifier of a product design version hierarchy component instance, and may be based on datatype GDT: UUID. ParentComponentUUID may be optional, is an identifier of a parent node instance, and may be based on datatype GDT: UUID. TopLevelProductDesignVersionUUID may be optional, is a universally unique identifier of a product design version, may be based on datatype GDT: UUID, may be a product design version for which a hierarchy is built up, and may be filled on a top level of a hierarchy. ProductDesignVersionComponentUUID may be optional, is a universally unique identifier of a product design version component, and may be based on datatype GDT: UUID. ProductDesignUUID may be optional, is a universally unique identifier of a referenced product design, and may be based on datatype GDT: UUID. This element may not be maintained on a node instance which represents the top level. ProductDesignVersionUUID may be optional, is a universally unique identifier of a referenced product design version as selected within a hierarchical explosion, and may be based on datatype GDT: UUID. This element may not be maintained on a node instance which represents the top level. ProductDesignVersionComponentBaseQuantity may be optional, is a base quantity of a product design version component, and may be based on datatype GDT: NONNEGATIVE_Quantity, with a qualifier of Base. ProductDesignVersionComponentBaseQuantityTypeCode may be optional, is a quantity type code as specified in the referenced Product Design Version Component, and may be based on datatype GDT: QuantityTypeCode, with a qualifier of Base. Quantity may be optional, is a calculated quantity along a hierarchy path of an explosion, and may be based on datatype GDT: NONNEGATIVE_Quantity. HierarchyLevelOrdinalNumberValue is an identifying level of a component node within a hierarchical path, and may be based on datatype GDT: OrdinalNumberValue, with a qualifier of HierarchyLevel. LeafIndicator indicates that the current level is a leaf of a hierarchy, and may be based on datatype GDT: Indicator, with a qualifier of Leaf. The hierarchy additionally interprets a node as leaf if there occurs conversion errors of quantities within an explosion on a path.

A Top Level Product Design Version inbound aggregation relationship may exist from the business object Product Design/node Version, with a cardinality of C:CN, which identifies a product design version that is referenced by a component at top level. A Product Design inbound association relationship may exist from the business object Product Design/node Product Design, with a cardinality of C:CN, which identifies a product design that is referenced by a component. A Product Design Version inbound association relationship may exist from the business object Product Design/node Version, with a cardinality of C:CN, which identifies a product design version that is referenced by the component. A Product Design Version Component inbound association relationship may exist from the business object Product Design/node Version Component, with a cardinality of C:CN, which identifies the product design version component that is referenced by the component. A ParentComponent inbound association relationship may exist from the business object Product Design Version Hierarchy/node Component, with a cardinality of C:CN, which is a relation to the parent node to build up the hierarchy path of the explosion. The top-level component representing the starting product design version of the hierarchy may not have as target a ParentComponent, but rather a Component-relationship to the Root node. A ChildComponent specialization association for navigation may exist to the own business object/node Component, with a target cardinality of CN, which is a component which is child of a certain component. In some implementations, the element TopLevelProductDesignVersionUUID is only filled for the component node instance assigned to the top level, and has the same value as that referenced at root level.

A number of implementations have been described. Nevertheless, it will be understood that various modifications may be made without departing from the spirit and scope of the disclosure. Accordingly, other implementations are within the scope of the following claims.

What is claimed is:

1. A computer readable medium including program code for providing a message-based interface for exchanging information about product design version hierarchies with external engineering systems, the medium comprising:
program code for receiving via a message-based interface exposing at least one service as defined in a service registry and from a heterogeneous application executing in an environment of computer systems providing message-based services, a first message for responding to a query from an external engineering system about a product design version hierarchy that includes a message package hierarchically organized as:
a product design version hierarchy by elements response message entity;
a product design version hierarchy package comprising a product design version hierarchy entity, where the product design version hierarchy entity includes a universally unique identifier (UUID) and a log entity; and
a log package comprising a log entity; and
program code for sending a second message to the heterogeneous application responsive to the first message.

2. The computer readable medium of claim 1, wherein the message package further comprises a product design package.

3. The computer readable medium of claim 1, wherein the product design version hierarchy entity further includes at least one of the following: a product design version UUID, a product design identifier (ID), a product design version ID, an engineering design business system ID, an engineering design internal ID, an engineering design version internal ID, and at least one component entity.

4. A distributed system operating in a landscape of computer systems providing message-based services defined in a service registry, the system comprising:
a graphical user interface comprising computer readable instructions, embedded on tangible media, for responding to a query from an external engineering system about a product design version hierarchy using a request;
a first memory storing a user interface controller for processing the request and involving a message including a message package hierarchically organized as:
a product design version hierarchy by elements response message entity;
a product design version hierarchy package comprising a product design version hierarchy entity, where the product design version hierarchy entity includes a universally unique identifier (UUID) and a log entity; and
a log package comprising a log entity; and
a second memory, remote from the graphical user interface, storing a plurality of service interfaces, where one of the service interfaces is operable to process the message via the service interface.

5. The distributed system of claim 4, wherein the first memory is remote from the graphical user interface.

6. The distributed system of claim 4, wherein the first memory is remote from the second memory.

7. A computer readable medium including program code for providing a message-based interface for exchanging information about product design version hierarchies with external engineering systems, the medium comprising:
program code for receiving via a message-based interface exposing at least one service as defined in a service registry and from a heterogeneous application executing in an environment of computer systems providing message-based services, a first message for sending a query from an external engineering system about a product design version hierarchy that includes a message package hierarchically organized as:
a product design version hierarchy by elements query message entity;
a message header package comprising a message header entity; and
a product design version hierarchy selection by elements package comprising a product design version hierarchy selection by elements entity, where the product design version hierarchy selection by elements entity includes a requested detail level and at least one selection by product design version hierarchy elements entity; and
program code for sending a second message to the heterogeneous application responsive to the first message.

8. The computer readable medium of claim 7, wherein the product design version hierarchy selection by elements entity further includes a language code.

9. The computer readable medium of claim 7, wherein each selection by product design version hierarchy elements entity includes at least one of the following: a product design version UUID, a product design ID, a product design version ID, an engineering design business system ID, an engineering design internal ID, an engineering design version internal ID, a quantity, an explosion date, a maximum hierarchy level ordinal number value, and a version determination code.

10. A distributed system operating in a landscape of computer systems providing message-based services defined in a service registry, the system comprising:
a graphical user interface comprising computer readable instructions, embedded on tangible media, for sending a query from an external engineering system about a product design version hierarchy using a request;
a first memory storing a user interface controller for processing the request and involving a message including a message package hierarchically organized as:
a product design version hierarchy by elements query message entity;
a message header package comprising a message header entity; and
a product design version hierarchy selection by elements package comprising a product design version hierarchy selection by elements entity, where the product design version hierarchy selection by elements entity includes a requested detail level and at least one selection by product design version hierarchy elements entity; and
a second memory, remote from the graphical user interface, storing a plurality of service interfaces, where one of the service interfaces is operable to process the message via the service interface.

11. The distributed system of claim 10, wherein the first memory is remote from the graphical user interface.

12. The distributed system of claim 10, wherein the first memory is remote from the second memory.
